(19) United States
(12) Patent Application Publication
(10) Pub. No.: US 2026/0108850 A1
(43) Pub. Date: Apr. 23, 2026

(54) LITHIUM RECOVERY FROM LIQUID STREAMS USING SOLUTE-PERMEABLE MEMBRANES

(71) Applicant: Gradiant Corporation, Woburn, MA (US)

(72) Inventors: Siva Kumar Kota, Sengkang (SG); Hiep Thanh Huynh Le, Singapore (SG); Kushal Seth, Cypress, TX (US); Omkar Lokare, Arlington, MA (US); Looh Tchuin Choong, Somerville, MA (US); Richard Stover, Waltham, MA (US)

(73) Assignee: Gradiant Corporation, Woburn, MA (US)

(21) Appl. No.: 19/116,346

(22) PCT Filed: Sep. 27, 2023
(86) PCT No.: PCT/US2023/075227

§ 371 Date: Mar. 27, 2025

Related U.S. Application Data
(60) Provisional application No. 63/411,075, filed on Sep. 28, 2022.

(51) Int. Cl. B01D 61/02; B01D 69/02; C01D 15/02; C25B 1/16

(52) U.S. Cl. CPC B01D 61/026; B01D 69/02; C01D 15/02; C25B 1/16; B01D 2317/022; B01D 2325/34

(57) ABSTRACT

Methods and systems directed to recovery of lithium (e.g., lithium salts) from liquid streams are provided. In some embodiments, methods relate to obtaining lithium (e.g., as a solid lithium salt) by removing at least a portion of liquid from a feed stream to form a concentrated stream with respect to solubilized lithium cations. Liquid removal may include transporting at least a portion of the feed stream to a membrane separator and/or a humidifier. Some methods include removing impurities (e.g., non-lithium cations) from the concentrated stream (e.g., via precipitation and/or crystallization). In some embodiments, solutions containing solubilized lithium cations and anions are electrochemically-treated such that first solubilized anions are replaced with second, different anions. In some embodiments, solid lithium salt containing at least a portion of the lithium cations and the second anions is obtained (e.g., via precipitation and/or crystallization following concentration of the electrochemically-treated solution in a humidifier).

### RELATED APPLICATIONS

This application claims priority under 35 U.S.C. § 119(e) to U.S. Provisional Patent Application No. 63/411,075, filed Sep. 28, 2022, and entitled “Lithium Recovery from Liquid Streams Using Solute-Permeable Membranes,” which is incorporated herein by reference in its entirety for all purposes.

### TECHNICAL FIELD

Methods and systems directed to recovery of lithium (e.g., lithium salts) from liquids are provided.

### BACKGROUND

Lithium is a commercially valuable resource that can be recovered from a variety of sources, such as brines (e.g., seawater, salt lake brines, underground water), ores, and waste products such as lithium ion batteries. Lithium is often found as a solubilized ion in liquid mixtures along with other non-lithium species. Improved methods and systems for obtaining lithium (including lithium salts of relatively high purity in some instances) are desirable.

### SUMMARY

Methods and systems directed to recovery of lithium (e.g., lithium salts) from liquid streams are provided. The subject matter of the present invention involves, in some cases, interrelated products, alternative solutions to a particular problem, and/or a plurality of different uses of one or more systems and/or articles.

In one aspect, methods are provided. In some embodiments, the method comprises removing at least a portion of liquid from a feed stream comprising the liquid, solubilized lithium cations, and solubilized non-lithium cations, to form a concentrated stream having a higher concentration of solubilized lithium cations compared to the feed stream, wherein the removing comprises: (a) transporting a first membrane separator retentate inlet stream comprising at least a portion of the feed stream to a retentate side of a first membrane separator such that: a first membrane separator retentate outlet stream exits the retentate side of the first membrane separator, the first membrane separator retentate outlet stream having a concentration of solubilized lithium cations that is greater than a concentration of solubilized lithium cations in the first membrane separator retentate inlet stream, and at least a portion of liquid from the first membrane separator retentate inlet stream is transported from the retentate side of the first membrane separator, through a semi-permeable membrane of the first membrane separator, to a permeate side of the first membrane separator; (b) transporting a second membrane separator retentate inlet stream comprising at least a portion of the first membrane separator retentate outlet stream to a retentate side of a second membrane separator such that: a second membrane separator retentate outlet stream exits the retentate side of the second membrane separator, the second membrane separator retentate outlet stream having a concentration of solubilized lithium cations that is greater than a concentration of solubilized lithium cations in the second membrane separator retentate inlet stream, and at least a portion of liquid, at least a portion of solubilized lithium cations, and at least a portion of solubilized non-lithium cations from the second membrane separator retentate inlet stream are transported from the retentate side of the second membrane separator, through a semi-permeable membrane of the second membrane separator, to a permeate side of the second membrane separator; and (c) transporting a humidifier liquid inlet stream comprising at least a portion of the second membrane separator retentate outlet stream to a humidifier and allowing at least a portion of liquid of the humidifier liquid inlet stream to evaporate within the humidifier to produce a humidified gas stream and a humidifier liquid outlet stream having a higher concentration of solubilized lithium cations compared to the humidifier liquid inlet stream, such that at least a portion of the humidifier liquid outlet stream is part of the concentrated stream; and removing at least some of the solubilized non-lithium cations from the concentrated stream to form an impurity-depleted concentrated steam having an atomic ratio of solubilized lithium cations to solubilized non-lithium cations that is larger than an atomic ratio of solubilized lithium cations to solubilized non-lithium cations in the concentrated stream.

In some embodiments, the method comprises: removing at least a portion of liquid from a feed stream comprising the liquid, solubilized lithium cations, and solubilized non-lithium cations, to form a concentrated stream having a higher concentration of solubilized lithium cations compared to the feed stream, wherein the removing comprises: (a) transporting a first membrane separator retentate inlet stream to a retentate side of a first membrane separator such that: a first membrane separator retentate outlet stream exits the retentate side of the first membrane separator, the first membrane separator retentate outlet stream having a concentration of solubilized lithium cations that is greater than a concentration of solubilized lithium cations in the first membrane separator retentate inlet stream, and at least a portion of liquid from the first membrane separator retentate inlet stream is transported from the retentate side of the first membrane separator, through a semi-permeable membrane of the first membrane separator, to a permeate side of the first membrane separator; (b) transporting a second membrane separator retentate inlet stream comprising at least a portion of the first membrane separator retentate outlet stream to a retentate side of a second membrane separator such that: a second membrane separator retentate outlet stream exits the retentate side of the second membrane separator, the second membrane separator retentate outlet stream having a concentration of solubilized lithium cations that is greater than a concentration of solubilized lithium cations in the second membrane separator retentate inlet stream, and at least a portion of liquid, at least a portion of solubilized lithium cations, and at least a portion of solubilized non-lithium cations from the second membrane separator retentate inlet stream are transported from the retentate side of the second membrane separator, through a semi-permeable membrane of the second membrane separator, to a permeate side of the second membrane separator where the portion of the liquid, portion of solubilized lithium cations, and portion of solubilized non-lithium cations form some or all of a second membrane separator permeate outlet stream that is transported out of the permeate side of the second membrane separator; (c) transporting a third membrane separator retentate inlet stream comprising at least a portion of the second membrane separator retentate outlet stream to a retentate side of a third membrane separator such that: a third membrane separator retentate outlet stream exits the retentate side of the third membrane separator, the third membrane separator retentate outlet stream having a concentration of solubilized lithium cations that is greater than a concentration of solubilized lithium cations of the third membrane separator retentate inlet stream, and at least a portion of liquid, at least a portion of solubilized lithium, and at least a portion of solubilized non-lithium cations from the third membrane separator retentate inlet stream are transported from the retentate side of the third membrane separator, through a semi-permeable membrane of the third membrane separator, to a permeate side of the third membrane separator where the portion of the liquid, portion of solubilized lithium cations, and portion of solubilized non-lithium cations form some or all of a third membrane separator permeate outlet stream that is transported out of the permeate side of the third membrane separator; and (d) transporting a humidifier liquid inlet stream comprising at least a portion of the third membrane separator retentate outlet stream to a humidifier and allowing at least a portion of liquid of the humidifier liquid inlet stream to evaporate within the humidifier to produce a humidified gas stream and a humidifier liquid outlet stream having a higher concentration of solubilized lithium cations compared to the humidifier liquid inlet stream, such that at least a portion of the humidifier liquid outlet stream is part of the concentrated stream; and removing at least some of the solubilized non-lithium cations from the concentrated stream to form an impurity-depleted concentrated steam having an atomic ratio of solubilized lithium cations to solubilized non-lithium cations that is larger than an atomic ratio of solubilized lithium cations to solubilized non-lithium cations in the concentrated stream; wherein: the first membrane separator retentate inlet stream comprises at least a portion of the second membrane separator permeate outlet stream and/or at least a portion of the third membrane separator permeate outlet stream; and the second membrane separator retentate inlet stream and/or the third membrane separator retentate inlet stream comprises at least a portion of the feed stream.

In some embodiments, the method comprises removing at least a portion of liquid from a feed stream comprising a liquid and solubilized lithium cations to form a concentrated stream having a higher concentration of solubilized lithium cation compared to the feed stream, wherein the removing comprises: transporting a first membrane separator retentate inlet stream comprising at least a portion of the feed stream to a retentate side of a first membrane separator such that: a first membrane separator retentate outlet stream exits the retentate side of the first membrane separator, the first membrane separator retentate outlet stream having a concentration of solubilized lithium cations that is greater than a concentration of solubilized lithium cations in the first membrane separator retentate inlet stream, and at least a portion of liquid from the first membrane separator retentate inlet stream is transported from the retentate side of the first membrane separator, through a semi-permeable membrane of the first membrane separator, to a permeate side of the first membrane separator; and transporting a second membrane separator retentate inlet stream comprising at least a portion of the first membrane separator retentate outlet stream to a retentate side of a second membrane separator such that: a second membrane separator retentate outlet stream exits the retentate side of the second membrane separator, the second membrane separator retentate outlet stream having a higher concentration of solubilized lithium cations than a concentration of solubilized lithium cations of the second membrane separator retentate inlet stream, such that at least a portion of the second membrane separator retentate outlet stream is part of the concentrated stream, and at least a portion of liquid and at least a portion of solubilized lithium cations from the second membrane separator retentate inlet stream are transported from the retentate side of the second membrane separator, through a semi-permeable membrane of the second membrane separator, to a permeate side of the second membrane separator; wherein: a concentration of solubilized lithium cations in the feed stream is greater than or equal to 10 mg/L, and a ratio of a concentration of solubilized lithium cations in the concentrated stream to the concentration of solubilized lithium cations in the feed stream is greater than or equal to 4.

In some embodiments, the method comprises: removing at least a portion of liquid from a feed stream comprising a liquid and solubilized lithium cations to form a concentrated stream having a higher concentration of solubilized lithium cation compared to the feed stream, wherein the removing comprises: transporting a first membrane separator retentate inlet stream to a retentate side of a first membrane separator such that: a first membrane separator retentate outlet stream exits the retentate side of the first membrane separator, the first membrane separator retentate outlet stream having a concentration of solubilized lithium cations that is greater than a concentration of solubilized lithium cations in the first membrane separator retentate inlet stream, and at least a portion of liquid from the first membrane separator retentate inlet stream is transported from the retentate side of the first membrane separator, through a semi-permeable membrane of the first membrane separator, to a permeate side of the first membrane separator; transporting a second membrane separator retentate inlet stream comprising at least a portion of the first membrane separator retentate outlet stream to a retentate side of a second membrane separator such that: a second membrane separator retentate outlet stream exits the retentate side of the second membrane separator, the second membrane separator retentate outlet stream having a higher concentration of solubilized lithium cations than a concentration of solubilized lithium cations of the second membrane separator retentate inlet stream, and at least a portion of liquid and at least a portion of solubilized lithium cations from the second membrane separator retentate inlet stream are transported from the retentate side of the second membrane separator, through a semi-permeable membrane of the second membrane separator, to a permeate side of the second membrane separator where the portion of the liquid and the portion of solubilized lithium cations form some or all of a second membrane separator permeate outlet stream that is transported out of the permeate side of the second membrane separator; and transporting a third membrane separator retentate inlet stream comprising at least a portion of the second membrane separator retentate outlet stream to a retentate side of a third membrane separator such that: a third membrane separator retentate outlet stream exits the retentate side of the third membrane separator, the third membrane separator retentate outlet stream having a concentration of solubilized lithium cations that is greater than a concentration of solubilized lithium cations of the third membrane separator retentate inlet stream, such that at least a portion of the third membrane separator retentate outlet stream is part of the concentrated stream, and at least a portion of liquid and at least a portion of solubilized lithium cations from the third membrane separator retentate inlet stream are transported from the retentate side of the third membrane separator, through a semi-permeable membrane of the third membrane separator, to a permeate side of the third membrane separator where the portion of the liquid and the portion of solubilized lithium cations form some or all of a third membrane separator permeate outlet stream that is transported out of the permeate side of the third membrane separator; wherein: the first membrane separator retentate inlet stream comprises at least a portion of the second membrane separator permeate outlet stream and/or at least a portion of the third membrane separator permeate outlet stream; the second membrane separator retentate inlet stream and/or the third membrane separator retentate inlet stream comprises at least a portion of the feed stream; a concentration of solubilized lithium cations in the feed stream is greater than or equal to 10 mg/L, and a ratio of a concentration of solubilized lithium cations in the concentrated stream to the concentration of solubilized lithium cations in the feed stream is greater than or equal to 4.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1A is a schematic diagram of a system for obtaining a lithium salt comprising a membrane separator that receives a feed stream and produces a retentate outlet stream that can form some or all of a concentrated stream, in accordance with certain embodiments;

FIG. 1B is a schematic diagram of a system for obtaining a lithium salt comprising a membrane separator that receives a feed stream and produces a retentate outlet stream that can form some or all of a concentrated stream, and where a recycle stream is fed back to a retentate inlet stream of the membrane separator, in accordance with certain embodiments;

FIG. 2A is a schematic diagram of a system for obtaining a lithium salt comprising a humidifier that receives a feed stream and produces a humidifier outlet stream that can form some or all of a concentrated stream, in accordance with certain embodiments;

FIG. 2B is a schematic diagram of a system for obtaining a lithium salt comprising a humidifier that receives a feed stream and produces a humidifier outlet stream that can form some or all of a concentrated stream, and where a humidified gas stream from the humidifier may be fed to a dehumidifier for condensation, in accordance with certain embodiments;

FIG. 3A is a schematic diagram of a system for obtaining a lithium salt comprising a membrane separator and a humidifier, in accordance with certain embodiments;

FIG. 3B is a schematic diagram of a system for obtaining a lithium salt comprising a first membrane separator, a second membrane separator, and a humidifier, in accordance with certain embodiments;

FIG. 3C is a schematic diagram of a system comprising a first membrane separator and a second membrane separator, according to some embodiments;

FIGS. 3D-3G are schematic diagrams of systems for obtaining a lithium salt comprising a first membrane separator, a second membrane separator, and a third membrane separator, according to some embodiments;

FIGS. 3H-3J are schematic diagrams of a system for obtaining a lithium salt comprising a first membrane separator, a second membrane separator, and an upstream membrane separator, according to some embodiments;

FIG. 3K is a schematic diagram of a system for obtaining a lithium salt comprising a first membrane separator, a second membrane separator, a third membrane separator, and an upstream membrane separator, according to some embodiments;

FIG. 4A is a schematic diagram of a system for obtaining a lithium salt comprising a non-lithium-containing salt production unit that receives a concentrated stream and produces an impurity-depleted concentrated stream, in accordance with certain embodiments;

FIG. 4B is a schematic diagram of a system for obtaining a lithium salt comprising a non-lithium-containing salt production unit comprising a precipitation unit and a cooling unit, in accordance with certain embodiments;

FIGS. 5A-5B are schematic diagrams showing an electrochemical cell with an initial solution (FIG. 5A) and during application of a voltage (FIG. 5B), in accordance with certain embodiments;

FIG. 5C is a schematic diagram of a system for obtaining a lithium salt comprising an electrochemical cell and a humidifier, in accordance with certain embodiments;

FIG. 6A is a schematic diagram of a system for obtaining a lithium salt comprising a membrane separator, a first humidifier, a non-lithium-containing salt production unit, an electrochemical cell, a second humidifier, and a solid lithium salt formation unit, in accordance with certain embodiments;

FIG. 6B is a schematic diagram of a system for obtaining a lithium salt comprising a first membrane separator, a second membrane humidifier, a first humidifier, a non-lithium-containing salt production unit, an electrochemical cell, a second humidifier, and a solid lithium salt formation unit, in accordance with certain embodiments;

FIG. 7A is a schematic illustration of a single-membrane membrane separator, in accordance with certain embodiments;

FIG. 7B is a schematic illustration of a membrane separator comprising multiple semi-permeable membranes fluidically connected in parallel, in accordance with certain embodiments;

FIG. 7C is a schematic illustration of a membrane separator comprising multiple semi-permeable membranes fluidically connected in series, in accordance with certain embodiments;

FIG. 8A is a plot of recovery percentage versus feed salinity for various examples of membranes;

FIG. 8B is a plot of rejection percentage versus feed salinity for various examples of membranes;

FIG. 9 is a schematic illustration of a system for obtaining a lithium salt from a brine, in accordance with certain embodiments;

FIG. 10 is a schematic illustration of a system for obtaining a lithium salt from a solution comprising anions such as sulfate and carbonate, in accordance with certain embodiments;

FIG. 11 is a schematic illustration of a system for obtaining a lithium salt from a solution derived from lithium ion batteries, in accordance with certain embodiments;

FIG. 12 is a schematic illustration of a system for concentrating a lithium-containing stream, in accordance with certain embodiments;

FIG. 13A is a schematic diagram of a system for obtaining a lithium salt comprising a membrane separator that receives a feed stream treated by a boron-selective medium and produces a retentate outlet stream that can form some or all of a concentrated stream, in accordance with certain embodiments; and

FIG. 13B is a schematic diagram of a system for obtaining a lithium salt comprising a membrane separator that receives a feed stream and produces a retentate outlet stream that can form some or all of a concentrated stream treated that can be treated by a boron-selective medium, in accordance with certain embodiments.

FIG. 14A is a schematic diagram of a system for obtaining a lithium salt comprising a first membrane separator and a second membrane separator, according to some embodiments;

FIG. 14B-14D are schematic diagrams of a system for obtaining a lithium salt comprising a first membrane separator, a second membrane separator, and a third membrane separator, according to some embodiments; and

FIG. 15A-15C are schematic diagrams of a system for obtaining a lithium salt comprising a first membrane separator, a second membrane separator, and a third membrane separator, according to some embodiments.

### DETAILED DESCRIPTION

Methods and systems directed to recovery of lithium (e.g., as lithium salts) from liquid streams are provided. In some embodiments, methods relate to obtaining lithium (e.g., as a solid lithium salt) by removing at least a portion of liquid from a feed stream to form a concentrated stream with respect to solubilized lithium cations. Liquid removal may include transporting at least a portion of the feed stream to a membrane separator and/or a humidifier. Some methods include removing impurities (e.g., non-lithium cations) from the concentrated stream (e.g., via precipitation and/or crystallization). In some embodiments, solutions containing solubilized lithium cations and anions are electrochemically-treated such that first solubilized anions are replaced with second, different anions. In some embodiments, solid lithium salt containing at least a portion of the lithium cations and the second anions are obtained (e.g., via precipitation and/or crystallization following concentration of an electrochemically-treated solution in a humidifier).

Recovery of lithium (e.g., lithium salts) from liquids (e.g., brines, ores, battery waste) is a commercially and industrially important process. However, such recovery can be difficult because typical lithium sources also include one or more impurities. For example, typical brines having appreciable lithium ion content have orders of magnitude greater concentrations of sodium, potassium, calcium and, in some instances, other ions such as magnesium, iron, aluminum, manganese, strontium, and/or barium. Certain strategies for separating lithium ions from potential impurities rely on chemical treatment of liquid sources. The chemical treatment may be used to selectively precipitate non-lithium cations. For example, liquid sources comprising lithium, potassium, and sodium may be chemically treated to form sulfates (e.g., by salt metathesis). Lower solubilities of potassium sulfates and sodium sulfates compared to lithium sulfates can be leveraged for separation (e.g., via selective precipitation and/or concentration). These typical lithium separation techniques tend to require energy-intensive and/or slow concentration (e.g., via solar concentration) and chemical treatment/separation processes that are expensive and capital-intensive.

It has been realized in the context of this disclosure that improved liquid concentration techniques (e.g., in terms of energy expenditure and/or speed) are possible by using different liquid concentration and/or ion exchange techniques than are typically employed for lithium recovery. For example, membrane-based separation and humidification/dehumidification techniques, either alone or in combination, can provide relatively high concentrations of lithium ions from a variety of sources at greater speed and/or lower energy expenditure than typical techniques. Furthermore, membrane-based separation and humidification/dehumidification processes can promote greater liquid recovery, lower liquid consumption, and less waste production requiring discharge than typical lithium recovery techniques. It has also been realized that electrochemical treatment of solutions rich in lithium can, in some instances, reliably and efficiently exchange anions to produce commercially valuable lithium salts, such as lithium hydroxides. Electrochemical treatment techniques (e.g., electrolysis) can, in some embodiments, be readily integrable with membrane-based separation and/or humidification/dehumidification techniques to yield lithium in a desirable form (e.g., solid lithium salts such as crystallized lithium hydroxide).

In some membrane-based separation processes, such as reverse osmosis and nanofiltration, hydraulic pressure is applied to promote passage of liquid through a semi-permeable membrane. In many such systems, the amount of hydraulic pressure required to cause passage of liquid through the membrane scales with the difference in solute concentration and/or osmotic pressure between the retentate side and the permeate side of the membrane. It can be desirable to configure systems and methods to reduce the required hydraulic pressure for a given solute concentration and/or osmotic pressure in order to promote energy efficiency, an increase in concentration limits, and/or promote the durability of the system. It has been realized that one way to reduce required hydraulic pressure is to permit a greater portion of the influent solute (e.g., comprising solubilized lithium cations and/or solubilized non-lithium cations) to pass through the membrane compared to high-rejection (e.g., 99.9% rejection or 100% rejection) reverse osmosis (RO) membranes. Highly saline streams may be treated (e.g., desalinated) with such a membrane configuration because the higher solute permeability can reduce the required hydraulic pressure. In some instances, the membranes are configured such that a greater portion of the influent solute (e.g., solute ions such as lithium cations) are rejected by the membrane as compared to nanofiltration (NF) membranes, reducing permeate salinity and increasing retentate outlet salinity. It is believed that highly concentrated streams can be produced using such membranes as compared to lower-rejection nanofiltration membranes because the lower ion permeability increases the degree of separation. But, it has also been realized in the context of this disclosure that performance of at least some membrane-based separation systems is based, at least in part, on the amount of permeate generated by the membranes and the extent of separation carried out by the membrane at a given operating condition. In the context of this disclosure, the amount of permeate generated (defined as a percentage calculated by dividing the value of the permeate outlet mass flow by the value of the retentate inlet mass flow and multiplying by 100) at a membrane separator is referred to as “recovery”. Also in the context of this disclosure, the extent of separation is described by the “rejection” of the membrane, as explained in more detail below. Generally, an increase in the feed salinity for a membrane results in a decrease in the recovery as well as rejection achieved by the membrane. Decreased recovery and rejection can result in poor membrane performance, and in such a case a substantially larger amount of membrane area may be required to separate certain liquids (e.g., to desalinate higher salinity waters).

One way to address the issues described above is to employ systems having multiple stages (e.g., membrane separators), where the retentate outlet stream from a previous stage is transported to the next stage as the retentate inlet stream for further concentration. At least because water permeability decreases substantially with increasing salinity (or solute concentration), the ability of a given membrane in subsequent stages to concentrate the stream further can become limited. In some embodiments, this potential problem for system performance is addressed at least in part by using membranes with varying (e.g., in some instances increasing) permeability as a function of increasing salinity in a multiple stage system.

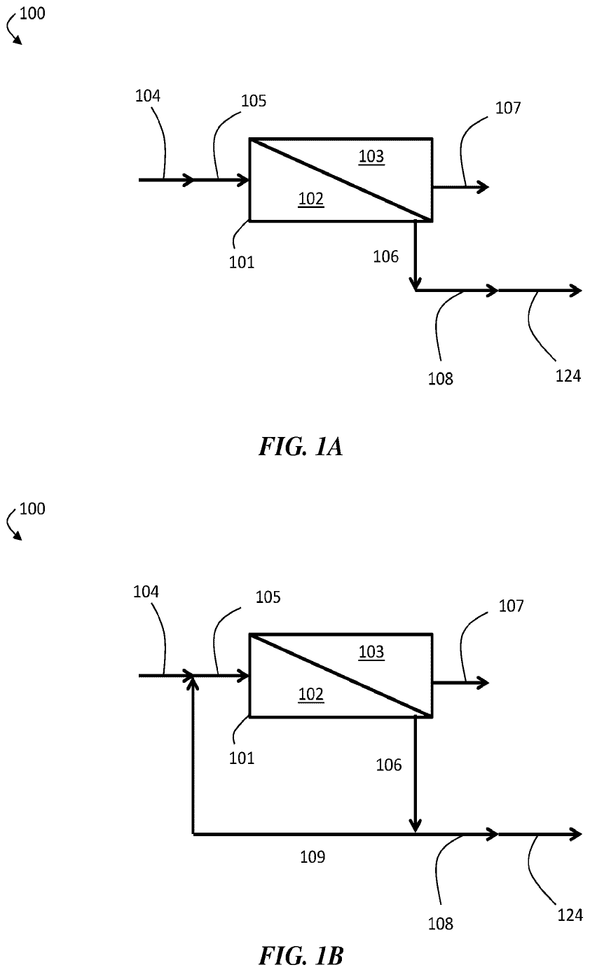

One aspect of this disclosure is directed to the recovery of lithium from liquids (e.g., from liquid streams). Lithium recovery may comprise obtaining lithium (e.g., as lithium salt) from such liquids. Lithium recovery may be performed using a lithium recovery system. FIGS. 1A-3K, 6A-6B, and 13A-15C are schematic diagrams of examples of lithium recovery system 100, according to certain embodiments. In some embodiments, some or all of the lithium is recovered in the form of a lithium salt in a solid form. In some embodiments, some or all of the lithium is recovered in the form of a solution comprising solubilized lithium cations. In some embodiments, some or all of the lithium is recovered in the form of a solution or suspension comprising a relatively high concentration of lithium cations compared to non-lithium cations.

In some embodiments, a lithium salt is obtained at least in part by removing at least a portion of liquid from a feed stream comprising the liquid, a solubilized lithium cation, and a solubilized non-lithium cation, to form a concentrated stream. As described in more detail below, the concentrated stream may be subjected to one or more further downstream processes as part of the method of obtaining lithium (e.g., as a lithium salt), such as removal of impurities (e.g., non-lithium cations), anion exchange, and/or solid lithium salt formation (e.g., via precipitation or crystallization). In some embodiments, at least some (e.g., at least 75 wt %, at least 80%, at least, at least 90 wt %, at least 95 wt %, at least 98 wt %, at least 99 wt %, at least 99.9 wt %, or even 100 wt %) of the liquid of the feed stream is removed during formation of the concentrated stream. In some embodiments, at least some of the liquid is removed from the feed stream via a membrane separator and/or a humidifier, as described in more detail below.

The methods and systems described herein can be used to process a variety of feed streams. Generally, the feed stream comprises at least one liquid and at least one solubilized species (also referred to herein as a solute). According to certain embodiments, the feed stream comprises solubilized ions. The solubilized ion(s) may originate, for example, from a salt that has been dissolved in the liquid of the feed stream. A solubilized ion is generally an ion that has been solubilized to such an extent that the ion is no longer ionically bonded to a counter-ion. As mentioned above, the feed stream may comprise a solubilized lithium cation and at least one solubilized non-lithium cation. The solubilized non-lithium cation may be a non-lithium monovalent cation (i.e., a cation having a redox state of +1 when solubilized). In some embodiments, the non-lithium cation is a divalent cation (i.e., a cation having a redox state of +2 when solubilized). In some embodiments, the non-lithium cation is chosen from one or more of sodium cation (Na⁺), potassium cation (K⁺), magnesium cation (Mg²⁺), and calcium cation (Ca²⁺). In addition to the solubilized lithium cation and non-lithium cation(s), the feed stream may comprise any of a variety of other solubilized species. For example, the feed stream may comprise solubilized anions. The solubilized anions may include monovalent anions (i.e., anions having redox state of −1 when solubilized) and/or divalent anions (i.e., anions having redox state of −2 when solubilized). In some embodiments, the feed stream comprises an anion chosen from one or more of chloride, sulfate, carbonate, bicarbonate, nitrate, borate, phosphate, bromide, citrate, oxide, and hydride. Cations and/or anions having other valencies may also be present in feed streams (e.g., an aqueous feed stream), in some embodiments.

In some embodiments, the total concentration of solubilized ions in the feed stream can be relatively high. One advantage associated with certain embodiments is that initial feed streams (e.g., aqueous feed streams) with relatively high solubilized ion concentrations can undergo liquid removal (e.g., for lithium concentrating) without the use of energy intensive desalination methods. In certain embodiments, the total concentration of solubilized ions in the feed stream transported into a lithium recovery system is at least 1,000 mg/L, at least 5,000 mg/L, at least 10,000 mg/L, at least 12,000 mg/L, at least 14,000 mg/L, and/or up to 50,000 mg/L, up to 60,000 mg/L, up to 100,000 mg/L, up to 500,000 mg/L, or greater.

According to certain embodiments, the feed stream that is transported to the lithium recovery system comprises a suspended and/or emulsified immiscible phase. Generally, a suspended and/or emulsified immiscible phase is a material that is not soluble in water to a level of more than 10% by weight at the temperature and other conditions at which the stream is operated. In some embodiments, the suspended and/or emulsified immiscible phase comprises oil and/or grease. The term “oil” generally refers to a fluid that is more hydrophobic than water and is not miscible or soluble in water, as is known in the art. Thus, the oil may be a hydrocarbon in some embodiments, but in other embodiments, the oil may comprise other hydrophobic fluids. In some embodiments, at least 0.1 wt %, at least 1 wt %, at least 2 wt %, at least 5 wt %, or at least 10 wt % (and/or, in some embodiments, up to 20 wt %, up to 30 wt %, up to 40 wt %, up to 50 wt %, or more) of a feed stream (e.g., an aqueous feed stream) is made up of a suspended and/or emulsified immiscible phase.

In some embodiments, the feed stream is treated to remove at least some impurities prior to liquid removal steps described below. For example, impurities such as heavy metals (e.g., iron, aluminum, manganese, barium, strontium) or silica can be removed from the feed stream prior to liquid removal (e.g., prior to the membrane-based separation and/or humidifier concentration processes described below). In some instances, at least some of these impurities are removed via chemical precipitation. Such a chemical precipitation process may include addition of reagents including, but not limited to, aluminates (e.g., sodium aluminate), inorganic compounds (e.g., FeCl₃), activated alumina, hypochlorites (e.g., sodium hypochlorite), bases (e.g., caustic soda (NaOH)), acids, and/or polymers. The feed stream may also be fed through one or more ion exchange media, such as an ion exchange column, prior to undergoing the liquid removal steps described below.

While one or more components of the lithium recovery system can be used to separate a suspended and/or emulsified immiscible phase from an incoming feed stream, such separation is optional. For example, in some embodiments, the feed stream transported to the lithium recovery system is substantially free of a suspended and/or emulsified immiscible phase. In certain embodiments, one or more separation units upstream of the lithium recovery system can be used to at least partially remove a suspended and/or emulsified immiscible phase from a feed stream before the feed stream is transported to a component of the lithium recovery system (e.g., a membrane separator and/or humidifier). Non-limiting examples of such systems are described, for example, in International Patent Publication No. WO 2015/021062, published on Feb. 12, 2015, which is incorporated herein by reference in its entirety for all purposes.

In some embodiments, the feed stream can be derived from seawater, ground water, brackish water, and/or the effluent of a chemical process. In some cases, the systems and methods described herein can be used to recover lithium from and in some instances at least partially desalinate aqueous feed streams derived from such process streams. As one example, the feed stream may be derived from water used in applications that expose water to salts and minerals, such as some mining methods. As another example, the feed stream may be a product of an ion extraction process from waste sources, such as spent lithium ion batteries. In some embodiments, the feed stream is or is derived from a lithium-containing brine. Such brines may be sourced from, for example, the Dead Sea in Israel, the Great Salt Lake in the USA, Searles Lake in the USA, Clayton Valley in the USA, Salton Sea in the USA, Bonneville in the USA, Sua Pan in India, Zabuye in China, Taijinaier in China, Salar de Uyuni in Bolivia, Salton Sea in the USA, Salar del Hombre Muerto in Argentina, and/or Salar de Atacama in Chile.

A variety of types of liquids could also be used in the feed stream. In some embodiments, the liquid of the feed stream comprises water. For example, in some embodiments, at least 10 wt %, at least 25 wt %, at least 50 wt %, at least 75 wt %, at least 90 wt %, at least 95 wt %, at least 98 wt %, at least 99 wt %, at least 99.9 wt %, or more (e.g., all) of the liquid is water. Other examples of potential liquids for the feed steam include, but are not limited to alcohols and/or hydrocarbons. The liquid of the feed stream may be a mixture of different liquid-phase species. For example, the liquid may be a mixture of water and a water-miscible organic liquid, such as an alcohol.

The feed stream may have any of a variety of concentrations of solubilized lithium cations, depending on the feed stream source and/or desired application. The versatility of the techniques described in this disclosure may allow for lithium recovery from relatively lithium-poor liquid sources due to an ability in some embodiments to effectively concentrate liquids by orders of magnitude. Alternatively or in addition, the versatility of the techniques described in this disclosure may allow for lithium recovery from relatively lithium-rich sources due to an ability in some embodiments to remove liquid from highly concentrated streams with comparatively low energy input and/or stress on system components compared to typical concentration techniques. In some embodiments, the feed stream has a concentration of solubilized lithium cations of greater than or equal to 10 mg/L, greater than or equal to 50 mg/L, greater than or equal to 100 mg/mL, greater than or equal to 200 mg/L, greater than or equal to 500 mg/L, or higher. In some embodiments, the feed stream has a concentration of solubilized lithium cations of less than or equal to 2,000 mg/L, less than or equal to 1,600 mg/mL, less than or equal to 1,200 mg/L, less than or equal to 1,000 mg/L, less than or equal to 800 mg/L, less than or equal to 680 mg/L, less than or equal to 600 mg/L, or less. Combinations of these ranges (e.g., greater than or equal to 10 mg/L and less than or equal to 2,000 mg/L or greater than or equal to 10 mg/L and less than or equal to 680 mg/L) are possible. The concentration of one or more solubilized ions (e.g., lithium cations, non-lithium cations, etc.) may be measured according to any method known in the art. For example, suitable methods for measuring the concentration of one or more solubilized ions include inductively coupled plasma (ICP) spectroscopy (e.g., inductively coupled plasma optical emission spectroscopy). As one non-limiting example, an Optima 8300 ICP-OES spectrometer may be used.

The concentrated stream formed by the removal of the liquid from the feed stream may have a higher concentration of solubilized lithium cations compared to the feed stream. It has been realized in the context of this disclosure that concentrating lithium cations (e.g., by removing liquid) can promote, in some instances, effective removal of impurities such as non-lithium cations. For example, as described below, some embodiments leverage solubility differences between at least some lithium salts and non-lithium-containing salts. First achieving relatively high concentrations of solubilized lithium cations (and/or non-lithium cations as well) can facilitate such separation processes. Some techniques described below (e.g., membraned-based separation, humidification) can in some instances accomplish lithium cation concentration relatively efficiently in terms of energy and/or operational expenditure. In some embodiments, a ratio of a concentration of solubilized lithium cations in the concentrated stream to a concentration of solubilized lithium cations in the feed stream is greater than or equal to 4, greater than or equal to 5, greater than or equal to 10, greater than or equal to 20, greater than or equal to 25, and/or up to 30, up to 40, up to 50, or greater.

In some embodiments, the concentrated stream has a relatively high concentration of solubilized lithium cations. For example, in some embodiments, the concentrated stream has a concentration of solubilized lithium cations of greater than or equal to 40 mg/L, greater than or equal to 50 mg/L, greater than or equal to 100 mg/L, greater than or equal to 200 mg/L, greater than or equal to 500 mg/L, greater than or equal to 1,000 mg/L, greater than or equal to 2,000 mg/L, greater than or equal to 5,000 mg/L, greater than or equal to 10,000 mg/L, greater than or equal to 20,000 mg/L, greater than or equal to 30,000 mg/L, and/or up to 50,000 mg/L, or greater.

In some embodiments, at least some (e.g., at least 5 wt %, at least 10 wt %, at least 20 wt %, at least 50 wt %, at least 80 wt %, at least 90 wt %, at least 95 wt %, at least 99 wt %, or more) of the liquid removed during the removing step is removed using one or more membrane separators. A membrane separator refers to a collection of components including one or more semi-permeable membranes configured to perform a membrane-based separation process (e.g., an osmotic process such as a reverse osmosis process, a filtration process, or a combination thereof) on at least one input stream and produce at least one output stream. A membrane separator may comprise at least one semi-permeable membrane defining a permeate side of the first membrane separator and a retentate side of the first membrane separator. For example, referring to FIGS. 1A-1B, 3A-3K, 6A-6B, lithium recovery system 100 comprises first membrane separator 101 comprising retentate side 102 and permeate side 103 and is arranged such that membrane separator 101 can receive at least a portion of feed stream 104. Each membrane separator described herein may include further sub-units such as, for example, individual semi-permeable membrane modules (e.g., in the form of cartridges), valving, fluidic conduits, and the like. As described in more detail below, each membrane separator can include a single semi-permeable membrane or multiple semi-permeable membranes. In some embodiments, a single membrane separator can include multiple sub-units (e.g., multiple modules such as multiple cartridges) that may or may not share a common container.

In some embodiments, a first membrane separator retentate inlet stream (which may comprise at least a portion (e.g., at least 5 wt %, at least 10 wt %, at least 20 wt %, at least 50 wt %, at least 80 wt %, at least 90 wt %, at least 95 wt %, at least 99 wt %, or more) of liquid from the feed stream, optionally with one or more other streams) is transported to a retentate side of the first membrane separator such that a first membrane separator retentate outlet stream exits the retentate side of the first membrane separator, the first membrane separator retentate outlet stream having a concentration of solubilized lithium cations that is greater than a concentration solubilized lithium cations in the first membrane separator retentate inlet stream (e.g., by a factor of at least 1.03, at least 1.035, at least 1.05, at least 1.10, at least 1.25, and/or up to 1.40, up to 1.50, up to 2, up to 3, up to 4, up to 5 or greater). For example, referring again to FIGS. 1A-1B, 3A-3K, 6A-6B, and 13A-15C, first membrane separator 101 may comprise at least one semi-permeable membrane defining retentate side 102 and permeate side 103, and first membrane separator retentate inlet stream 105 may be transported to retentate side 102 such that first membrane separator retentate outlet stream 106 exits retentate side 102. In some embodiments, such as those shown in FIGS. 1A-1B, 3A-3K, and 6A-6B, first membrane separator retentate inlet stream 105 comprises at least a portion of feed stream 104. The step may be performed such that first membrane separator retentate outlet stream 106 has a concentration of solubilized ions (e.g., solubilized lithium cations) that is greater than a concentration of solubilized lithium cations in first membrane separator retentate inlet stream 105, according to some embodiments. Unless expressly stated otherwise, reference to amounts of substances (e.g., concentration comparisons) described in this disclosure are on a mass basis (e.g., g/mL for concentrations and weight percent for percentages such as salinities). However, the concentration comparisons could also be expressed on an atomic or molar basis.

In some embodiments, a hydraulic pressure is applied (e.g., to facilitate transport of liquid and/or solute from the retentate side to the permeate side). In some embodiments, the system is operated such that the first membrane separator retentate inlet stream has a hydraulic pressure of at least 200 psi (at least 1.38×10³ kPa), at least 500 psi (at least 3.45×10³ kPa), at least 750 psi (at least 5.17×10³ kPa), at least 1000 psi (at least 6.90×10³ kPa), and/or up to 1500 psi (up to 1.03×10⁴ kPa), up to 2000 psi (up to 1.38×10⁴ kPa), or more.

In some embodiments, at least a portion (e.g., at least 5 wt %, at least 10 wt %, at least 20 wt %, at least 50 wt %, at least 80 wt %, and/or up to 90 wt %, up to 95 wt %, up to 99 wt %, or more) of liquid from the first membrane separator retentate inlet stream is transported from the retentate side of the first membrane separator, through a semi-permeable membrane of the membrane separator, to a permeate side of the first membrane separator. Referring again to FIGS. 1A-1B, 3A-3K, 6A-6B, and 13A-15C, for example, at least a portion of liquid from first membrane separator retentate inlet stream 105 may be transported from retentate side 102, through a semi-permeable membrane, to permeate side 103. Liquid transported from the retentate side to the permeate side of the first membrane separator may form some or all of a first membrane separator permeate outlet stream (e.g., membrane separator permeate outlet stream 107 in FIGS. 1A-1B, 3A-3K, 6A-6B, and 13A-15C), which may be discharged from the system (e.g., as substantially pure liquid such as substantially pure water).

In some, but not necessarily all embodiments, a portion (e.g., at least 5 wt %, at least 10 wt %, at least 20 wt %, at least 50 wt %, at least 80 wt %, and/or up to 85 wt %, up to 90 wt %, or more) of the solubilized lithium cations from the first membrane separator retentate inlet stream are transported from the retentate side of the first membrane separator, through a semi-permeable membrane of the first membrane separator, to a permeate side of the first membrane separator. However, in some embodiments, less than or equal to 20 wt %, less than or equal to 10 wt %, less than or equal to 5 wt %, less than or equal to 2 wt %, less than or equal to 1 wt %, less than or equal to 0.1 wt %, or less (e.g., none) of the solubilized lithium cations from the first membrane separator retentate inlet stream are transported from the retentate side of the first membrane separator, through a semi-permeable membrane of the first membrane separator, to a permeate side of the first membrane separator.

In some, but not necessarily all embodiments, a portion (e.g., at least 5 wt %, at least 10 wt %, at least 20 wt %, at least 50 wt %, at least 80 wt %, and/or up to 85 wt %, up to 90 wt %, or more) of any solubilized non-lithium cations present in the first membrane separator retentate inlet stream are transported from the retentate side of the first membrane separator, through a semi-permeable membrane of the first membrane separator, to a permeate side of the first membrane separator. However, in some embodiments, less than or equal to 20 wt %, less than or equal to 10 wt %, less than or equal to 5 wt %, less than or equal to 2 wt %, less than or equal to 1 wt %, less than or equal to 0.1 wt %, or less (e.g., none) of the solubilized non-lithium cations from the first membrane separator retentate inlet stream are transported from the retentate side of the first membrane separator, through a semi-permeable membrane of the first membrane separator, to a permeate side of the first membrane separator.

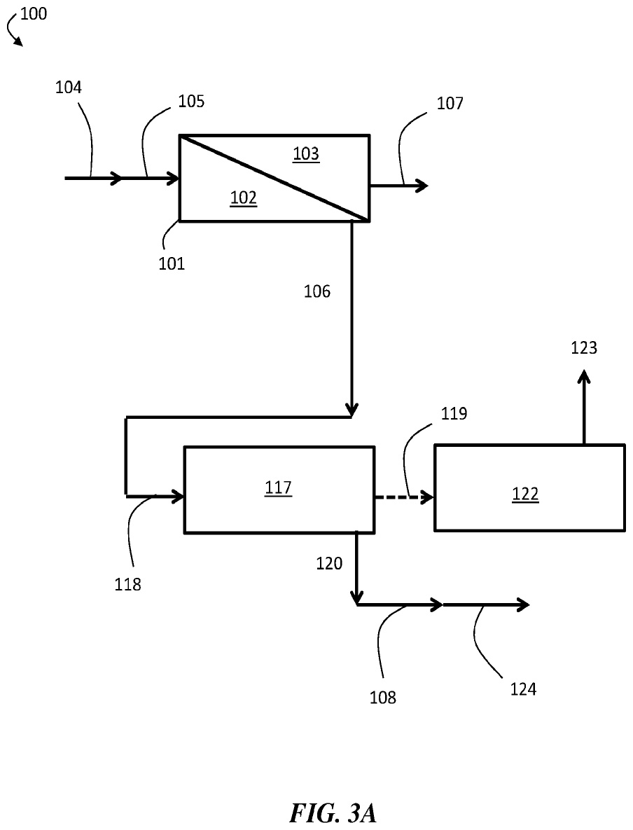

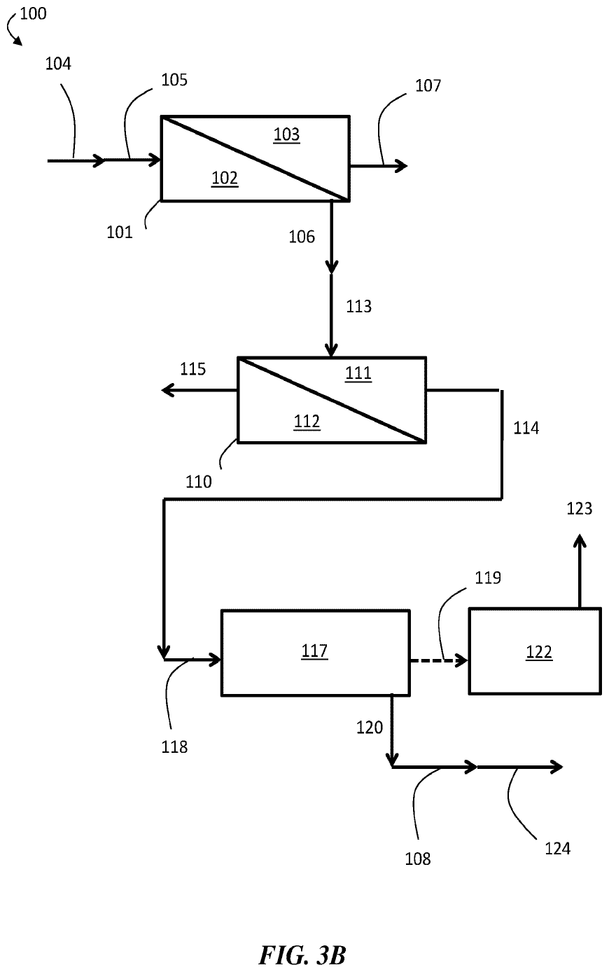

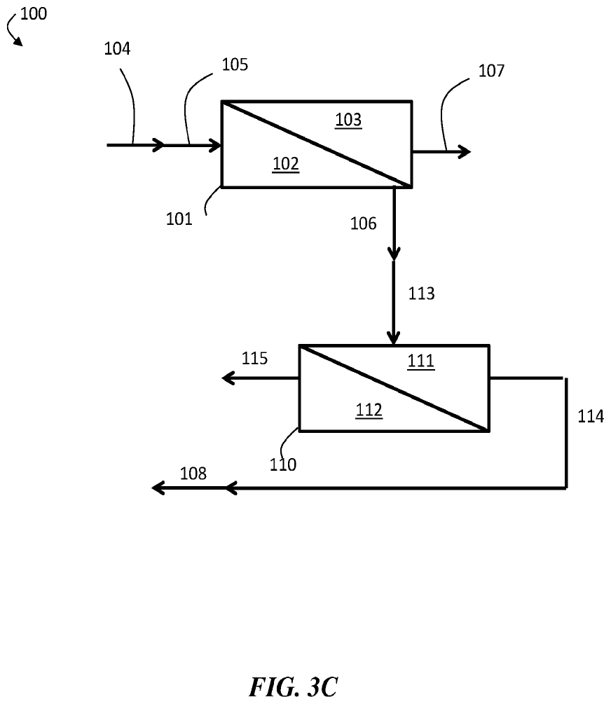

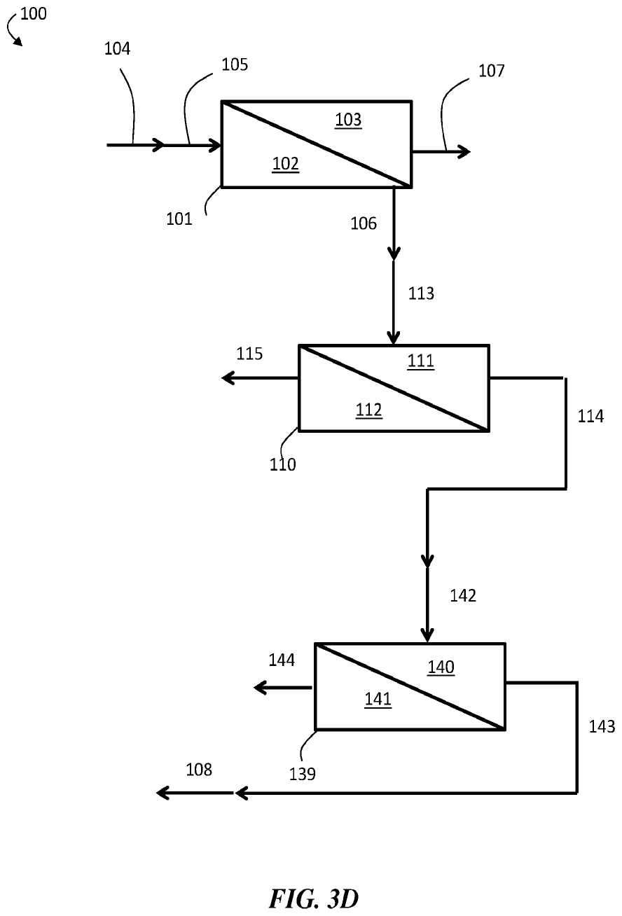

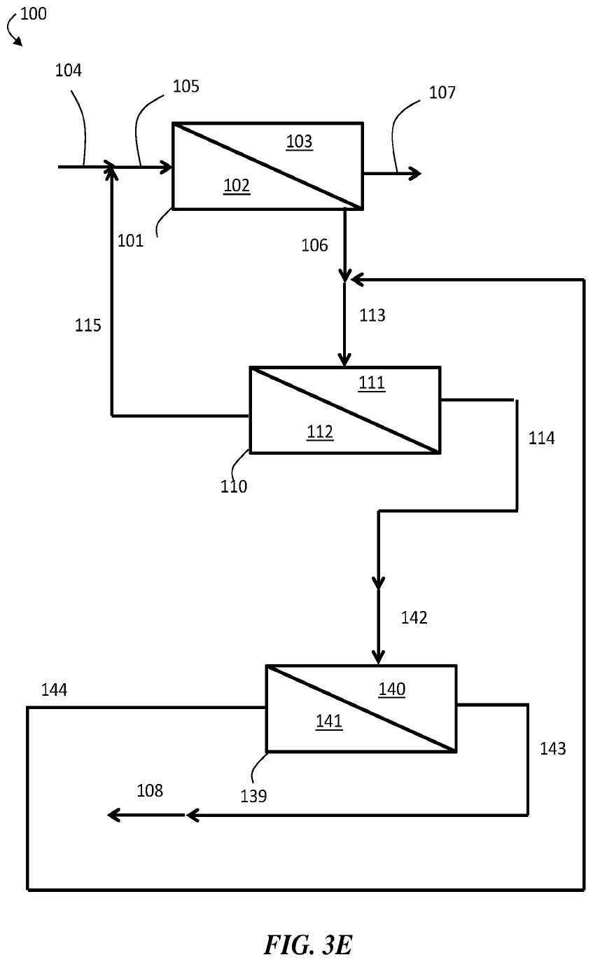

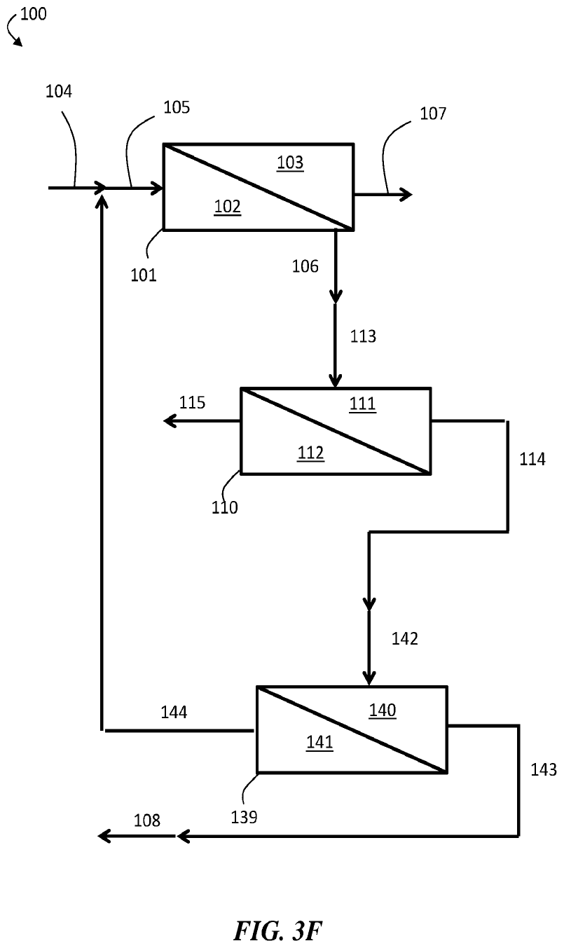

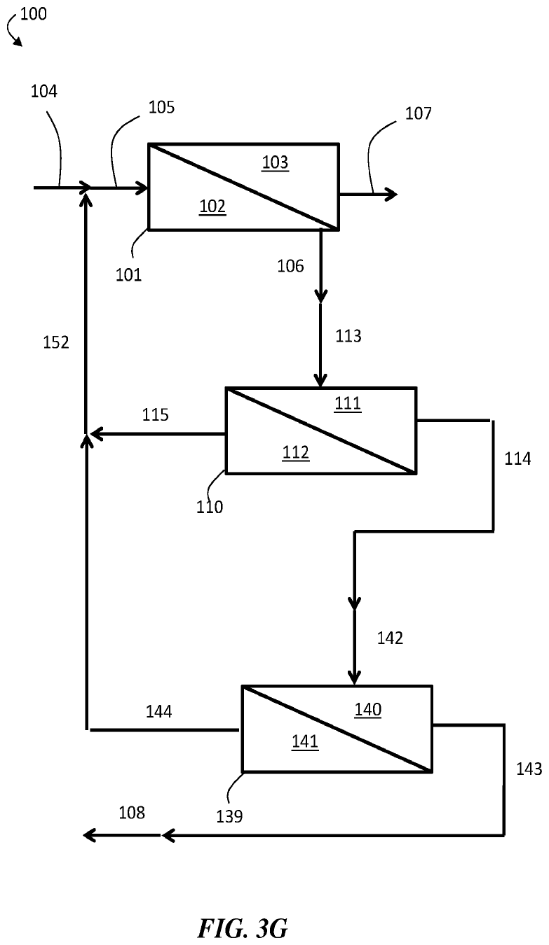

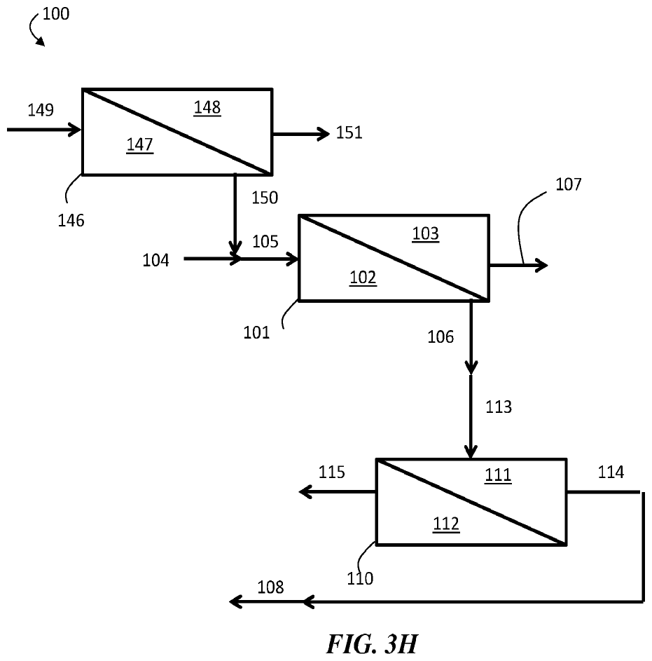

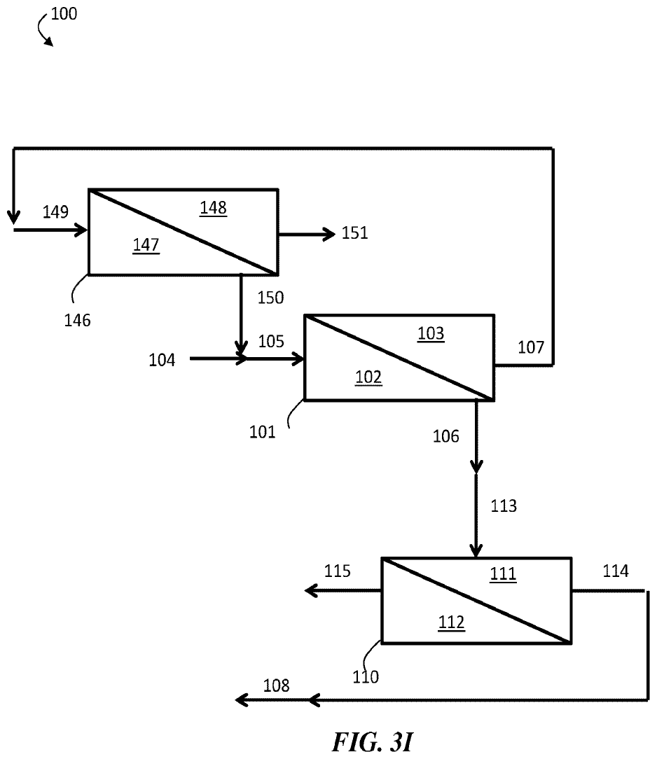

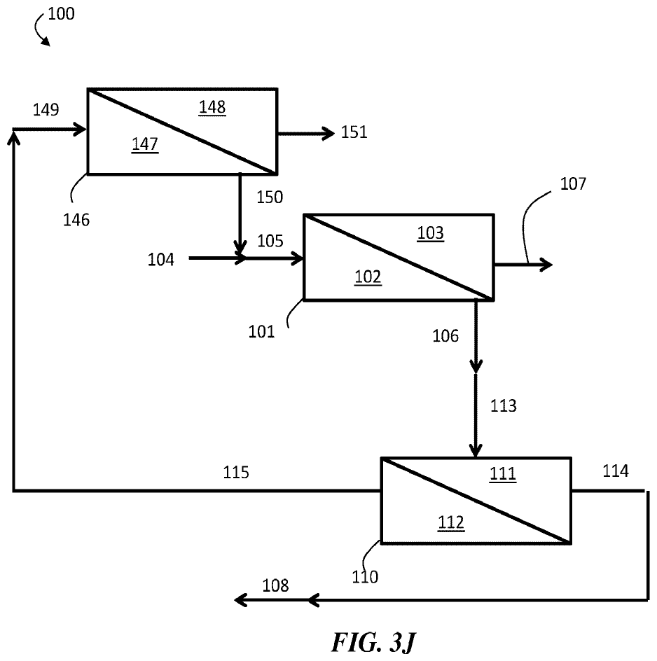

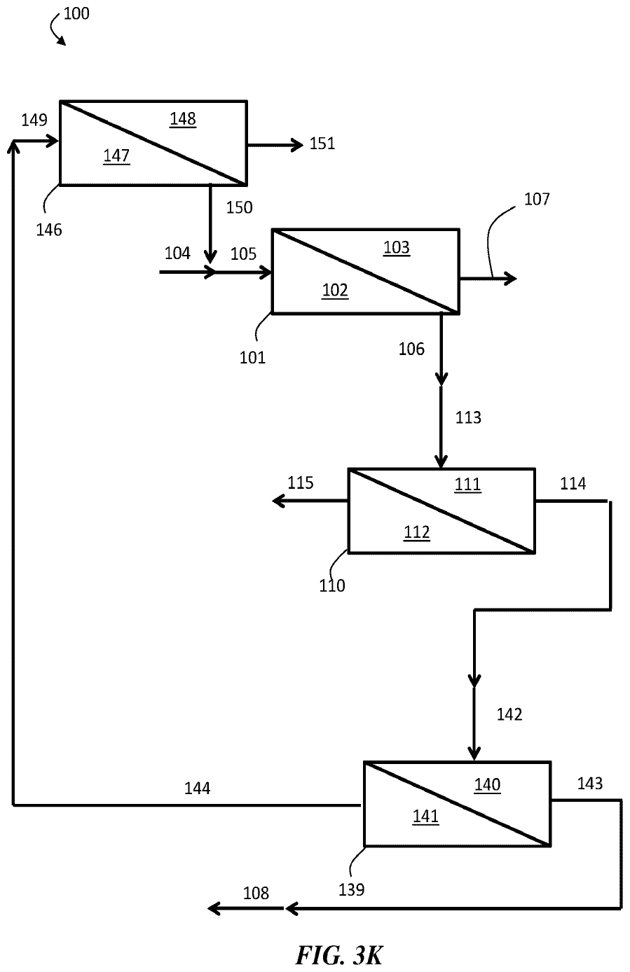

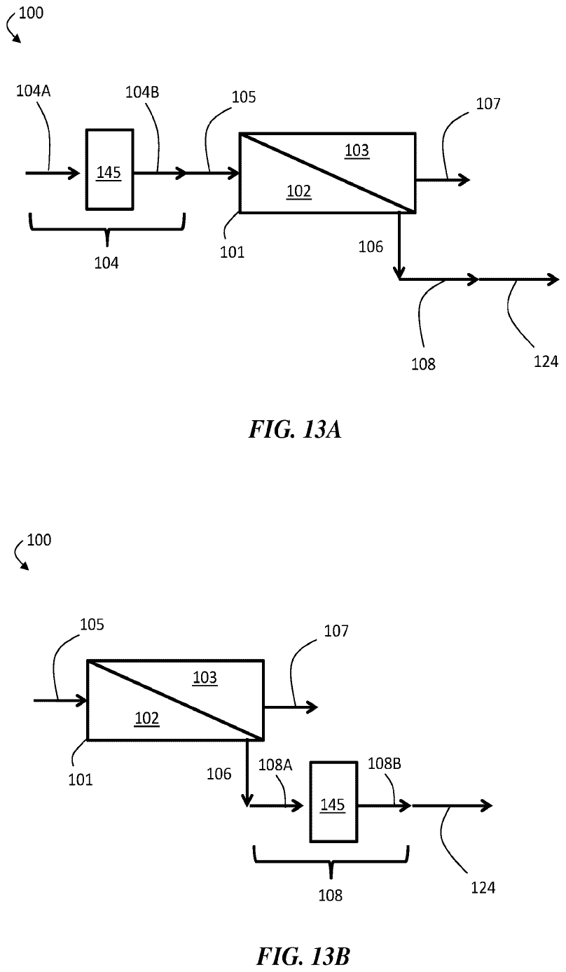

In some embodiments, the method of obtaining lithium (e.g., as a lithium salt) is performed such that at least a portion (e.g., at least 5 wt %, at least 10 wt %, at least 20 wt %, at least 50 wt %, at least 80 wt %, at least 90 wt %, at least 95 wt %, at least 99 wt %, or more) of the first membrane separator retentate outlet stream is part of the concentrated stream. For example, in FIGS. 1A-1B and 13A-13B, at least a portion of first membrane separator retentate outlet stream 106 is part of concentrated stream 108. While FIGS. 1A-1B shows membrane separator retentate outlet stream 106 being directly fed to concentrated steam 108, other arrangements are possible. For example, in some embodiments, the portion of the first membrane separator retentate outlet stream that ultimately becomes part of the concentrated stream first goes through one or more intervening processes (e.g., by being transported through one or more further membrane separators and/or humidifiers such as in FIGS. 3A-3K, 6A-6B, and 14A-15C).

In some embodiments, one or more membrane separators (e.g., the first membrane separator) is operated as an osmotic separator. For example, in some embodiments, the semi-permeable membrane is an osmotic membrane. Transport of liquid (e.g., water) through osmotic membrane(s) of osmotic units can be achieved via a transmembrane net driving force (i.e., a net driving force through the thickness of the membrane(s)), according to certain embodiments. Generally, the transmembrane net driving force (AX) is expressed as:

$$Δχ = Δ P - Δ \prod = ( {P}_{1} - {P}_{2} ) - ( {\prod }_{1} - {\prod }_{2} ) \qquad [ 1 ]$$

wherein P₁ is the hydraulic pressure on the retentate side of the osmotic membrane, P₂ is the hydraulic pressure on the permeate side of the osmotic membrane, Π₁ is the osmotic pressure of the stream on the retentate side of the osmotic membrane, and Π₂ is the osmotic pressure of the stream on the permeate side of the osmotic membrane. (P₁-P₂) can be referred to as the transmembrane hydraulic pressure difference, and (Π₁-Π₂) can be referred to as the transmembrane osmotic pressure difference.

Those of ordinary skill in the art are familiar with the concept of osmotic pressure. The osmotic pressure of a particular liquid is an intrinsic property of the liquid. The osmotic pressure can be determined in a number of ways, with the most efficient method depending upon the type of liquid being analyzed. For certain solutions with relatively low molar concentrations of ions, osmotic pressure can be accurately measured using an osmometer. In other cases, the osmotic pressure can simply be determined by comparison with solutions with known osmotic pressures. For example, to determine the osmotic pressure of an uncharacterized solution, one could apply a known amount of the uncharacterized solution on one side of a non-porous, semi-permeable, osmotic membrane and iteratively apply different solutions with known osmotic pressures on the other side of the osmotic membrane until the differential pressure through the thickness of the membrane is zero.

The osmotic pressure (Π) of a solution containing n solubilized species may be estimated as:

$$\prod = {\sum }_{j = 1}^{n} {i}_{j} {M}_{j} RT \qquad [ 2 ]$$

wherein iⱼ is the van't Hoff factor of the j^{th} solubilized species, Mⱼ is the molar concentration of the j^{th} solubilized species in the solution, R is the ideal gas constant, and T is the absolute temperature of the solution. Equation 2 generally provides an accurate estimate of osmotic pressure for liquid with low concentrations of solubilized species (e.g., concentrations at or below between about 4 wt % and about 6 wt %). For many liquids comprising solubilized species, at species concentrations above around 4-6 wt %, the increase in osmotic pressure per increase in salt concentration is greater than linear (e.g., slightly exponential).

As mentioned above, one type of osmotic separation technique that can be performed using the membrane separators of this disclosure, according to some embodiments, is reverse osmosis. Reverse osmosis generally occurs when the osmotic pressure on the retentate side of the osmotic membrane is greater than the osmotic pressure on the permeate side of the osmotic membrane, and a pressure is applied to the retentate side of the osmotic membrane such that the hydraulic pressure on the retentate side of the osmotic membrane is sufficiently greater than the hydraulic pressure on the permeate side of the osmotic membrane such that the osmotic pressure difference is overcome and solvent (e.g., water) is transported from the retentate side of the osmotic membrane to the permeate side of the osmotic membrane. Generally, such situations result when the transmembrane hydraulic pressure difference (P₁-P₂) is greater than the transmembrane osmotic pressure difference (Π₁-Π₂) such that liquid (e.g., water) is transported from the retentate side of the osmotic membrane to the permeate side of the osmotic membrane (rather than having liquid transported from the permeate side of the osmotic membrane to the first side of the osmotic membrane, which would be energetically favored in the absence of the pressure applied to the retentate side of the osmotic membrane).

In some embodiments, some or all of the membrane separators in the lithium recovery system are configured and operated to perform reverse osmosis (e.g., during methods of obtaining lithium). For example, in some embodiments, the first membrane separator is operated to perform reverse osmosis.

In some embodiments, at least a portion of a stream exiting one or more membrane separator is recirculated and fed back into the same membrane separator. Such recycle processes may allow for relatively high amounts of liquid to be removed by the membrane separator (in some instances using fewer system components) prior to further downstream processes compared to some embodiments in which no such recycle occurs.

As one example of a recycle process, in some embodiments the first membrane separator retentate inlet stream comprises at least a portion (e.g., at least 5 wt %, at least 10 wt %, at least 20 wt %, at least 50 wt %, at least 80 wt %, at least 90 wt %, at least 95 wt %, at least 99 wt %, or more) of the first membrane separator retentate outlet stream. The first membrane separator retentate inlet stream may comprise at least a portion of the first membrane separator retentate outlet stream during at least a period of time (e.g., an entirety or a subset of time) during operation of the first membrane separator as part of the methods described in this disclosure. As an illustrative example, the embodiment shown in FIG. 1B shows a portion of first membrane separator retentate outlet stream 106 being transported back to first membrane separator retentate inlet stream 105 as recycle stream 109. Recycle stream 109 may be combined with feed stream 104 to form at least part of first membrane separator retentate inlet stream 105. However, in some embodiments, such as during certain of the batch processes described below, the recycle stream comprising at least a portion of the first membrane separator retentate outlet stream is not mixed with the feed stream prior to or during incorporation of that portion of the first membrane separator retentate outlet stream into the first membrane separator retentate inlet stream. For example, in some embodiments, during at least a period of time during the liquid removal process, the first membrane separator retentate inlet stream comprises at least a portion of the first membrane separator retentate outlet stream, but less than or equal to 20 wt %, less than or equal to 10 wt %, less than or equal to 5 wt %, less than or equal to 2 wt %, less than or equal to 1 wt %, less than or equal to 0.1 wt %, or none of the first membrane separator retentate inlet stream is from the feed stream during that period of time.

During a recycle process, in accordance with some embodiments, at least some (or all) of a remainder of the first membrane separator retentate outlet stream not recirculated back to the retentate side of the membrane separator can become a part (or all) of the concentrated stream. In some embodiments, a hydraulic pressure of the recycle stream is increased (e.g., by at least 5%, at least 10%, at least 20%, at least 50%, at least 80%, at least 90%, at least 95%, at least 99%, or more) prior to becoming part of the first membrane separator retentate inlet stream. Such an increase in pressure can be accomplished using any of a variety of techniques, such as using a pump. In some instances, a recycle process involving a first membrane separator (e.g., incorporating a portion of the first membrane separator retentate outlet stream into the first membrane separator retentate inlet stream) is performed in a batch manner. In some embodiments, a recycle process is performed in a continuous manner. In some embodiments, a recycle process is performed using a semi-batch process. Batch operation, semi-batch operation, and continuous operation of membrane separators are generally known. During batch operation, a hydraulic pressure of the membrane separator retentate inlet stream is increased over time during operation, as quantities of streams are fed to the retentate side inlet stream. It has been realized in the context of this disclosure that batch or semi-batch operation of a process involving a membrane separator (e.g., a recycle process) can reduce an amount of energy required to operate the membrane separator by gradually increasing a concentration (and in some instances the hydraulic pressure) of the membrane separator retentate inlet stream rather than maintaining an entirety of the membrane separator's streams at a high pressure, as is generally the case during continuous operation. Such a reduction in energy usage may allow for lithium recovery with greater energy efficiency and/or lower cost than typical existing lithium recovery technologies.

In some embodiments, at least some (e.g., at least 5 wt %, at least 10 wt %, at least 20 wt %, at least 50 wt %, at least 80 wt %, at least 90 wt %, at least 95 wt %, at least 99 wt %, or more) of the liquid removed from the feed stream during the removing step is performed using one or more humidifiers. A humidifier of may have any configuration that allows for the production of a gaseous stream comprising vapor (e.g., water vapor) transferred from a liquid stream (e.g., a stream comprising liquid water) via an evaporation process. In some embodiments, the humidifier is configured to produce such a gaseous stream comprising vapor (e.g., a “humidified gas stream”) by transferring the vapor (e.g., water vapor) from the liquid stream (e.g., a stream comprising liquid water) to a carrier gas via an evaporation process. In some embodiments, the humidifier comprises a liquid inlet configured to receive the liquid stream and/or a gas inlet configured to receive the carrier gas. The humidifier may further comprise a liquid outlet and/or a gas outlet. In certain embodiments, the carrier gas comprises a non-condensable gas. Non-limiting examples of suitable non-condensable gases include air, nitrogen, oxygen, helium, argon, carbon monoxide, carbon dioxide, sulfur oxides (SOₓ) (e.g., SO₂, SO₃), and/or nitrogen oxides (NOₓ) (e.g., NO, NO₂). Examples of potentially suitable humidifiers include, but are not limited to bubble column humidifiers and packed bed humidifiers, further details of which are provided below.

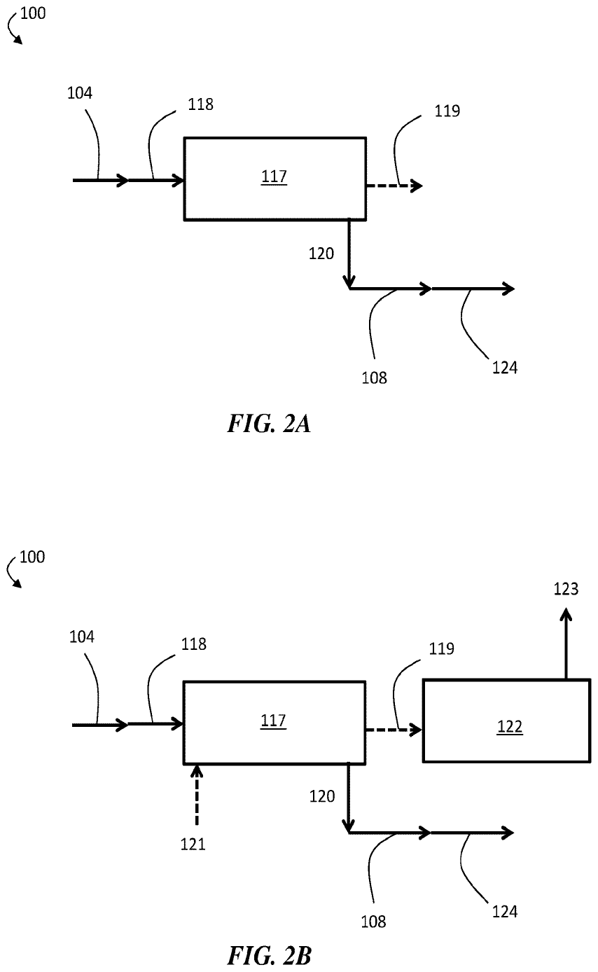

In some embodiments, the process of removing liquid from the feed stream comprises transporting a humidifier liquid inlet stream comprising at least a portion (e.g., at least 5 wt %, at least 10 wt %, at least 20 wt %, at least 50 wt %, at least 80 wt %, at least 90 wt %, at least 95 wt %, at least 99 wt %, or more) of the feed stream to a humidifier (e.g., via a humidifier liquid inlet). FIG. 2A shows a schematic diagram of an embodiment of lithium recovery system 100 comprising humidifier 117. In the embodiment shown in FIG. 2A, at least a portion of feed stream 104 forms some (e.g., at least 5 wt %, at least 10 wt %, at least 20 wt %, at least 50 wt %, at least 80 wt %, at least 90 wt %, at least 95 wt %, at least 99 wt %, or more) or all of humidifier liquid inlet stream 118.

In some embodiments, at least a portion (e.g., at least 5 wt %, at least 10 wt %, at least 20 wt %, at least 50 wt %, at least 80 wt %, at least 90 wt %, at least 95 wt %, at least 99 wt %, or more) of liquid of the humidifier liquid inlet stream is allowed to evaporate within the humidifier (e.g., within a vessel of the humidifier) to produce a humidified gas stream and a humidifier liquid outlet stream. Referring again to FIG. 2A, for example, at least a portion of liquid of humidifier liquid inlet stream 118 may be allowed to evaporate within humidifier 117 to produce humidified gas stream 119 (comprising at least a portion of vapor produced by the evaporation) and humidifier liquid outlet stream 120. In some instances, the humidified gas stream is produced by transporting a gas stream (e.g., comprising a carrier gas) to the humidifier (e.g., via a humidifier gas inlet) and transferring at least some of the vapor formed by the evaporation into the gas stream. For example, FIG. 2B shows gas stream 121 entering humidifier 117, where carrier gas of the gas stream 121 may be contacted with liquid of humidifier liquid inlet stream 118, thereby transferring liquid (e.g., in vapor form) to the gas stream to form humidified gas stream 119.

The humidifier liquid outlet stream may have a higher concentration of solubilized lithium cations compared to the humidifier liquid inlet stream. In some embodiments, the humidifier liquid outlet stream has a higher concentration of solubilized lithium cations than does the humidifier liquid inlet stream by a factor of at least 1.03, at least 1.05, at least 1.1, at least 1.2, at least 1.25, and/or up to 1.5, up to 2, up to 4, up to 5, or more. As mentioned above, increasing a concentration of solubilized lithium ions may facilitate downstream separation processes, such as processes involving removal of non-lithium cations (e.g., by selective thermal precipitation).

In some embodiments, the method of obtaining lithium (e.g., as a lithium salt) is performed such that at least a portion (e.g., at least 5 wt %, at least 10 wt %, at least 20 wt %, at least 50 wt %, at least 80 wt %, at least 90 wt %, at least 95 wt %, at least 99 wt %, or more) of the humidifier liquid outlet stream is part of the concentrated stream. For example, in FIGS. 2A-3B and 6A-6B, at least a portion of humidifier liquid outlet stream 120 is part of concentrated stream 108. While FIGS. 2A-3B and 6A-6B show humidifier liquid outlet stream 120 being directly fed to concentrated steam 108, other arrangements are possible. In some embodiments, the portion of the membrane separator retentate outlet stream that ultimately becomes part of the concentrated stream first goes through one or more intervening processes (e.g., by being transported through one or more further humidifiers and/or membrane separators).

In some embodiments, the humidifier is part of a humidification-dehumidification (HDH) apparatus that also comprises a dehumidifier. In some embodiments, the process of removing liquid from the feed stream further comprises condensing at least a portion (e.g., at least 5 wt %, at least 10 wt %, at least 20 wt %, at least 50 wt %, at least 80 wt %, at least 90 wt %, at least 95 wt %, at least 99 wt %, or more) of the liquid within the humidified gas within a dehumidifier to produce a condensed liquid stream. The dehumidifier may be configured to receive the humidified gas stream from the humidifier. In some embodiments in which the liquid comprises water, the dehumidifier may be configured to transfer at least a portion of the water (e.g., water vapor) from the humidified gas stream to a substantially pure water stream through a condensation process, thereby producing a substantially pure water stream. In FIGS. 2B-3B and 6A-6B, lithium recovery system 100 comprises dehumidifier 122, which is configured to receive (e.g., via one more fluidic conduits) at least a portion (e.g., at least 5 wt %, at least 10 wt %, at least 20 wt %, at least 50 wt %, at least 80 wt %, at least 90 wt %, at least 95 wt %, at least 99 wt %, or more) of humidified gas stream 119. Condensed liquid from humidified gas stream 119 produced in dehumidifier 122 may form some (e.g., at least 5 wt %, at least 10 wt %, at least 20 wt %, at least 50 wt %, at least 80 wt %, at least 90 wt %, at least 95 wt %, at least 99 wt %, or more) or all of condensed liquid stream 123 (e.g., substantially pure water). Any of a variety of dehumidifiers may be used. For example, the dehumidifier may comprise a bubble column dehumidifier, which is described in greater detail below. It has been realized that some such configurations involving coupling dehumidifiers to humidifiers during at least a portion of lithium recovery may allow for production of commercially valuable resources such as substantially pure water simultaneously (or sequentially) with obtaining lithium (e.g., lithium salts). Additionally, such configurations may allow for the recovery of at least a portion of the energy used to remove liquid from the feed stream. Such a process may help obtain greater commercial value from recovering lithium from certain feed stream sources (e.g., brines) compared to typical lithium recovery technologies.

In some embodiments, the process of removing liquid from the feed stream (e.g., comprising the liquid, solubilized lithium cations, and solubilized non-lithium cations) is performed using both a membrane separator and a humidifier. In some embodiments, the first membrane separator and the humidifier are arranged fluidically in series. For example, in some embodiments, the humidifier liquid inlet stream comprises at least a portion (e.g., at least 5 wt %, at least 10 wt %, at least 20 wt %, at least 50 wt %, at least 80 wt %, at least 90 wt %, at least 95 wt %, at least 99 wt %, or more) of the first membrane separator retentate outlet stream. As an illustrative example, FIG. 3A shows an embodiment of lithium recovery system 100 where at least a portion of membrane separator retentate outlet stream 106 (comprising at least a portion of feed stream 104 treated in first membrane separator 101) is transferred to humidifier 117 (e.g., via one or more conduits) by forming some (e.g., at least 5 wt %, at least 10 wt %, at least 20 wt %, at least 50 wt %, at least 80 wt %, at least 90 wt %, at least 95 wt %, at least 99 wt %, or more) or all of humidifier liquid inlet stream 118. It has been realized in the context of this disclosure that a process involving liquid removal by membrane-based (e.g., osmotic) separation followed by humidification can, in some instances, achieve ion concentration (e.g., lithium cation concentration) to a greater extent and/or with a greater efficiency than achievable with either technique alone. For example, a membrane-based separation process may be well-suited for concentrating initial feed streams source from, for example, brines. Such a membrane-based concentration of the feed stream may result in relatively high concentrations of solubilized ions that are better-suited for further concentration using a humidifier compared to additional membrane-based separation. For example, reverse osmosis can require greater and greater hydraulic pressures as ion concentrations increase, thereby requiring greater and greater energy expenditure and/or wear and tear on equipment. It has been realized that concentration via humidifiers may not necessarily experience the same adverse effects at higher ion concentrations. Additionally, streams with higher concentrations of solubilized species tend to have greater viscosity than streams having comparatively lower concentrations of solubilized species. It has been observed in the context of this disclosure that in some instances humidifiers are better suited for use with more viscous solutions than are membrane-based (e.g., osmotic) systems. Moreover, streams with higher concentrations of solubilized species tend to have reduced flux in membrane-based (e.g., osmotic) systems due in part to the higher viscosity and/or increased concentration polarization. Therefore, an initial concentration process with a membrane-based system and further concentration of the more concentrated output (having higher viscosity) with a humidifier can reduce or avoid such adverse effects compared to further concentration with a membrane-based system.

While the above disclosure describes a series configuration of the first membrane separator and the humidifier, other arrangements are possible. For example, in some embodiments, the first membrane separator and the humidifier are arranged in parallel, such that (a) the first membrane separator retentate inlet stream comprises a first portion of the feed stream, and (b) the humidifier liquid inlet stream comprises a second portion of the feed stream. In some embodiments, the concentrated stream is produced at least in part by combining at least a portion of the first membrane separator retentate outlet stream (and/or the second membrane separator retentate outlet stream described below) and at least a portion of the humidifier liquid outlet stream.

While in some embodiments the methods described herein employ a single membrane separator for removing the liquid from the feed stream (e.g., as shown in FIGS. 1A, 3A, and 13A-13B), in some embodiments multiple membrane separators are employed. For example, a second membrane separator may be used to further remove liquid from one or more streams. Use of a first membrane separator and a second membrane separator can promote, in some instances, effective removal of liquid from a feed stream by providing tunability of flow rates and hydraulic pressures for each membrane separator based on, for example, ion concentrations of streams fed to each unit. In some embodiments, the process of removing liquid from the feed stream further comprises transporting a second membrane separator retentate inlet stream comprising at least a portion of the first membrane separator retentate outlet stream to a retentate side of the second membrane separator. The second membrane separator may comprise at least one semi-permeable membrane defining a permeate side of the second membrane separator and a retentate side of the second membrane separator.

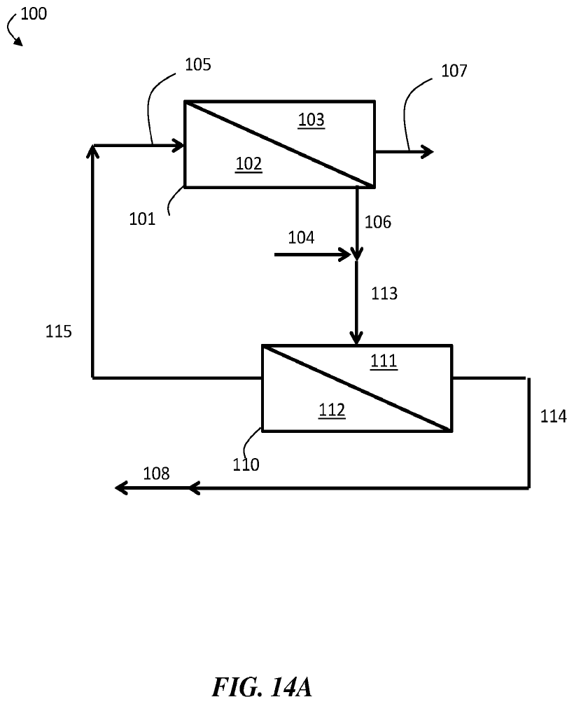

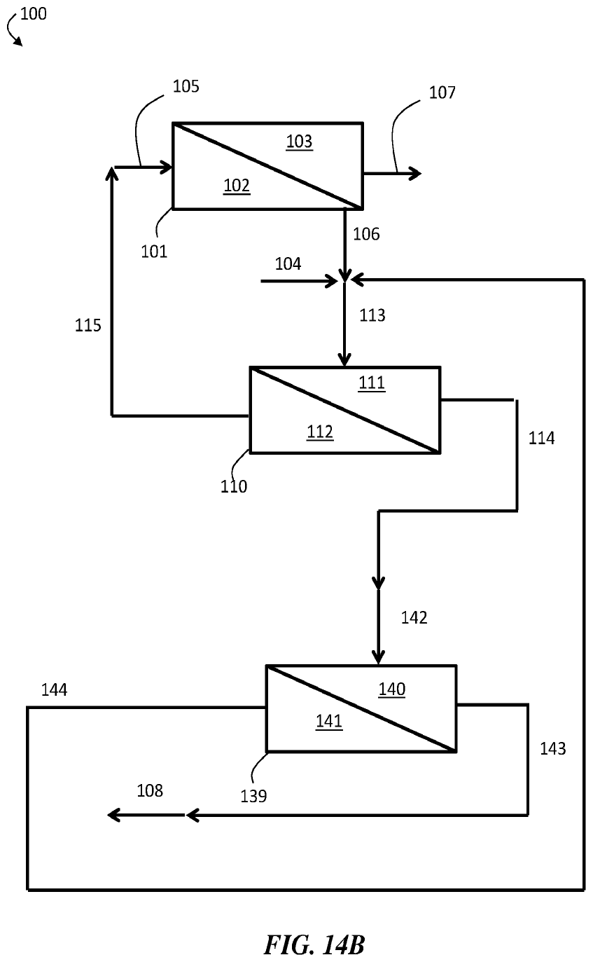

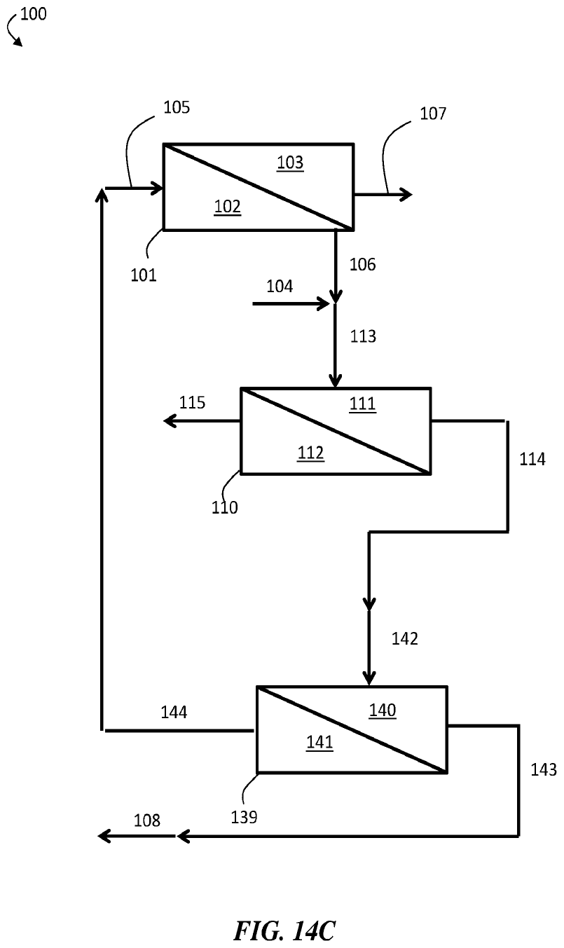

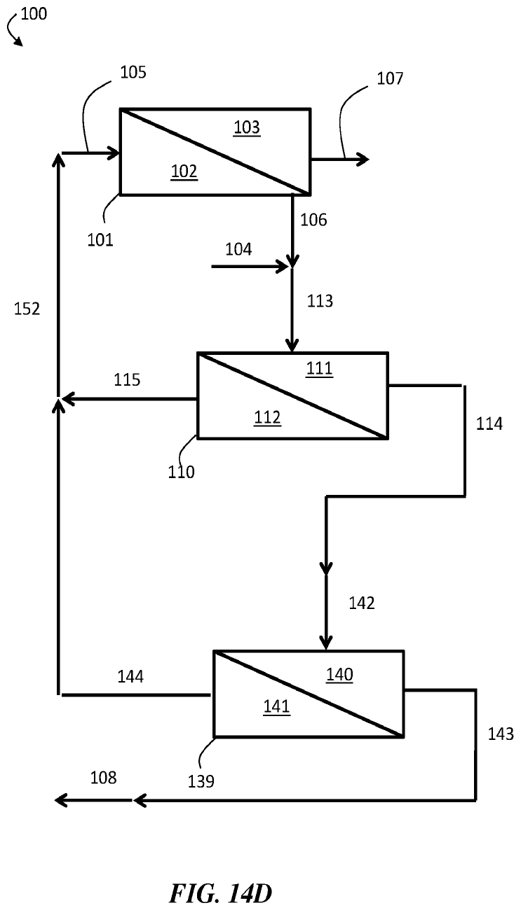

In some embodiments, the second membrane separator retentate inlet stream (which may comprise at least a portion (e.g., at least 5 wt %, at least 10 wt %, at least 20 wt %, at least 50 wt %, at least 80 wt %, at least 90 wt %, at least 95 wt %, at least 99 wt %, or more) of liquid from the first membrane separator retentate outlet stream (in some instances with one or more other streams) is transported to a retentate side of the second membrane separator such that a second membrane separator retentate outlet stream exits the retentate side of the second membrane separator, the second membrane separator retentate outlet stream having concentration of solubilized lithium cations that is greater than a concentration of solubilized lithium cations of the second membrane separator retentate inlet stream (e.g., by a factor of at least 1.03, at least 1.035, at least 1.05, at least 1.10, at least 1.25, and/or up to 1.40, up to 1.50, up to 2, up to 3, up to 4, up to 5, up to 6, or greater). In some embodiments, the second membrane separator retentate inlet stream comprises at least a portion (e.g., at least 5 wt %, at least 10 wt %, at least 20 wt %, at least 50 wt %, at least 80 wt %, at least 90 wt %, at least 95 wt %, at least 99 wt %, or more) of the feed stream, optionally with one or more other streams. Having the retentate side of the second membrane separator receive at least a portion of the feed stream may facilitate the treatment of feed streams having a higher osmotic pressure and/or higher concentration of solubilized lithium cations than in some instances in which the feed stream is fed to the retentate side of the first membrane separator. The second membrane separator inlet stream comprising at least a portion of the feed stream (and in some instances, at least a portion of the first membrane separator retentate outlet stream) may be transported to the retentate side of the second membrane separator such that the second membrane separator retentate outlet stream exits the retentate side of the second membrane separator, the second membrane separator retentate outlet stream having an osmotic pressure and/or concentration of solubilized lithium cations that is greater (e.g., by a factor of at least 1.03, at least 1.035, at least 1.05, at least 1.10, at least 1.25, and/or up to 1.40, up to 1.50, up to 2, up to 3, up to 4, up to 5, or greater) than an osmotic pressure and/or concentration of solubilized lithium cations of the second membrane separator retentate inlet stream. For example, referring to FIGS. 3B-3K, 6B, and 14A-15C, second membrane separator 110 may comprise at least one semi-permeable membrane defining retentate side 111 and permeate side 112, and second membrane separator retentate inlet stream 113 may be transported to retentate side 111 such that second membrane separator retentate outlet stream 114 exits retentate side 111. In some embodiments, such as those shown in FIGS. 3B-3K, 6B, and 14A-15C, second membrane separator retentate inlet stream 113 comprises at least a portion of first membrane separator retentate outlet stream 106. In some embodiments, such as those shown in FIGS. 14A-14D, second membrane separator retentate inlet stream 113 comprises at least a portion of feed stream 104. The step may be performed such that second membrane separator retentate outlet stream 114 has a concentration of solubilized lithium cations that is greater than a concentration of solubilized lithium cations in the second membrane separator retentate inlet stream 113. In some embodiments, a hydraulic pressure is applied (e.g., to facilitate transport of liquid and/or solute from the retentate side to the permeate side). In some embodiments, the system is operated such that the second membrane separator retentate inlet stream has a hydraulic pressure that is at least 50%, at least 75%, at least 90%, at least 95%, or more of the pressure of the first membrane separator retentate inlet stream. In some embodiments, the system is operated such that the second membrane separator retentate inlet stream has a hydraulic pressure of at least 200 psi (at least 1.38×10³ kPa), at least 500 psi (at least 3.45×10³ kPa), at least 750 psi (at least 5.17×10³ kPa), at least 1000 psi (at least 6.90×10³ kPa), and/or up to 1500 psi (up to 1.03×10⁴ kPa), up to 2000 psi (up to 1.38×10⁴ kPa), or more.

In some embodiments, at least a portion (e.g., at least 5 wt %, at least 10 wt %, at least 20 wt %, at least 50 wt %, at least 80 wt %, and/or up to 90 wt %, up to 95 wt %, up to 99 wt %, or more) of liquid from the second membrane separator retentate inlet stream is transported from the retentate side of the second membrane separator, through a semi-permeable membrane of the second membrane separator, to a permeate side of the second membrane separator. Referring again to FIGS. 3B-3K, 6B, and 14A-15C, for example, at least a portion of liquid from second membrane separator retentate inlet stream 113 may be transported from retentate side 111, through a semi-permeable membrane, to permeate side 112. Liquid transported from the retentate side to the permeate side of the second membrane separator may form some (e.g., at least 5 wt %, at least 10 wt %, at least 20 wt %, at least 50 wt %, at least 80 wt %, at least 90 wt %, at least 95 wt %, at least 99 wt %, or more) or all of a second membrane separator permeate outlet stream (e.g., second membrane separator permeate outlet stream 115 in FIGS. 3B-3K, 6B, and 14A-15C). The second membrane separator permeate outlet stream may be recirculated to an earlier stream in the system. For example, in some embodiments, the first membrane separator retentate inlet stream comprises at least a portion (e.g., at least 5 wt %, at least 10 wt %, at least 20 wt %, at least 50 wt %, at least 80 wt %, at least 90 wt %, at least 95 wt %, at least 99 wt %, or more) of the second membrane separator permeate outlet stream.

In some embodiments, at least a portion (e.g., at least 5 wt %, at least 10 wt %, at least 20 wt %, at least 50 wt %, at least 80 wt %, and/or up to 85%, up to 90%, or more) of the solubilized lithium cations from the second membrane separator retentate inlet stream are transported from the retentate side of the second membrane separator, through the semi-permeable membrane of the second membrane separator, to the permeate side of the second membrane separator. Referring again to FIGS. 3B-3K, 6B, and 14A-15C, for example, at least a portion of the solubilized lithium cations from second membrane separator retentate inlet stream 113 may be transported from retentate side 111, through a semi-permeable membrane, to permeate side 112.

In some embodiments, at least a portion (e.g., at least 5 wt %, at least 10 wt %, at least 20 wt %, at least 50 wt %, at least 80 wt %, and/or up to 85%, up to 90%, or more) of the solubilized non-lithium cations from the second membrane separator retentate inlet stream are transported from the retentate side of the second membrane separator, through the semi-permeable membrane of the second membrane separator, to the permeate side of the second membrane separator. Referring again to FIGS. 3B-3K, 6B, and 14A-15C, for example, at least a portion of any solubilized non-lithium cations in second membrane separator retentate inlet stream 113 may be transported from retentate side 111, through a semi-permeable membrane, to permeate side 112.

Solubilized lithium cations and/or non-lithium cations transported from the retentate side to the permeate side of the second membrane separator may form some (e.g., at least 5 wt %, at least 10 wt %, at least 20 wt %, at least 50 wt %, at least 80 wt %, at least 90 wt %, at least 95 wt %, at least 99 wt %, or more) or all of any solute present in the second membrane separator permeate outlet stream (e.g., second membrane separator permeate outlet stream 115 in FIGS. 3B-3K, 6B, and 14A-15C).

The amount of solute (e.g., lithium cations, non-lithium cations) that pass through the semi-permeable membrane of a membrane separator (e.g., the first membrane separator and/or the second membrane separator) may depend on any of a variety of parameters such as the solute concentration in the membrane separator retentate inlet stream, the solute permeability of the membrane, the water permeability of the membrane, the temperature, and/or a magnitude of hydraulic pressure of membrane separator retentate inlet stream. In some embodiments, at least a portion of liquid and solubilized lithium cations (and in some instances solubilized non-lithium cations) from the second membrane separator retentate inlet stream are transported from the retentate side of the second membrane separator, through the semi-permeable membrane of the second membrane separator, to the permeate side of the second membrane separator.

In some embodiments, the method of obtaining lithium (e.g., as a lithium salt) is performed such that at least a portion (e.g., at least 5 wt %, at least 10 wt %, at least 20 wt %, at least 50 wt %, at least 80 wt %, at least 90 wt %, at least 95 wt %, at least 99 wt %, or more) of the second membrane separator retentate outlet stream is part of the concentrated stream. For example, in FIG. 3B, at least a portion of second membrane separator retentate outlet stream 114 is part of concentrated stream 108 following treatment in humidifier 117. While FIG. 3B shows second membrane separator retentate outlet stream 114 being indirectly fed to concentrated steam 108, other arrangements are possible. For example, in some embodiments, the second membrane separator retentate outlet stream is fed directly to the concentrated stream.

In some embodiments in which one or more membrane separators and the humidifier are arranged in series, the second membrane separator is employed such that the humidifier liquid inlet stream comprises at least a portion (e.g., at least 5 wt %, at least 10 wt %, at least 20 wt %, at least 50 wt %, at least 80 wt %, at least 90 wt %, at least 95 wt %, at least 99 wt %, or more) of the second membrane separator retentate outlet stream. For example, FIG. 3B shows an embodiment of lithium recovery system 100 where at least a portion of second membrane separator retentate outlet stream 114 is transferred to humidifier 117 by forming some (e.g., at least 5 wt %, at least 10 wt %, at least 20 wt %, at least 50 wt %, at least 80 wt %, at least 90 wt %, at least 95 wt %, at least 99 wt %, or more) or all of humidifier liquid inlet stream 118.

It should be understood that while FIG. 3B shows an embodiment in which system 100 includes first membrane separator 101, second membrane separator 110, and humidifier 117, the presence of a humidifier in a system comprising a first membrane separator and a second membrane separator is not required. For example, FIG. 3C shows a schematic diagram of system 100 comprising first membrane separator 101 and second membrane separator 110 configured in the same manner as in the embodiment shown in FIG. 3B. In some embodiments, system 100 as shown in FIG. 3C can be used to form concentrated stream 108, which comprises at least a portion (e.g., at least 5 wt %, at least 10 wt %, at least 20 wt %, at least 50 wt %, at least 80 wt %, at least 90 wt %, at least 95 wt %, at least 99 wt %, or more) of second membrane separator retentate outlet stream 114 and has a higher concentration of solubilized lithium ions than feed stream 104. In some embodiments, at least a portion (e.g., at least 5 wt %, at least 10 wt %, at least 20 wt %, at least 50 wt %, at least 80 wt %, at least 90 wt %, at least 95 wt %, at least 99 wt %, or more) of concentrated stream 108 from FIG. 3C is subjected to further treatment (e.g., by removing at least some of any non-lithium cations present in concentrated stream as described elsewhere in this disclosure). In some embodiments, at least a portion (e.g., at least 5 wt %, at least 10 wt %, at least 20 wt %, at least 50 wt %, at least 80 wt %, at least 90 wt %, at least 95 wt %, at least 99 wt %, or more) of concentrated stream 108 is used directly for any of a variety of desired applications. Such desired applications include, but are not limited to, production of lithium metal, use as a desiccant, production of pyrotechnics, and production of medical agents (e.g., lithium-containing pharmaceutical agents).

Some embodiments comprise transporting a third membrane separator retentate inlet stream to a retentate side of a third membrane separator. The third membrane separator may comprise at least one semi-permeable membrane defining a permeate side of the third membrane separator and a retentate side of the third membrane separator.

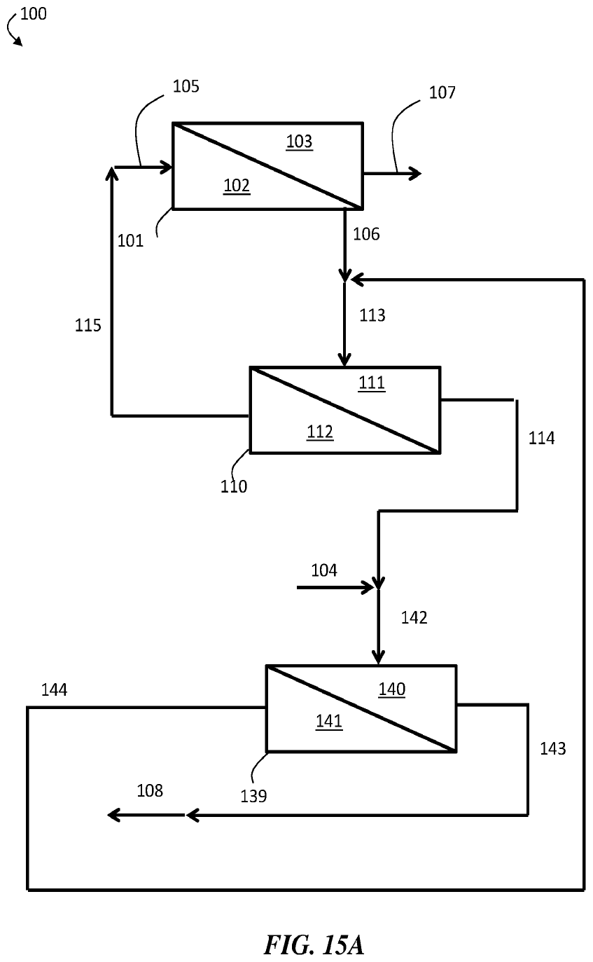

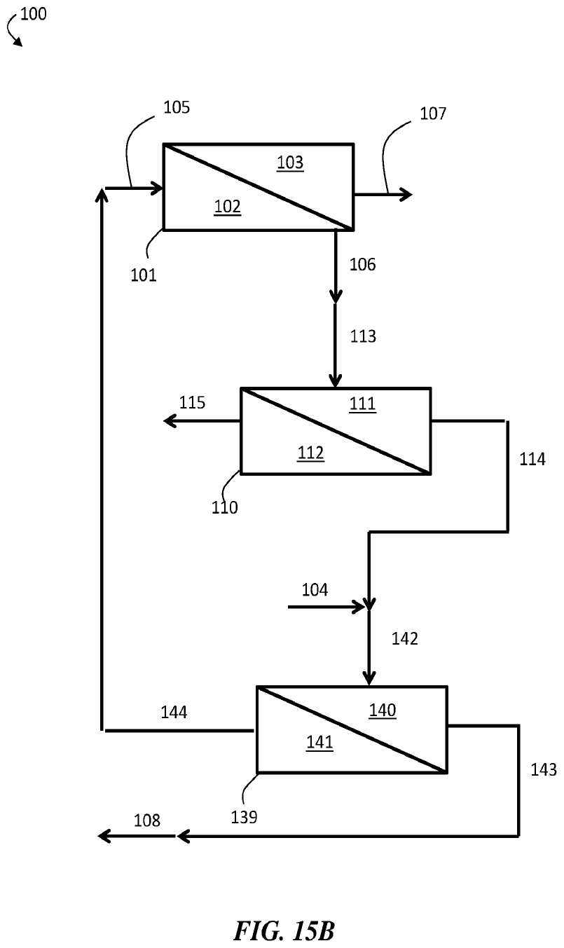

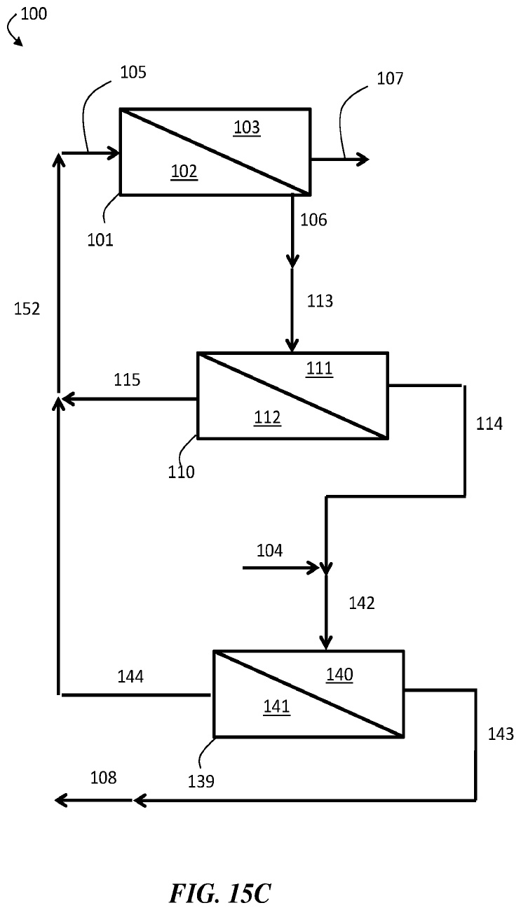

In some embodiments, the third membrane separator retentate inlet stream (which may comprise at least a portion (e.g., at least 5 wt %, at least 10 wt %, at least 20 wt %, at least 50 wt %, at least 80 wt %, at least 90 wt %, at least 95 wt %, at least 99 wt %, or more) of the second membrane separator retentate outlet stream, optionally with one or more other streams) is transported to a retentate side of the third membrane separator such that a third membrane separator retentate outlet stream exits the retentate side of the third membrane separator, the third membrane separator retentate outlet stream having a concentration of solubilized lithium cations that is greater (e.g., by a factor of at least 1.03, at least 1.035, at least 1.05, at least 1.10, at least 1.25, and/or up to 1.40, up to 1.50, up to 2, up to 3, up to 4, up to 5 or greater) than the concentration of solubilized lithium cations of the third membrane separator retentate inlet stream. In some embodiments, the third membrane separator retentate inlet stream comprises at least a portion (e.g., at least 5 wt %, at least 10 wt %, at least 20 wt %, at least 50 wt %, at least 80 wt %, at least 90 wt %, at least 95 wt %, at least 99 wt %, or more) of the feed stream, optionally with one or more other streams. Having the retentate side of the third membrane separator receive at least a portion of the feed stream may facilitate the treatment of feed streams having a higher osmotic pressure and/or concentration of solubilized lithium cations than in some instances in which the feed stream is fed to the retentate side of the first membrane separator. The third membrane separator inlet stream comprising at least a portion of the feed stream (and in some instances, at least a portion of the second membrane separator retentate outlet stream) may be transported to the retentate side of the third membrane separator such that the third membrane separator retentate outlet stream exits the retentate side of the third membrane separator, the third membrane separator retentate outlet stream having an osmotic pressure and/or concentration of solubilized lithium cations that is greater (e.g., by a factor of at least 1.03, at least 1.035, at least 1.05, at least 1.10, at least 1.25, and/or up to 1.40, up to 1.50, up to 2, up to 3, up to 4, up to 5 or greater) than an osmotic pressure and/or concentration of solubilized lithium cations of the third membrane separator retentate inlet stream. For example, in the embodiments shown in FIGS. 3D-3G, 3K and 14A-15C, third membrane separator 139 may comprise at least one semi-permeable membrane defining retentate side 140 and permeate side 141, and third membrane separator retentate inlet stream 142 may be transported to retentate side 140 such that third membrane separator retentate outlet stream 143 exits retentate side 140. In some embodiments, such as those shown in FIGS. 3D-3G, 3K, and 14A-15C, third membrane separator retentate inlet stream 142 comprises at least a portion of second membrane separator retentate outlet stream 114. In some embodiments, such as those shown in FIGS. 15A-15C, third membrane separator retentate inlet stream 142 comprises at least a portion of feed stream 104. This step may be performed such that third membrane separator retentate outlet stream 143 has a concentration of solubilized lithium cations that is greater than the concentration of solubilized lithium cations in third membrane separator retentate inlet stream 142, according to some embodiments. For example, this step may be performed such that third membrane separator retentate outlet stream 143 has a concentration of the solubilized lithium cations that is increased with respect to the concentration of solubilized lithium cations in third membrane separator retentate inlet stream 142 (e.g., by a factor of at least 1.03, at least 1.035, at least 1.05, at least 1.10, at least 1.25, and/or up to 1.40, up to 1.50, up to 2, up to 3, up to 4, up to 5 or greater). In some embodiments, a hydraulic pressure is applied (e.g., to facilitate transport of liquid and/or solute from the retentate side to the permeate side). In some embodiments, the system is operated such that the third membrane separator retentate inlet stream has a hydraulic pressure that is at least 50%, at least 75%, at least 90%, at least 95%, or more of the pressure of the second membrane separator retentate inlet stream. In some embodiments, the system is operated such that the third membrane separator retentate inlet stream has a hydraulic pressure of at least 200 psi (at least 1.38×10³ kPa), at least 500 psi (at least 3.45×10³ kPa), at least 750 psi (at least 5.17×10³ kPa), at least 1000 psi (at least 6.90×10³ kPa), and/or up to 1500 psi (up to 1.03×10⁴ kPa), up to 2000 psi (up to 1.38×10⁴ kPa), or more.

In some embodiments, at least a portion (e.g., at least 5 wt %, at least 10 wt %, at least 20 wt %, at least 50 wt %, at least 80 wt %, and/or up to 90 wt %, up to 95 wt %, up to 99 wt %, or more) of liquid from the third membrane separator retentate inlet stream is transported from the retentate side of the third membrane separator, through a semi-permeable membrane of the third membrane separator, to a permeate side of the third membrane separator. Referring again to FIGS. 3D-3G, 3K, and 14A-15C, for example, at least a portion of liquid from third membrane separator retentate inlet stream 142 may be transported from retentate side 140, through a semi-permeable membrane, to permeate side 141. Liquid transported from the retentate side to the permeate side of the third membrane separator may form some (e.g., at least 5 wt %, at least 10 wt %, at least 20 wt %, at least 50 wt %, at least 80 wt %, at least 90 wt %, at least 95 wt %, at least 99 wt %, or more) or all of the liquid of a third membrane separator permeate outlet stream (e.g., third membrane separator permeate outlet stream 144 in FIGS. 3D-3G, 3K, and 14A-15C).

In some embodiments, at least a portion (e.g., at least 5 wt %, at least 10 wt %, at least 20 wt %, at least 50 wt %, at least 80 wt %, and/or up to 85%, up to 90%, or more) of the solubilized lithium cations from the third membrane separator retentate inlet stream are transported from the retentate side of the third membrane separator, through the semi-permeable membrane of the third membrane separator, to the permeate side of the third membrane separator. Referring again to FIGS. 3D-3G, 3K, and 14A-15C, for example, at least a portion of the solubilized lithium cations from third membrane separator retentate inlet stream 142 may be transported from retentate side 140, through a semi-permeable membrane, to permeate side 141.

In some embodiments, at least a portion (e.g., at least 5 wt %, at least 10 wt %, at least 20 wt %, at least 50 wt %, at least 80 wt %, and/or up to 85%, up to 90%, or more) of the solubilized non-lithium cations from the third membrane separator retentate inlet stream are transported from the retentate side of the third membrane separator, through the semi-permeable membrane of the third membrane separator, to the permeate side of the third membrane separator. Referring again to FIGS. 3D-3G, 3K, and 14A-15C, for example, at least a portion of any solubilized non-lithium cations in third membrane separator retentate inlet stream 142 may be transported from retentate side 140, through a semi-permeable membrane, to permeate side 141. Solubilized lithium cations and/or non-lithium cations transported from the retentate side to the permeate side of the third membrane separator may form some (e.g., at least 5 wt %, at least 10 wt %, at least 20 wt %, at least 50 wt %, at least 80 wt %, at least 90 wt %, at least 95 wt %, at least 99 wt %, or more) or all of any solute present in the third membrane separator permeate outlet stream (e.g., third membrane separator permeate outlet stream 144 in FIGS. 3D-3G, 3K, and 14A-15C).

The amount of solute that passes through the semi-permeable membrane of the third membrane separator may depend on any of a variety of parameters such as the solute concentration in the third membrane separator retentate inlet stream, the solute permeability of the membrane, the water permeability of the membrane, the temperature, and/or a magnitude of hydraulic pressure of the third membrane separator retentate inlet stream. In some embodiments, at least a portion of liquid and solute from the third membrane separator retentate inlet stream is transported from the retentate side of the third membrane separator, through the semi-permeable membrane of the third membrane separator, to the permeate side of the third membrane separator.

In some embodiments, the method of obtaining lithium (e.g., as a lithium salt) is performed such that at least a portion (e.g., at least 5 wt %, at least 10 wt %, at least 20 wt %, at least 50 wt %, at least 80 wt %, at least 90 wt %, at least 95 wt %, at least 99 wt %, or more) of the third membrane separator retentate outlet stream is part of the concentrated stream. For example, at least a portion of the third membrane separator retentate outlet stream may be part of concentrated stream 108 following treatment in the humidifier. However, in some embodiments, the second membrane separator retentate outlet stream is fed directly to the concentrated stream.

In some embodiments in which one or more membrane separators and the humidifier are arranged in series, the third membrane separator is employed such that the humidifier liquid inlet stream comprises at least a portion (e.g., at least 5 wt %, at least 10 wt %, at least 20 wt %, at least 50 wt %, at least 80 wt %, at least 90 wt %, at least 95 wt %, at least 99 wt %, or more) of the third membrane separator retentate outlet stream.

While FIGS. 1A-1B, 3A-3K, 6A-6B, and 14A-15C show one, two, or three membrane separators, it should be understood that a different number of membrane separators can be employed in the system and used in the methods of this disclosure. For example, a system comprising a plurality of membrane separators may have at least one, at least two, at least three, at least four, at least five, at least ten, and least twenty, or more membrane separators configured as described in this disclosure.

In some embodiments, at least a portion of a stream exiting one or more membrane separator is recirculated and fed back into a membrane separator (e.g., an upstream membrane separator). Such recycle processes may allow for relatively high amounts of liquid to be removed by the system (in some instances using fewer system components) and/or for relatively high recovery rates and/or efficiencies compared to some embodiments in which no such recycle occurs.

As one example of a recycle process, in some embodiments the first membrane separator retentate inlet stream comprises at least a portion (e.g., at least 5 wt %, at least 10 wt %, at least 20 wt %, at least 50 wt %, at least 80 wt %, at least 90 wt %, at least 95 wt %, at least 99 wt %) or all of the second membrane separator permeate outlet stream. The first membrane separator retentate inlet stream may comprise at least a portion of the second membrane separator permeate outlet stream during at least a period of time (e.g., an entirety or a subset of time) during operation of the first membrane separator and second membrane separator as part of the methods described in this disclosure. As an illustrative example, the embodiments shown in FIGS. 3E, 3G, 14B, 14D, 15A, and 15C show at least a portion of second membrane separator permeate outlet stream 115 being transported back to first membrane separator retentate inlet stream 105. Second membrane separator permeate outlet stream 115 may be combined with feed stream 104 to form at least part of first membrane separator retentate inlet stream 105.

As another example of a recycle process, in some embodiments in which a third membrane separator is employed, the second membrane separator retentate inlet stream comprises at least a portion (e.g., at least 5 wt %, at least 10 wt %, at least 20 wt %, at least 50 wt %, at least 80 wt %, at least 90 wt %, at least 95 wt %, at least 99 wt %) or all of the third membrane separator permeate outlet stream. The second membrane separator retentate inlet stream may comprise at least a portion of the third membrane separator permeate outlet stream during at least a period of time (e.g., an entirety or a subset of time) during operation of the first membrane separator, the second membrane separator, and/or the third membrane separator as part of the methods described in this disclosure. As an illustrative example, the embodiment shown in FIG. 3E shows at least a portion of third membrane separator permeate outlet stream 144 being transported back to second membrane separator retentate inlet stream 113. FIGS. 14B and 15A similarly show at least a portion of third membrane separator permeate outlet stream 144 being transported back to second membrane separator retentate inlet stream 113. Third membrane separator permeate outlet stream 144 may be combined with first membrane separator retentate outlet stream 106 to form at least part of second membrane separator retentate inlet stream 113.

Other recycle processes may also be employed. For example, in some embodiments, the first membrane separator retentate inlet stream comprises at least a portion (e.g., at least 5 wt %, at least 10 wt %, at least 20 wt %, at least 50 wt %, at least 80 wt %, at least 90 wt %, at least 95 wt %, at least 99 wt %) or all of the third membrane separator permeate outlet stream. Such a process may occur in embodiments in which the retentate side of the first membrane separator is fluidically connected to the permeate side of the third membrane separator. As an illustrative example, the embodiments shown in FIGS. 3F-3G, 14C-14D, and 15B-15C show at least a portion of third membrane separator permeate outlet stream 144 being transported back to first membrane separator retentate inlet stream 105. Third membrane separator permeate outlet stream 144 may be combined with feed stream 104 to form at least part of first membrane separator retentate inlet stream 105.

In some embodiments, the first membrane separator retentate inlet stream comprises at least a portion (e.g., at least 5 wt %, at least 10 wt %, at least 20 wt %, at least 50 wt %, at least 80 wt %, at least 90 wt %, at least 95 wt %, at least 99 wt %) or all of the second membrane separator permeate outlet stream and also at least a portion (e.g., at least 5 wt %, at least 10 wt %, at least 20 wt %, at least 50 wt %, at least 80 wt %, at least 90 wt %, at least 95 wt %, at least 99 wt %) or all of the third membrane separator permeate outlet stream. Such a process may occur in embodiments in which the retentate side of the first membrane separator is fluidically connected to the permeate side of the second membrane separator and the permeate side of the third membrane separator. As an illustrative example, the embodiment shown in FIG. 3G shows at least a portion of second membrane separator permeate outlet stream 115 and at least a portion of third membrane separator permeate outlet stream 144 being transported back to first membrane separator retentate inlet stream 105. At least a portion of second membrane separator permeate outlet stream 115 and at least a portion of third membrane separator permeate outlet stream 144 may be transported back to first membrane separator retentate inlet stream 105 by being combined to form stream 152. FIGS. 14D and 15C similarly show at least a portion of second membrane separator permeate outlet stream 115 and at least a portion of third membrane separator permeate outlet stream 144 being transported back to first membrane separator retentate inlet stream 105 by being combined to form stream 152. Second membrane separator permeate outlet stream 115 and third membrane separator permeate outlet stream 144 may be combined with feed stream 104 to form at least part of first membrane separator retentate inlet stream 105.

In some embodiments, the first membrane separator retentate inlet stream comprises at least a portion (e.g., at least 5 wt %, at least 10 wt %, at least 20 wt %, at least 50 wt %, at least 80 wt %, at least 90 wt %, at least 95 wt %, at least 99 wt %) of the feed stream (e.g., feed stream 101) and at least a portion (e.g., at least 5 wt %, at least 10 wt %, at least 20 wt %, at least 50 wt %, at least 80 wt %, at least 90 wt %, at least 95 wt %, at least 99 wt %) of an upstream membrane separator retentate outlet stream. The term “upstream” in “upstream membrane separator” is used for convenience and refers to the direction of flow of liquid relative to the retentate side of the first membrane separator. The upstream membrane separator may have a retentate side and a permeate side defined by at least one semi-permeable membrane. In some such embodiments, the retentate side of the upstream separator receives an upstream membrane separator retentate inlet stream (e.g., by having the retentate side of the upstream membrane separator be fluidically connected to one or more other components of the system, such as the retentate side and/or permeate side of a different membrane separator).

Referring to FIGS. 3H-3K, system 100 may further comprise upstream membrane separator 146. Upstream membrane separator 146 may comprise at least one semi-permeable membrane defining retentate side 147 and permeate side 148, and upstream membrane separator retentate inlet stream 149 may be transported to retentate side 147 such that upstream membrane separator retentate outlet stream 150 exits retentate side 147. This step may be performed such that upstream membrane separator retentate outlet stream 150 has an osmotic pressure and/or concentration of solubilized lithium cations that is greater than an osmotic pressure and/or concentration of solubilized lithium cations of upstream membrane separator retentate inlet stream 149, according to some embodiments. At least a portion of upstream membrane separator retentate outlet stream 150 may be combined with at least a portion of feed stream 104 to form some or all of first membrane separator retentate inlet stream 105, which is transported to retentate side 102 of first membrane separator 101. Liquid transported from the retentate side to the permeate side of the upstream membrane separator may form some or all of an upstream membrane separator permeate outlet stream (e.g., upstream membrane separator permeate outlet stream 151 in FIGS. 3H-3K), which may be discharged from the system (e.g., as relatively pure liquid such as relatively pure water).

The upstream separator retentate inlet stream may comprise at least a portion of one or more streams mentioned elsewhere in this disclosure. For example, in some embodiments, the upstream membrane separator retentate inlet stream comprises at least a portion of the first membrane separator permeate outlet stream (e.g., as shown in FIG. 3I), at least a portion of the second membrane separator permeate outlet stream (e.g., as shown in FIG. 3J), and/or at least a portion of the third membrane separator permeate outlet stream (e.g., as shown in FIG. 3K). These configurations may be obtained by, for example, having the retentate side of the upstream membrane separator be fluidically connected to the permeate side of the first membrane separator, the permeate side of the second membrane separator, and/or the permeate side of the third membrane separator.

In some embodiments, the upstream membrane separator and/or at least one semi-permeable membrane of the upstream membrane separator differs from first membrane separator and/or at least one semi-permeable membrane of the first membrane separator in one or more of the parameters discussed elsewhere in this disclosure. For example, the upstream membrane separator may have a different (e.g., lower) salt passage percentage at standard conditions, a different (e.g., lower) solute permeability, a different (e.g., higher) rejection for a solute, and/or a different total membrane surface area as compared to the first membrane separator. In some embodiments, the at least one semi-permeable membrane of the upstream membrane separator has a different (e.g., lower) average molecular weight cutoff (MWCO) as compared to the at least one semi-permeable membrane of the first membrane separator.

In some embodiments, the first membrane separator retentate inlet stream does not comprise any portion of an upstream membrane separator retentate outlet stream, or less than 10 wt %, less than 5 wt %, less than 2 wt %, less than 1 wt %, less than 0.1 wt %, or less of the first membrane separator inlet stream is produced by an upstream membrane separator retentate outlet stream.

As mentioned above, some methods for obtaining lithium (e.g., as a lithium salt) comprise removing at least some (e.g., at least 5 wt %, at least 10 wt %, at least 20 wt %, at least 50 wt %, at least 80 wt %, at least 90 wt %, at least 95 wt %, at least 99 wt %, or more) of the solubilized non-lithium cations (e.g., sodium cations, potassium cations, magnesium cations, calcium cations) from the concentrated stream to form an impurity-depleted concentrated stream. Such a process can be advantageous in a lithium recovery process because it can result in a stream having a relatively high concentration of lithium cations compared to a concentration of non-lithium cations, which may be considered impurities in applications in which a substantially pure form of lithium (e.g., a lithium salt) is desired. In the context of this disclosure, any material that is not and does not contain lithium is considered an impurity. For example, lithium cations and lithium salts are not considered impurities, but all other non-solvent components are considered impurities. Referring to FIGS. 1A-3K, 6A-6B, and 13A-15C, some methods may comprise removing at least some of the solubilized non-lithium cations in concentrated stream 108 (e.g., via one or more ion removal processes not pictured), thereby forming impurity-depleted concentrated stream 124.

In some embodiments, the impurity-depleted concentrated stream has a lower concentration of the solubilized non-lithium cation compared to the concentrated stream. For example, in some embodiments, a ratio of a concentration of a non-lithium cation (e.g., sodium cation, potassium cation, magnesium cation, or calcium cation) in the concentrated stream to the concentration of that non-lithium cation in the impurity-depleted concentrated stream is greater than or equal to 1.1, greater than or equal to 1.2, greater than or equal to 1.5, greater than or equal to 2, greater than or equal to 5, greater than or equal to 10, greater than or equal to 20, greater than or equal to 50, greater than or equal to 100, and/or up to 200, up to 500, up to 1,000, or greater. In some embodiments, a ratio of a total concentration of all non-lithium cations (e.g., a sum of the concentration of sodium cations, potassium cations, magnesium cations, calcium cations) in the concentrated stream to the total concentration of all non-lithium cations in the impurity-depleted concentrated stream is greater than or equal to 1.1, greater than or equal to 1.2, greater than or equal to 1.5, greater than or equal to 2, greater than or equal to 5, greater than or equal to 10, greater than or equal to 20, greater than or equal to 50, greater than or equal to 100, and/or up to 200, up to 500, up to 1,000, or greater.

In some embodiments in which at least some of the solubilized non-lithium cations are removed from the concentrated stream to form the impurity-depleted concentrated stream, both the absolute concentration of the non-lithium cations and the absolute concentration of the lithium cations are increased with respect to the concentrated stream, but the absolute concentration of the lithium ions increases to a greater extent than the absolute concentration of the non-lithium ions. As such, use of the term “impurity-depleted concentrated stream” does not necessarily mean that an absolute concentration of non-lithium cations in the liquid is lowered. Such an increase in concentration of non-lithium cations despite removal of at least some of the non-lithium cations can occur, for example, via concentration-induced precipitation. For example, the non-lithium cations may be solubilized in the concentrated stream at a concentration below a saturation point for those non-lithium cations. During the removal process, such a concentrated stream may be subjected to a liquid removal process and/or heating process (e.g., via boiling) such that the non-lithium cations are concentrated to the point of saturation. At saturation, precipitates of salts comprising at least some of the non-lithium cations may be formed and separated from the stream, thereby removing at least some of the non-lithium cations from the stream while the concentration of the non-lithium cations remains at the saturation point. Meanwhile, the lithium cations may also be solubilized in the concentrated stream at a concentration below a saturation point for the lithium cations. During the same removal process where the concentrated stream is subjected to a liquid removal process to form the impurity-depleted concentrated stream, the lithium cations are also concentrated, but to a greater extent than the non-lithium cations because the lithium cations have a higher saturation point than the non-lithium cations under the operative conditions. Therefore, the lithium cations may continue to be concentrated while the concentration of the non-lithium cations reaches and remains at their saturation point as at least some of the non-lithium cations are removed via precipitation.

In some embodiments, the process of the process of removing at least some of the solubilized non-lithium cations from the concentrated stream forms an impurity-depleted concentrated stream having an atomic ratio of lithium cations to non-lithium cations that is larger than an atomic ratio of lithium cations to non-lithium cations in the concentrated stream. In some embodiments, during the process of removing at least some of the solubilized non-lithium cations from the concentrated stream, a greater amount of the solubilized non-lithium cations is removed compared to any amount of solubilized lithium cation that is removed (which may none or a non-zero amount). Such a selective removal of non-lithium cations with respect to lithium cations may result in a lithium-enriched stream useful for obtaining relatively pure lithium-containing products (e.g., lithium salts). In some embodiments, little to no amount of solubilized lithium cations are removed during such a process, while in some embodiments a concentration of solubilized lithium cations is increased (e.g., due to a reduction in liquid volume). In some embodiments, a ratio of a concentration of solubilized lithium cations in the concentrated stream to the concentration of solubilized lithium cations in the impurity-depleted concentrated stream is less than or equal to 1.05, less than or equal to 1.02, less than or equal to 1, less than or equal to 0.9, less than or equal to 0.8, less than or equal to 0.5, less than or equal to 0.2, less than or equal to 0.1, and/or as low as 0.01, or less. In some embodiments, a ratio of a total concentration of all solubilized non-lithium cation (e.g., sodium cation, potassium cation, magnesium cation, or calcium cation) in the concentrated stream to the total concentration of all solubilized non-lithium cations in the impurity-depleted concentrated stream is greater than or equal to 1.1, greater than or equal to 1.2, greater than or equal to 1.5, greater than or equal to 2, greater than or equal to 5, greater than or equal to 10, greater than or equal to 20, greater than or equal to 50, greater than or equal to 100, and/or up to 200, up to 500, up to 1,000, or greater, while a ratio of a concentration of solubilized lithium cations in the concentrated stream to the concentration of solubilized lithium cations in the impurity-depleted concentrated stream is less than or equal to 1.05, less than or equal to 1.02, less than or equal to 1, less than or equal to 0.9, less than or equal to 0.8, less than or equal to 0.5, less than or equal to 0.2, less than or equal to 0.1, and/or as low as 0.01, or less. In some embodiments, the process of removing at least some of the solubilized non-lithium cations from the concentrated stream results in a ratio of a concentration of solubilized lithium cations to a total concentration of all solubilized non-lithium cations in the impurity-depleted concentrated stream that is greater than that in the concentrated stream by a factor of at least 1.1, at least 1.2, at least 1.5, at least 2, at least 5, at least 10, at least 20, at least 50, at least 100, at least 200, at least 500, and/or up to 1,000, up to 10,000, or greater. As would be readily understood, these ranges may also be expressed in terms of atomic ratios rather than ratios of concentrations. For example, in addition to or instead of satisfying the above ratios of concentrations on a mass basis, in some embodiments the process of removing at least some of the solubilized non-lithium cations from the concentrated stream results in an atomic ratio of solubilized lithium cations to total solubilized non-lithium cations in the impurity-depleted concentrated stream that is greater than that in the concentrated stream by a factor of at least 1.1, at least 1.2, at least 1.5, at least 2, at least 5, at least 10, at least 20, at least 50, at least 100, at least 200, at least 500, and/or up to 1,000, up to 10,000, or greater.

Any of a variety of suitable techniques may be used to remove the solubilized non-lithium cations from the concentrated stream to a greater extent than the solubilized lithium cations. In some embodiments, at least a portion (e.g., at least 5 wt %, at least 10 wt %, at least 20 wt %, at least 50 wt %, at least 80 wt %, at least 90 wt %, at least 95 wt %, at least 99 wt %, or more) of non-lithium cations removed from the concentrated stream during production of the impurity-depleted concentrated stream are removed as solid non-lithium-containing salts comprising at least a portion of the non-lithium cations. Other techniques for the removal of non-lithium cations that can be used include, but are not limited to, extraction (e.g., liquid-liquid extraction, solvent extraction, extraction with compounds and/or solvents with preferential affinity for non-lithium cations) and membrane-based techniques (e.g., dialysis, electrodialysis, nanofiltration). Removing non-lithium cations as solid non-lithium-containing salts may be advantageous in some instances where ease of separation of non-lithium and lithium-containing materials is desired, and in some instances where concentrations of non-lithium ions are relatively high (such as following the liquid removal steps described above, in some embodiments). Removing solid non-lithium-containing salts may be convenient in some instances, as doing so may simply require collection of a mother liquor/supernatant following solid non-lithium-containing salt removal.

Any of a variety of non-lithium-containing salts may be formed from one or more solutions (e.g., streams) described in this disclosure, depending on the composition of the solution. In some embodiments, the non-lithium-containing salt comprises a cation chosen from one or more of sodium and potassium and an anion chosen from one or more of chloride, sulfate, carbonate, bicarbonate, nitrate, borate, phosphate, bromide, citrate, oxide, and hydride. For example, in some embodiments where the concentrated stream comprises solubilized sodium and potassium cations and solubilized chloride anions, an amount of solid sodium chloride and/or potassium chloride may be removed from the concentrated stream during production of the impurity-depleted concentrated stream.

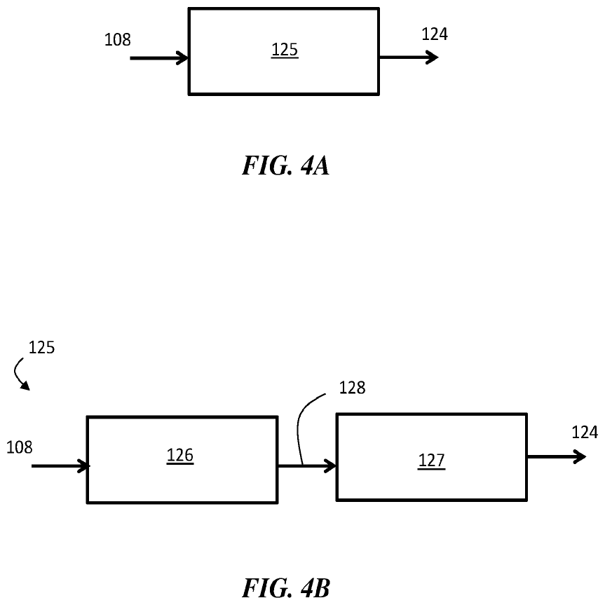

In some embodiments, at least a portion (e.g., at least 5 wt %, at least 10 wt %, at least 20 wt %, at least 50 wt %, at least 80 wt %, at least 90 wt %, at least 95 wt %, at least 99 wt %, or more) of the solid non-lithium-containing salt is formed via precipitation from the concentrated stream (or a stream comprising at least a portion of the concentrated stream). In some embodiments, the solid non-lithium-containing salt is formed via crystallization from the concentrated stream (or a stream comprising at least a portion of the concentrated stream). Precipitation and/or crystallization of the non-lithium-containing salt may occur in a non-lithium-containing salt production unit. In the embodiment shown in FIG. 4A, for example, at least a portion of concentrated stream 108 may be fed to non-lithium-containing salt production unit 125, where an amount of non-lithium-containing salt comprising at least a portion of the non-lithium cations is formed, thereby forming impurity-depleted concentrated stream 124. A non-lithium-containing salt production unit may comprise one or more vessels for receiving at least a portion of a liquid stream (e.g., via a liquid inlet). In some embodiments, a non-lithium-containing salt production unit comprises a heater in thermal communication with the vessel (e.g., for elevating a temperature of a liquid within a vessel). In some embodiments, a non-lithium-containing salt production unit comprises a cooling apparatus in thermal communication with the vessel (e.g., for lowering a temperature of a liquid within the vessel). In some embodiments, the non-lithium-containing salt production unit comprises a precipitation unit configured to induce precipitation and/or crystallization. Examples of apparatuses suitable for non-lithium-containing salt production (e.g., via precipitation) include, but are not limited to, forced circulation evaporators, solvent extraction apparatuses, froth flotation devices, electrodialysis devices, and low-temperature eutectic freeze crystallization apparatuses. In some embodiments, the non-lithium-containing salt production unit comprises a cooling unit (e.g., a chiller) fluidically connected to the precipitation apparatus. For example, in FIG. 4A, non-lithium-containing salt production unit 125 comprises precipitation unit 126 fluidically connected to cooling unit 127.

One process for inducing precipitation of a non-lithium-containing salt is to remove non-lithium-containing salts from solutions comprising lithium and non-lithium cations via chemical treatment. Such chemical treatment may result in selective precipitation of non-lithium-containing salts relative to lithium salts due to different solubilities of lithium and non-lithium-containing salts under certain conditions. One such example is addition of aluminum sulfates to solutions comprising solubilized lithium cations and non-lithium cations such as alkalis or alkaline earth metals. Addition of aluminum sulfate can result in precipitation of non-lithium-containing sulfate salts (e.g., alunite and/or alum) to a greater extent than any lithium-containing sulfates.

A different approach to selective precipitation of non-lithium-containing salts is to vary the temperature of the liquid comprising the solubilized lithium and non-lithium cations. Such a process may be performed without chemically treating the concentrated stream. The solubility of lithium salts and non-lithium-containing salts are generally temperature-dependent. However, the solubility of at least some lithium salts may be greater and vary with temperature to a greater extent than do at least some non-lithium-containing salts. For example, in going from 20° C. to 140° C., the solubility of lithium chloride (LiCl) in water increases from approximately 80 g/100 g of water to approximately 140 g/100 g of water—an increase in solubility of ˜75%. However, in going from 20° C. to 140° C., the solubility of potassium chloride (KCl) in water only increases from approximately 39 g/100 g water to approximately 65 g/100 g water—an increase of only 67% from a lower absolute value than that of lithium chloride. Even more starkly, the solubility of sodium chloride (NaCl) in water only increases from approximately 39 g/100 g water to approximately 42 g/100 g water—an increase of only about 8% from a lower absolute value than that of lithium chloride. Therefore, elevating the temperature of aqueous solutions comprising lithium cations, potassium cations, sodium cations, and chloride anions to sufficiently high temperatures (e.g., by boiling and/or evaporating at least some of the aqueous solution) can cause precipitation of potassium chloride and sodium chloride to a greater extent compared to any precipitation of lithium chloride. As a result, the remaining aqueous solution may be enriched in lithium cations compared to any remaining potassium cations or sodium cations.

Accordingly, in some embodiments, removing at least some of the solubilized non-lithium cations from the concentrated stream (e.g., comprising a liquid such as water, solubilized lithium cations, and solubilized non-lithium cations) comprises elevating a temperature of the concentrated stream to form a heated concentrated stream such that an amount of a solid non-lithium-containing salt comprising at least a portion of the non-lithium cations is formed. In some such embodiments, the heated stream has a temperature of greater than or equal to 100° C., greater than or equal to 110° C., greater than or equal to 120° C., greater than or equal to 140° C., and/or up to 160° C., or higher. In some embodiments, a temperature of the heated concentrated stream is greater than a temperature of the concentrated stream by at least 5° C., at least 10° C., at least 20° C., at least 50° C., at least 100° C., at least 120° C., at least 140° C., and/or up to 150° C. or more.

Any of a variety of techniques and suitable equipment may be used to elevate the temperature of the concentrated stream such that a non-lithium-containing salt is formed (e.g., via precipitation). In some embodiments, the temperature elevation is performed in a precipitation unit of a non-lithium-containing salt production unit as described above (e.g., heated concentration stream 128 may be produced by precipitation unit 126 of non-lithium-containing salt production unit 125 in FIG. 4B). In some embodiments, the precipitation unit is a vessel configured to heat liquid (e.g., by being equipped with a heater in thermal communication with the vessel). In some embodiments, the precipitation unit is configured to boil and/or evaporate the liquid (e.g., water) of the concentrated stream. In some embodiments, the concentrated stream is boiled at atmospheric pressure (e.g., between 90 and 110 kPa) while causing the concentrated stream to circulate. One example of suitable equipment for doing so is a forced circulation evaporator. Non-lithium-containing salts (e.g., NaCl, KCl) may be formed (e.g., precipitated) in the forced circulation evaporator.

In some embodiments, some (e.g., at least 5 wt %, at least 10 wt %, at least 20 wt %, at least 50 wt %, at least 80 wt %, at least 90 wt %, at least 95 wt %, at least 99 wt %, or more) or all of the non-lithium-containing salts formed during the temperature elevation of the concentrated stream are separated from the heated concentrated stream. Such a separation of solids from the heated concentrated stream may be performed using any suitable technique known in the art (e.g., filtration, centrifugation, decantation, etc.).

In some embodiments, the method of obtaining lithium (e.g., as a lithium salt) is performed such that at least a portion (e.g., at least 5 wt %, at least 10 wt %, at least 20 wt %, at least 50 wt %, at least 80 wt %, at least 90 wt %, at least 95 wt %, at least 99 wt %, or more) of the heated concentrated stream is part of the impurity-depleted concentrated stream. Incorporation of the heated concentration steam into the impurity-depleted concentrated stream may be direct or indirect.

In some embodiments, the process of removing at least some of the solubilized non-lithium cations from the concentrated stream comprises lowering a temperature of the heated concentrated stream such that an additional amount of the solid non-lithium-containing salt is formed. Such a lowering of the temperature may reduce the solubilities of the salts potentially formed by the solubilized lithium cations and non-lithium cations. It is believed that the differences in solubility of at least some lithium-containing salts and non-lithium-containing salts, and the temperature-dependences thereof, can result in solid non-lithium-containing salts being formed to a greater extent than is formed the lithium-containing salts during the temperature-lowering. In some embodiments, the temperature of the heated concentrated stream is lowered to a temperature of less than or equal to 40° C., less than or equal to 35° C., and/or as low as 30° C., or less.

Any of a variety of techniques and suitable equipment may be used to lower the temperature of the heated concentrated stream such that an additional amount of a non-lithium-containing salt is formed (e.g., via precipitation). In some embodiments, the temperature lowering is performed in a cooling unit of a non-lithium-containing salt production unit as described above (e.g., cooling unit 127 of non-lithium-containing salt production unit 125 in FIG. 4B). In some embodiments, the cooling unit is a vessel configured to cool liquid (e.g., by being equipped with a heat exchanger or refrigeration apparatus in thermal communication with the vessel). One example of a suitable equipment for lowering the temperature of the heated concentrated stream (e.g., comprising water) is a chiller. Non-lithium-containing salts (e.g., NaCl, KCl) may be formed (e.g., precipitated) in the chiller.

In some embodiments, some (e.g., at least 5 wt %, at least 10 wt %, at least 20 wt %, at least 50 wt %, at least 80 wt %, at least 90 wt %, at least 95 wt %, at least 99 wt %, or more) or all of the non-lithium-containing salts formed during the temperature lowering of the heated concentrated stream are separated from the resulting solution (e.g., stream). Such a separation of solids from the resulting solution may be performed using any suitable technique known in the art (e.g., filtration, centrifugation, decantation, etc.).

In some embodiments, the method of obtaining lithium (e.g., as a lithium salt) is performed such that at least a portion (e.g., at least 5 wt %, at least 10 wt %, at least 20 wt %, at least 50 wt %, at least 80 wt %, at least 90 wt %, at least 95 wt %, at least 99 wt %, or more) of the solution produced by the lowering of the temperature of the heated concentrated stream is part of the impurity-depleted concentrated stream. Incorporation of the resulting liquid from the lowering of the temperature of the heated concentrated stream may be direct (e.g., as illustrated by impurity-depleted concentrated stream exiting cooling unit 127 in FIG. 4B) or indirect.

In some embodiments, a method for obtaining lithium (e.g., as a lithium salt) from a liquid involves treating a solution via an electrochemical process. Such an electrochemical process may promote the at least partial replacement of counter-ions of solubilized lithium ions with different counter-ions. It has been realized that for at least some commercial/industrial applications, the lithium salts with certain counter-ions are generally more desirable or useful than those with counter-ions that may be more prevalent in feed streams. For example, in some instances, solid lithium hydroxide (LiOH) is a desirable product, while an available source of lithium ions (e.g., a salar brine) or treated product thereof is relatively rich in solubilized chloride anions but relatively lean in dissolved hydroxide ions. In some such instances, it is desirable to replace some or all of the chloride anions with hydroxide anions. It has been realized in the context of this disclosure that certain electrochemical processes may be well-suited (e.g., in terms of energy expenditure and ease of integration into lithium recovery systems) for some such lithium counter-ion replacements.

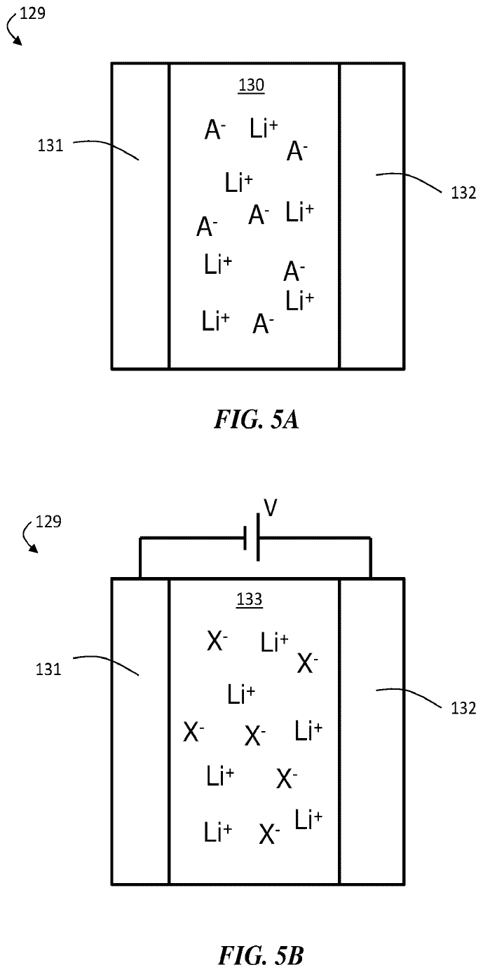

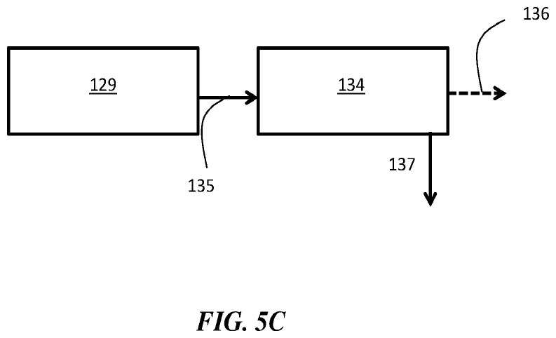

In some embodiments, a lithium recovery system comprises an electrochemical cell. FIG. 5A shows a cross-sectional schematic diagram of electrochemical cell 129, according to some embodiments. An electrochemical cell generally refers to a device capable of using electrical energy to induce chemical reactions and/or using chemical reactions to generate electrical energy. Examples of types of electrochemical cells include electrolytic cells and galvanic cells. In some embodiments, the electrochemical cell (e.g., electrochemical cell 129) is an electrolytic cell which can drive a reduction-oxidation chemical reaction via application of a voltage. In some embodiments, the electrochemical cell is a galvanic cell, in which a thermodynamically spontaneous reduction-oxidation reaction proceeds while generating electrical current across the electrodes.

In some embodiments, an initial solution (e.g., liquid solution) is associated with the electrochemical cell. For example, in some embodiments the electrochemical cell comprises a first electrode and a second electrode and at least a portion of the initial solution is in contact with at least a portion of the first electrode and/or the second electrode. The embodiment shown in FIG. 5A, for example, has initial solution 130 between first electrode 131 and second electrode 132 of electrochemical cell 129.

The initial solution may comprise a liquid, solubilized lithium cations, and solubilized first anions. For example, in FIG. 5A, initial solution 130 comprises solubilized lithium ions Li⁺ and solubilized first anions A⁻. The liquid may be or comprise water. For example, in some embodiments, at least 10 wt %, at least 25 wt %, at least 50 wt %, at least 75 wt %, at least 90 wt %, at least 95 wt %, at least 98 wt %, at least 99 wt %, at least 99.9 wt %, or more of the liquid is water. The first anions may be chosen from one or more of chloride, sulfate, carbonate, bicarbonate, nitrate, borate, phosphate, bromide, citrate, oxide, and hydride.

Some embodiments comprise applying a voltage to an electrochemical cell comprising the initial solution. In some such embodiments, the voltage is applied such that at least a portion (e.g., at least 5 wt %, at least 10 wt %, at least 20 wt %, at least 50 wt %, at least 80 wt %, at least 90 wt %, at least 95 wt %, at least 99 wt %, or more) of the first anions are replaced by second, different anions, thereby forming an electrochemically-treated solution comprising the liquid, solubilized lithium cations, and solubilized second anions. For example, referring to FIGS. 5A-5B, electrochemical cell 129 may initially comprise initial solution 130 (FIG. 5A), and upon application of a sufficient voltage V across first electrode 131 and second electrode 132 (FIG. 5B), at least some of first anions A⁻ are replaced by second anions X⁻, thereby forming electrochemically treated solution 133. The second anions (e.g., second anions X⁻ in FIG. 5B) may be any of a variety of different types of anions (e.g., hydroxides, halides, oxyanions), depending on a desired application. The second anions may be able to form lithium salts having more desirable properties than lithium salts comprising the first anion. For example, lithium salts comprising the second anion may have a different solubility than lithium salts comprising the first anion, which may be leveraged for downstream purification processes. In some instances, a lithium salt comprising the second anion is more commercially valuable than a lithium salt comprising the first lithium salt. For example, lithium hydroxide may be more commercially valuable than lithium chloride (e.g., for lithium ion battery applications), and so replacing at least a portion of chloride ions with hydroxide ions in a solution may be beneficial for some applications. In some embodiments, the second anions are more electronegative than the first anions. As shown in FIG. 5C, at least a portion of the electrochemically-treated solution may be transferred from the electrochemical cell (e.g., electrochemical cell 129) for further processes, such as further concentration (e.g., in a humidifier such as second humidifier 134), as described in more detail below.

In some embodiments, the electrochemically-treated solution comprises the solubilized second anions at a concentration greater than a concentration of the solubilized second anions in the initial solution. For example, in some embodiments, a ratio of a concentration of the solubilized second anions in the electrochemically-treated solution to the concentration of the solubilized second anions in the initial solution is greater than or equal to 1.1, greater than or equal to 1.2, greater than or equal to 1.5, greater than or equal to 2, greater than or equal to 5, greater than or equal to 10, greater than or equal to 100, greater than or equal to 1,000, greater than or equal to 10,000, greater than or equal to 100,000, and/or up to 1,000,000, or greater. A concentration of solubilized lithium cations may be relatively unchanged upon application of the voltage. For example, in some embodiments, a ratio of a concentration of solubilized lithium cations in the initial solution to the concentration of solubilized lithium cations in electrochemically-treated solution is less than or equal to 1.2, less than or equal to 1.1, less than or equal to 1.05, less than or equal to 1.02, less than or equal to 1, and/or as low as 0.98, as low as 0.95, as low as 0.9, or as low as 0.8.

As an illustrative example of an embodiment in which the electrochemical cell is an electrolytic cell, the initial solution may be an initial aqueous solution comprising solubilized lithium cations and solubilized chloride anions (e.g., from a brine). A voltage may be applied to drive an electrolytic reaction in which (a) the lithium ions are reduced at a first electrode to form Li⁰ (e.g., lithium metal), which may rapidly react with water to produce hydrogen gas (H₂), hydroxide anions (OH⁻), and lithium cations (Li⁺), and (b) the chloride ions are oxidized to form a product such as chlorine gas (Cl₂). The hydrogen gas and chlorine gas may be removed from the resulting electrochemically-treated solution (e.g., via bubbling), leaving the lithium cations and hydroxide anions remaining in the solution (thereby accomplishing the at least partial replacement of chloride anions with hydroxide anions).

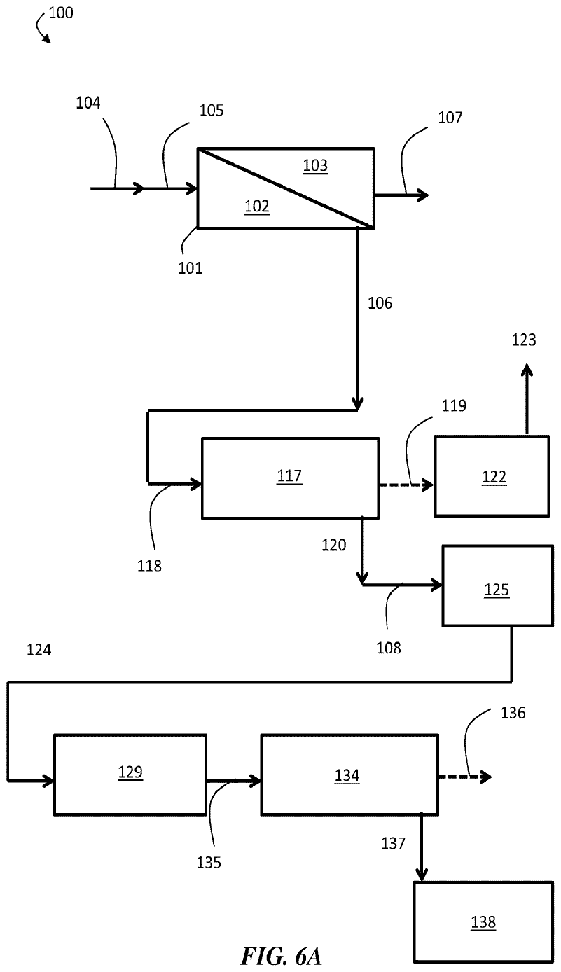

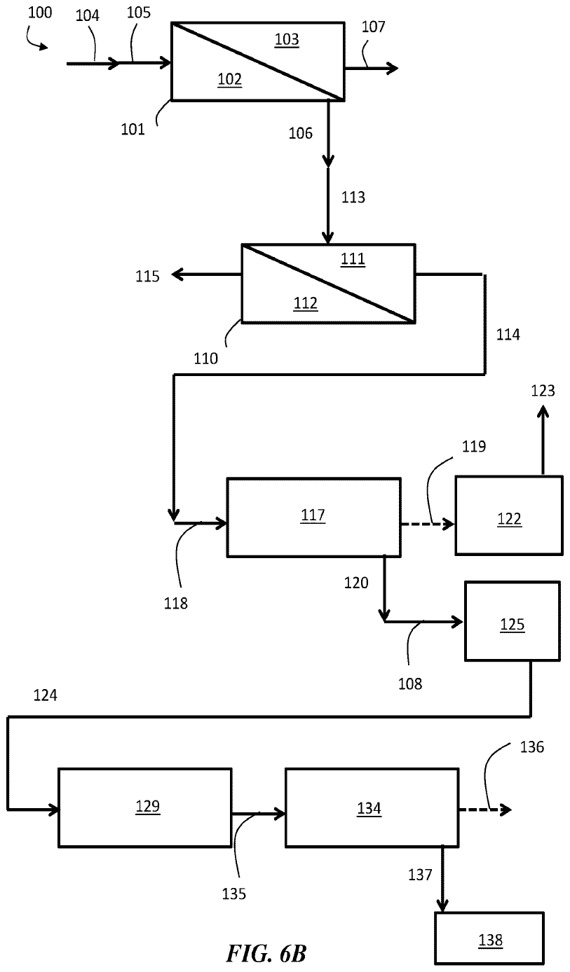

In some embodiments, the initial solution in the electrochemical cell (e.g., initial solution 130 in FIG. 5A) comprises at least a portion (e.g., at least 5 wt %, at least 10 wt %, at least 20 wt %, at least 50 wt %, at least 80 wt %, at least 90 wt %, at least 95 wt %, at least 99 wt %, or more) of the impurity-depleted concentrated stream described above. Such a process may promote facile anion exchange for producing desirable lithium salts derived from the feed stream (e.g., a salar brine or an extract from discarded lithium ion batteries). As an example, FIGS. 6A-6B show examples of embodiments of lithium recovery system 100 in which at least a portion of impurity-depleted concentrated stream 124 is transported from non-lithium-containing salt production unit 125 to electrochemical cell 129, where application of a voltage may result in replacement of at least some of the anions (chloride anions) in impurity-depleted concentrated stream 124 with different anions (e.g., hydroxide ions) prior to further downstream processing described in more detail below. In the embodiment shown in FIG. 6A, impurity-depleted concentrated stream 124 may be produced via removal of liquid from feed stream 104 via first membrane separator 101 and humidifier 117 prior to removal of at least a portion of the solubilized non-lithium cations in non-lithium-containing salt production unit 125. In the embodiment shown in FIG. 6B, impurity-depleted concentrated stream 124 may be produced via removal of liquid from feed stream 104 via first membrane separator 101, second membrane separator 110, and humidifier 117 prior to removal of at least a portion of the solubilized non-lithium cations in non-lithium-containing salt production unit 125.

In some embodiments, liquid is removed from the electrochemically-treated solution produced by the electrochemical cell (e.g., comprising a liquid, solubilized lithium cations, and the second anions). Such liquid removal may be useful in some instances where a relatively concentrated stream of lithium cations and the second anions is desired (e.g., for obtaining a solid salt of the lithium cation and second anion). In some embodiments, at least a portion of liquid from the electrochemically-treated solution is allowed to evaporate within a humidifier to produce a humidified gas stream and a humidifier liquid outlet stream. In some embodiments, the humidifier is the same humidifier as described above with respect to the removal of liquid from the feed stream. However, in other embodiments, more than one humidifier (which can be the same or different types) can be used.

As an example, in FIGS. 5C and 6A-6B, second humidifier 134 receives some (e.g., at least 5 wt %, at least 10 wt %, at least 20 wt %, at least 50 wt %, at least 80 wt %, at least 90 wt %, at least 95 wt %, at least 99 wt %, or more) or all of the liquid output of electrochemical cell 129 via second humidifier liquid inlet stream 135. At least a portion of liquid of second humidifier liquid inlet stream 135 may be allowed to evaporate with second humidifier 134 to produce second humidified gas stream 136 (comprising at least a portion of vapor produced by the evaporation) and second humidifier liquid outlet stream 137. In some instances, some or all of the second humidified gas stream is transported to a dehumidifier, where liquid in the second humidified gas stream may be condensed to form a liquid stream (e.g., comprising substantially pure water).

In some embodiments, the humidifier liquid outlet stream (e.g., second humidifier liquid outlet stream 137) has a higher concentration of the solubilized lithium cations and the solubilized second anions compared to the electrochemically-treated solution that is transported to the humidifier. For example, a ratio of a concentration of the solubilized lithium cations in the humidifier liquid outlet stream to the concentration of solubilized lithium cations in the electrochemically-treated solution may be greater than or equal to 1.1, greater than or equal to 1.2, greater than or equal to 1.5, greater than or equal 2, greater than or equal to 5, greater than or equal to 10, greater than or equal to 20, greater than or equal to 25, greater than or equal to 50, and/or up to 100, or greater.

In some embodiments, a solid lithium salt comprising at least a portion of the lithium cations derived from the feed stream is obtained (e.g., from the impurity-depleted concentrated stream, from the electrochemically-treated solution, and/or from humidifier liquid outlet stream). For example, in some embodiments, a solid lithium salt comprising at least a portion (e.g., at least 5 wt %, at least 10 wt %, at least 20 wt %, at least 50 wt %, at least 80 wt %, at least 90 wt %, at least 95 wt %, at least 99 wt %, or more) of the lithium cations and at least a portion of the second anions (e.g., at least 5 wt %, at least 10 wt %, at least 20 wt %, at least 50 wt %, at least 80 wt %, at least 90 wt %, at least 95 wt %, at least 99 wt %, or more) from the humidifier liquid outlet stream is obtained. As one example, in some embodiments the humidifier liquid outlet stream of the humidifier that is fed some or all of the electrochemically-treated solution comprises solubilized lithium cations and solubilized hydroxide ions. Some embodiments involve obtaining solid lithium hydroxide (LiOH) from that humidifier liquid outlet stream. Referring to FIGS. 6A-6B, solid lithium salt formation unit 138 may receive some or all of second humidifier liquid outlet stream 137. Solid lithium salt formation unit 138 may be any of a variety of apparatuses capable of inducing formation of solid lithium salts from solution. For example, obtaining a solid lithium salt may comprise removing liquid from the second humidifier liquid outlet stream, in some instances via heating (e.g., via boiling/evaporation). In some embodiments, the solid lithium salt formation comprises a forced circulation evaporator. In some embodiments, the solid lithium salt (e.g., LiOH) is obtained via crystallization. In some instances, the solid lithium salt is obtained by under reduced-pressure conditions (e.g., by applying a vacuum), optionally while heating. It is known that obtaining solid salts of some lithium-containing compounds such as lithium hydroxide is challenging at least because some such salts are relatively hygroscopic. It has been realized in the context of this disclosure that forming relatively concentrated solutions of solubilized cations and anions of such salts can assist with obtaining solid salts. Use of a humidifier to produce such high concentrations can be advantageous in some instances at least because a humidifier can produce sufficiently high solubilized lithium cation concentrations with relatively low energetic input and/or relatively quickly compared to typical technologies such as solar evaporation.

In some embodiments, solid lithium salt obtained can be further processed and/or packaged for commercial and/or industrial purposes. For example, lithium salt products may be obtained by filling and packing containers with the solid lithium salt. Pneumatic conveying followed by sealing using commercially-available form fill seal systems is one way to package the solid lithium salt.

In some embodiments, a pressure of any of the streams described herein can be increased via one or more additional components, such as one or more booster pumps. In some embodiments, a pressure of any of the streams described herein can be decreased via one or more additional components, such as one or more additional valves or energy recovery devices. In some embodiments, a membrane separator described herein further comprises one or more heating, cooling, or other concentration or dilution mechanisms or devices.

The membrane separators described herein (e.g., the first membrane separator, the second membrane separator, the third membrane separator) can each include a single semi-permeable membrane or a plurality of semi-permeable membranes.

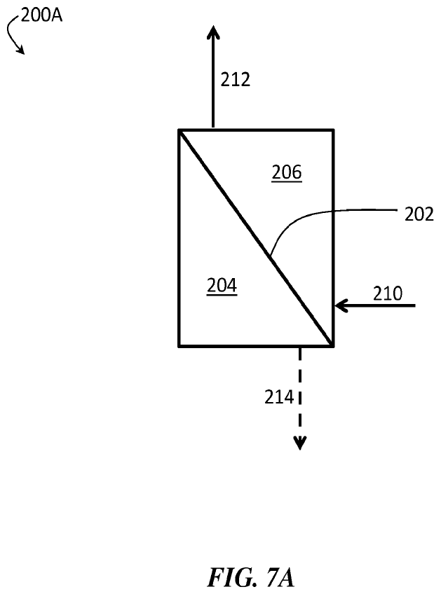

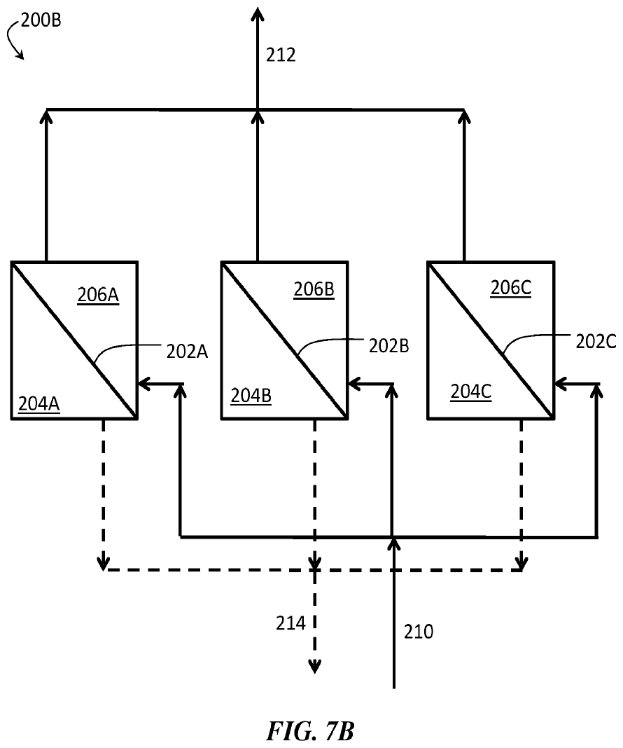

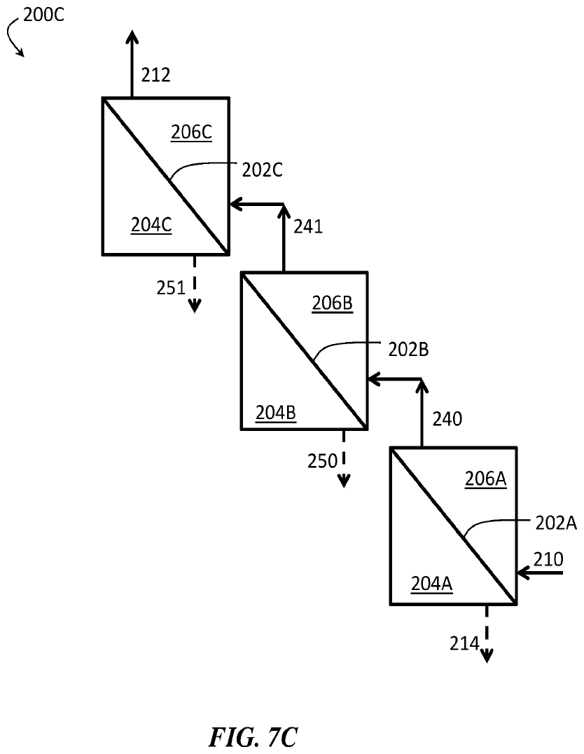

FIG. 7A is a schematic illustration of membrane separator 200A, in which a single semi-permeable membrane is used to separate permeate side 204 from retentate side 206. Membrane separator 200A can be operated by transporting retentate inlet stream 210 across retentate side 206. At least a portion of a liquid (e.g., a solvent) and, in some instances, solute within retentate inlet stream 210 can be transported across semi-permeable membrane 202 to permeate side 204. This can result in the formation of retentate outlet stream 212, which can include a higher concentration of solute than is contained within retentate inlet stream 210, as well as permeate outlet stream 214. Permeate outlet stream 214 can correspond to the liquid (e.g., solvent) and, in some instances, solute, of retentate inlet stream 210 that was transported from retentate side 206 to permeate side 204.

In some embodiments, a membrane separator (e.g., the first membrane separator, the second membrane separator, the third membrane separator) comprises a plurality of semi-permeable membranes connected in parallel. One example of such an arrangement is shown in FIG. 7B. In FIG. 7B, membrane separator 200B comprises three semi-permeable membranes 202A, 202B, and 202C arranged in parallel. Retentate inlet stream 210 is split into three sub-streams, with one sub-stream fed to retentate side 206A of semi-permeable membrane 202A, another sub-stream fed to retentate side 206B of semi-permeable membrane 202B, and yet another sub-stream fed to retentate side 206C of semi-permeable membrane 202C. Membrane separator 200B can be operated by transporting the retentate inlet sub-streams across the retentate sides of the semi-permeable membranes. At least a portion of a liquid (e.g., a solvent), and, in some instances, solute, within retentate inlet stream 210 can be transported across each of semi-permeable membranes 202A, 202B, and 202C to permeate sides 204A, 204B, and 204C, respectively. This can result in the formation of three retentate outlet sub-streams, which can be combined to form retentate outlet stream 212. Retentate outlet stream 212 can include a higher concentration of solute than is contained within retentate inlet stream 210. Permeate outlet stream 214 can also be formed (from three permeate outlet sub-streams). Permeate outlet stream 214 can correspond to the liquid (e.g., solvent), and, in some instances, solute of retentate inlet stream 210 that was transported from retentate sides 206A-206C to permeate sides 204A-204C.

While FIG. 7B shows three semi-permeable membranes connected in parallel, other embodiments could include 2, 4, 5, or more semi-permeable membranes connected in parallel.

In some embodiments, a membrane separator (e.g., the first membrane separator, the second membrane separator) comprises a plurality of semi-permeable membranes connected in series. One example of such an arrangement is shown in FIG. 7C. In FIG. 7C, membrane separator 200C comprises three semi-permeable membranes 202A, 202B, and 202C arranged in series. In FIG. 7C, retentate inlet stream 210 is first transported to retentate side 206A of semi-permeable membrane 202A. At least a portion of a liquid (e.g., a solvent), and, in some instances, solute, within retentate inlet stream 210 can be transported across semi-permeable membrane 202A to permeate side 204A of semi-permeable membrane 202A. This can result in the formation of permeate outlet stream 214 and first intermediate retentate stream 240 that is transported to retentate side 206B of semi-permeable membrane 202B. At least a portion of a liquid (e.g., a solvent), and, in some instances, solute, within first intermediate retentate stream 240 can be transported across semi-permeable membrane 202B to permeate side 204B of semi-permeable membrane 202B. This can result in the formation of permeate outlet stream 250 and second intermediate retentate stream 241 that is transported to retentate side 206C of semi-permeable membrane 202C. At least a portion of a liquid (e.g., a solvent), and, in some instances, solute within second intermediate retentate stream 241 can be transported across semi-permeable membrane 202C to permeate side 204C of semi-permeable membrane 202C. This can result in the formation of permeate outlet stream 251 and retentate outlet stream 212.

While FIG. 7C shows three semi-permeable membranes connected in series, other embodiments could include 2, 4, 5, or more semi-permeable membranes connected in series.

For membrane separators comprising a plurality of semi-permeable membranes, parameters such as rejection percentage, recovery, and salt passage percentage at standard conditions for the membrane separators are calculated by performing a mass balance on the entire membrane separator. This means that all initial retentate streams for the membrane separator would be added and considered together, all final permeate outlet streams for the membrane separator would be added and considered together, and all final retentate outlet streams for the membrane separator would be added and considered together. For example, as mentioned above, in FIG. 7B, membrane separator 200B comprises three semi-permeable membranes 202A, 202B, and 202C arranged in parallel. Accordingly, calculation of the composition of the retentate inlet stream of membrane separator 200B for the purpose of calculating parameters such as the rejection percentage, recovery, and salt passage percentage at standard conditions for membrane separator 200B would involve taking measurements of retentate inlet stream 210 prior to it being split into the three inlet sub-streams fed to retentate sides 206A, 206B, and 206C of semi-permeable membranes 202A, 202B, and 202C, respectively. Similarly, calculation of the composition of the retentate outlet stream of membrane separator 200B for the purpose of calculating parameters such as the rejection percentage, recovery, and salt passage percentage at standard conditions for membrane separator 200B would involve taking measurements of retentate outlet stream 212, which is a combination of the three outlet sub-streams from retentate sides 206A, 206B, and 206C from semi-permeable membranes 202A, 202B, and 202C, respectively. Also similarly, calculation of the composition of the permeate outlet stream of membrane separator 200B for the purpose of calculating parameters such as the rejection percentage, recovery, and salt passage percentage at standard conditions would involve taking measurements of permeate outlet stream 214, which is a combination of the three outlet sub-streams from permeate sides 204A, 204B, and 204C from semi-permeable membranes 202A, 202B, and 202C, respectively.

As another example of the calculation of parameters corresponding to a membrane separator comprising a plurality of semi-permeable membranes, reference is made to membrane separator 200C in FIG. 7C. Membrane separator 200C comprises three semi-permeable membranes 202A, 202B, and 202C arranged in series. Accordingly, calculation of the composition of the retentate inlet stream of membrane separator 200C for the purpose of calculating parameters such as the rejection percentage, recovery, and salt passage percentage at standard conditions for membrane separator 200C would involve taking measurements of retentate inlet stream 210 prior to it entering semi-permeable membrane 202A because semi-permeable membrane 202A is the initial semi-permeable membrane in the series. Similarly, calculation of the composition of the retentate outlet stream of membrane separator 200C for the purpose of calculating parameters such as the rejection percentage, recovery, and salt passage percentage at standard conditions for membrane separator 200C would involve taking measurements of retentate outlet stream 212 exiting semi-permeable membrane 202C because semi-permeable membrane 202C is the final semi-permeable membrane in the series with respect to the retentate outlet streams, thereby making retentate outlet stream 212 the final retentate outlet stream of membrane separator 200C. Calculation of the composition of the permeate outlet stream of membrane separator 200C for the purpose of calculating parameters such as the rejection percentage, recovery, and salt passage percentage at standard conditions would involve taking measurements of a combination of permeate outlet streams 214, 250, and 251 exiting semi-permeable membranes 202A, 202B, and 202C respectively. In addition, in some embodiments, a given membrane separator could include multiple semi-permeable membranes connected in parallel as well as multiple semi-permeable membranes connected in series.

In some embodiments, the first membrane separator comprises a plurality of semi-permeable membranes. In some such embodiments, the plurality of semi-permeable membranes within the first membrane separator are connected in series. In some such embodiments, the plurality of semi-permeable membranes within the first membrane separator are connected in parallel. In certain embodiments, the first membrane separator comprises a plurality of membranes a first portion of which are connected in series and another portion of which are connected in parallel.

In some embodiments, the second membrane separator comprises a plurality of semi-permeable membranes. In some such embodiments, the plurality of semi-permeable membranes within the second membrane separator are connected in series. In some such embodiments, the plurality of semi-permeable membranes within the second membrane separator are connected in parallel. In certain embodiments, the second membrane separator comprises a plurality of membranes a first portion of which are connected in series and another portion of which are connected in parallel.

In some embodiments, the third membrane separator comprises a plurality of semi-permeable membranes. In some such embodiments, the plurality of semi-permeable membranes within the third membrane separator are connected in series. In some such embodiments, the plurality of semi-permeable membranes within the third membrane separator are connected in parallel. In certain embodiments, the third membrane separator comprises a plurality of membranes a first portion of which are connected in series and another portion of which are connected in parallel.

As mentioned above, each membrane separator of the system may comprise at least one semi-permeable membrane. In general, a semi-permeable membrane is a barrier that allows some components of a mixture to pass through while blocking at least some of other components (e.g., blocking all of another component, or reducing the relative rate of permeation of another component). For example, a semi-permeable membrane may block some molecules in a liquid solution from passing through while allowing others to pass through. In some instances, a semi-permeable membrane blocks some molecules and permits other molecules to pass through based on their molecular weight and/or charge. As noted above, a semi-permeable membrane can be used for osmotic processes. For example, the semi-permeable membrane may be an osmotic membrane. An osmotic membrane may be capable of producing an osmotic pressure difference between solutions on either side of the membrane upon application of a hydraulic pressure difference across the two sides of the membrane. For example, if an osmotic membrane is placed between two solutions of identical composition such that there is initially no osmotic pressure difference across the membrane, application of a hydraulic pressure difference across the osmotic membrane may allow for transport of components from one side of the membrane to the other such that an osmotic pressure difference across the two sides of the membrane is established. Semi-permeable membranes may also be used for nanofiltration processes. Semi-permeable membranes may be configured for osmotic processes, nanofiltration processes, and/or processes in which separation is achieved based on a combination of nanofiltration and osmotic mechanisms (e.g., based on, for example, the molecular weight cutoff of the membranes, pore sizes of the membranes, the nature of the mixtures to which they are exposed, and a magnitude of applied hydraulic pressure).

The semi-permeable membrane medium can comprise, for example, a metal, a ceramic, a polymer (e.g., polyamides, polyethylenes, polyesters, poly(tetrafluoroethylene), polysulfones, polycarbonates, polypropylenes, poly(acrylates)), and/or composites or other combinations of these. The semi-permeable membranes generally allow for the selective transport of solvent (e.g., water) through the membrane, where solvent is capable of being transmitted through the membrane while solute (e.g., solubilized species such as solubilized ions) are inhibited from being transported through the membrane. Examples of commercially available semi-permeable membranes that can be used in association with certain of the embodiments described herein include, but are not limited to, those commercially available from Dow Water and Process Solutions (e.g., FilmTec™ membranes), Hydranautics, GE Osmonics, Suez, LG, Toyobo, Microdyn, and Toray Membrane, among others known to those of ordinary skill in the art.

In some embodiments, the semi-permeable membrane(s) of the first membrane separator, the second membrane separator, and/or the third membrane separator has an average pore size of greater than or equal to 0.0001 microns, greater than or equal to 0.001 microns, greater than or equal to 0.002 microns or greater. In some embodiments, the semi-permeable membrane of the first membrane separator, the second membrane separator, and/or the third membrane separator has an average pore size of less than or equal to 0.01 microns, less than or equal to 0.005 microns, or less. Combinations of these ranges (e.g., greater than or equal to 0.0001 microns and less than or equal to 0.01 microns) are possible.

In some embodiments, the semi-permeable membrane(s) of the second membrane separator has an average pore size that is greater than that of the semi-permeable membrane(s) of the first membrane separator (e.g., by a factor of at least 1.05, at least 1.1, at least 1.2, at least 1.5, at least 2, at least 3, at least 5, or more). In some embodiments, the semi-permeable membrane(s) of the third membrane separator has an average pore size that is greater than that of the semi-permeable membrane(s) of the second membrane separator (e.g., by a factor of at least 1.05, at least 1.1, at least 1.2, at least 1.5, at least 2, at least 3, at least 5, or more). The average pore size of the semi-permeable membrane may affect any of a variety of the parameters discussed below, such as solute permeability, water permeability, salt passage, rejection, and/or recovery. Average pore size can be determined, for example, using mercury intrusion porosimetry.

In some embodiments, the semi-permeable membrane of a membrane separator of this disclosure has an average molecular weight cutoff (MWCO) that is sufficiently high such that a desired amount of liquid and/or solute (and/or type of solute) can pass through during operation of the system. In some embodiments, the semi-permeable membrane(s) of the first membrane separator, the second membrane separator, and/or the third membrane separator has an average MWCO of greater than or equal to 50 Daltons, greater than or equal to 75 Daltons, greater than or equal to 100 Daltons, greater than or equal to 150 Daltons, or greater. In some embodiments, the semi-permeable membrane of a membrane separator of this disclosure has an average molecular weight cutoff (MWCO) that is sufficiently low such that a desired amount of solute (and/or type of solute) is rejected such that an effective separation is performed. In some embodiments, the semi-permeable membrane(s) of the first membrane separator, the second membrane separator, and/or the third membrane separator has an average MWCO of less than or equal to 400 Daltons, less than or equal to 300 Daltons, less than or equal to 250 Daltons, less than or equal to 200 Daltons, or less. Combinations of these ranges (e.g., greater than or equal to 50 Daltons and less than or equal to 400 Daltons, greater than or equal to 50 Daltons and less than or equal to 250 Daltons) are possible. The average MWCO of a membrane refers to the lowest molecular weight solute in which 90% of the solute is retained by the membrane.

In some embodiments, the semi-permeable membrane(s) of the second membrane separator has an average MWCO that is greater than that of the semi-permeable membrane(s) of the first membrane separator (e.g., by a factor of at least 1.05, at least 1.1, at least 1.2, at least 1.5, at least 2, at least 3, at least 5, and/or up to 10, up to 20, or more). In some embodiments, the semi-permeable membrane(s) of the third membrane separator has an average MWCO that is greater than that of the semi-permeable membrane(s) of the second membrane separator (e.g., by a factor of at least 1.05, at least 1.1, at least 1.2, at least 1.5, at least 2, at least 3, at least 5, and/or up to 10, up to 20, or more). The average MWCO of the semi-permeable membrane may affect any of a variety of the parameters discussed below, such as solute permeability, salt passage, rejection, and/or recovery.

The solute permeability of each membrane separator may be chosen based on any of a variety of design criteria such as desired purity of permeate, desired hydraulic pressure to be used, and nature of incoming influent (e.g., solute concentration of incoming influent). The solute permeability of a membrane separator can be calculated from the solute flux through the membrane and the respective concentrations of solute on either side using equation [3] below:

$${J}_{S} = B ( {C}_{R} - {C}_{P} ) \qquad [ 3 ]$$

In the above equation, Jₛ represents the ion flux, C_{R} represents the concentration of solute on the retentate side of the membrane, C_{P} represents the concentration of solute on the permeate side of the membrane, and B represents the solute permeability. Solute permeability is dependent on the species of solute in the retentate inlet stream and the concentrations on either side of the membrane.

In some embodiments, the solute permeabilities of the first membrane separator and the second membrane separator (and, if present the third membrane separator) during operation of the method are chosen to afford good, consistent performance across all membrane separators by accounting for differences in concentrations of their respective retentate inlet streams. In some embodiments, the solute permeability of the first membrane separator during the step of transporting the first membrane separator retentate inlet stream to the retentate side of the first membrane separator is different than the solute permeability of the second membrane separator during the step of transporting the second membrane separator retentate inlet stream to the retentate side of the second membrane separator. The difference in solute permeabilities between the first membrane separator and the second membrane separator may be due, at least in part, to use of different semi-permeable membranes in the first and second membrane separators (e.g., having different pore sizes, MWCOs, and/or surface chemistries). In some embodiments, the solute permeability of the first membrane separator during the step of transporting the first membrane separator retentate inlet stream to the retentate side of the first membrane separator and the solute permeability of the second membrane separator during the step of transporting the second membrane separator retentate inlet stream to the retentate side of the second membrane separator are at least 5% different, at least 10% different, at least 20% different, at least 50% different, and/or up to 100% different or more different from each other. In some embodiments, the solute permeability of the second membrane separator during the step of transporting the second membrane separator retentate inlet stream to the retentate side of the second membrane separator is greater than the solute permeability of the first membrane separator during the step of transporting the first membrane separator retentate inlet stream to the retentate side of the first membrane separator (e.g., by a factor of at least 1.05, at least 1.1, at least 1.2, at least 1.5, at least, 2, at least, 3, at least 5, or more). In some embodiments, the first membrane separator has a solute permeability of 0 during operation of the first membrane separator. In this context, the solute permeability refers to the permeability of all total solute in the streams. However, in some embodiments, the relationships between permeabilities of the first and second membrane separators hold for one or more specific solute species described in this disclosure, such as solubilized NaCl and/or solubilized lithium cations.

When calculating the percentage difference between two values (unless specified otherwise herein), the percentage calculation is made using the value that is larger in magnitude as the basis. To illustrate, if a first value is V₁, and a second value is V₂ (which is larger than V₁), the percentage difference (V_{%Diff}) between V₁ and V₂ would be calculated as:

$${V}_{\% Diff} = \frac{{V}_{2} - {V}_{1}}{{V}_{2}} \times 100 \% \qquad [ 4 ]$$

and the first and second values would be said to be within X % of each other if V_{%Diff} is X % or less, and the first and second values would be said to be at least X % different than each other if V_{%Diff} is X % or more.

Water permeability can be calculated from the water flux, pressure differential and osmotic differential, as shown below in equation [5]:

$${J}_{W} = A ( Δ P - Δπ ) \qquad [ 5 ]$$

In the above equation [5], J_{w} represents the flux of water through the membrane, ΔP represents the hydraulic pressure differential across the membrane, Δπ represents the osmotic pressure differential across the membrane, and A represents the water permeability.

The salt passage percentage at standard conditions of each membrane separator may be chosen based on any of a variety of design criteria such as desired purity of permeate, desired hydraulic pressure to be used, and nature of incoming influent (e.g., solute type and/or concentration of incoming influent). The salt passage percentage at standard conditions of a membrane separator is an intrinsic property of the separator based on the quantity of salt, as a percentage, which passes through the semi-permeable membrane(s) from the retentate side to the permeate side of the membrane separator under defined reference conditions. The salt passage percentage at standard conditions of a membrane separator can be determined using the standardized test described in ASTM D4516-19a.

In some embodiments, the salt passages at standard conditions of the first membrane separator and the second membrane separator (and, if present the third membrane separator) used in in the operation of the method are chosen to afford good, consistent performance across all membrane separators by accounting for differences in concentrations of their respective retentate inlet streams. In some embodiments, the salt passage percentage at standard conditions of the first membrane separator is different than the salt passage percentage at standard conditions of the second membrane separator. The difference in salt passages at standard conditions between the first membrane separator and the second membrane separator may be due, at least in part, to use of different semi-permeable membranes in the first and second membrane separators (e.g., having different pore sizes, MWCOs, and/or surface chemistries). In some embodiments, the salt passage percentage at standard conditions of the first membrane separator and the salt passage percentage at standard conditions of the second membrane separator are at least 5% different, at least 10% different, at least 20% different, at least 50% different, and/or up to 100% different or more different from each other. In some embodiments, the salt passage percentage at standard conditions of the second membrane separator is greater than the salt passage percentage at standard conditions of the first membrane separator (e.g., by a factor of at least 1.05, at least 1.1, at least 1.2, at least 1.5, at least, 2, at least, 3, at least 5, and/or up to 10, up to 20, or more). In some embodiments in which the system further comprises a third membrane separator, the salt passage percentage at standard conditions of the second membrane separator is different than the salt passage percentage at standard conditions of the third membrane separator. In some embodiments, the salt passage percentage at standard conditions of the second membrane separator and the salt passage percentage at standard conditions of the third membrane separator are at least 5% different, at least 10% different, at least 20% different, at least 50% different, and/or up to 100% different or more different from each other. In some embodiments, the salt passage percentage at standard conditions of the third membrane separator is greater than the salt passage percentage at standard conditions of the second membrane separator (e.g., by a factor of at least 1.05, at least 1.1, at least 1.2, at least 1.5, at least, 2, at least, 3, at least 5, and/or up to 10, up to 20, or more).

In some embodiments, the salt passage percentage at standard conditions of the first membrane separator, the second membrane separator, and/or the third membrane separator (if present) are independently greater than or equal to 0%, greater than or equal to 1%, greater than or equal to 2%, greater than or equal to 5%, greater than or equal to 10%, greater than or equal to 15%, greater than or equal to 20%, greater than or equal to 50%, greater than or equal to 75%, and/or up to 80%, up to 85%, up to 90%, or greater. In some embodiments, the first membrane separator has a relatively low salt passage percentage at standard conditions. Such a low salt passage percentage at standard conditions may be useful in embodiments in which the first membrane separator is operated as a high-rejection reverse osmosis separator. In some embodiments, the first membrane separator has a salt passage percentage at standard conditions of less than or equal to 10%, less than or equal to 5%, less than or equal to 2%, less than or equal to 1%, less than or equal to 0.1%, or less.

Intrinsic properties of a semi-permeable membrane such as salt passage percentage at standard conditions, pore size, and/or MWCO can be selected based on supplier specifications for commercially-obtained membranes, by controlling the synthesis of membranes, and/or by physically and/or chemically modifying existing membranes (e.g., commercially obtained membranes). As an example of the latter, in some embodiments, a set of identical membranes may be obtained commercially (or prepared synthetically). A first subset of the membranes may be used without further modification. A second subset may be subjected to a first type of modification procedure (e.g., chemical treatment) that enlarges the pores of the membranes and/or modifies the surface chemistry of the membranes in such a way that the intrinsic salt passage (salt passage percentage at standard conditions), average pore size, and/or MWCO is increased. A third subset of the membranes may be subjected to a second, different type of modification procedure (e.g., a different chemical treatment) that enlarges the pores of the membranes and/or modifies the surface chemistry of the membranes in such a way that the intrinsic salt passage, average pore size, and/or MWCO is increased to a greater extent than those of the second subset of membranes. In such a way, the first subset of membranes could be incorporated into the first membrane separator, the second subset of membranes into the second membrane separator, and the third subset of membranes into the third membrane separator, in accordance with some embodiments. Each of the first membrane separator, the second membrane separator, and the third membrane separator may then have a differing salt passage percentage at standard conditions and, in use, differing permeabilities, rejections, and recoveries.

In some embodiments, the semi-permeable membrane comprises cross-links. For example, the membrane may be a cross-linked polyamide membrane. In some embodiments, the semi-permeable membrane comprises an active layer which comprises the cross-links (e.g., a cross-linked polyamide active layer). One way in which a semi-permeable membrane of can be modified (e.g., such that the intrinsic salt passage, average pore size, and/or MWCO is increased) is via disruption of at least some (e.g., at least 0.01 mole percent (mol %), at least 0.1 mol %, at least 0.2 mol %, at least 0.5 mol %, at least 1 mol %, at least 2 mol %, at least 5 mol %, and/or up to 10 mol %, up to 20 mol %, or more) of the cross-links of the membrane. For example, cross-links (e.g., of polyamide chains) of the membrane may be disrupted via physical treatment (e.g., thermal treatment and/or mechanical disruption) and/or chemical treatment (e.g., via treatment with a chemical reagent and/or ultraviolet or visible light). Chemical treatment may result in chemical disruption (e.g., via breaking of chemical bonds due to a chemical reaction, breaking of noncovalent interactions such as hydrogen bonding) of at least some (e.g., at least 0.1 mole percent (mol %), at least 0.2 mol %, at least 0.5 mol %, at least 1 mol %, at least 2 mol %, at least 5 mol %, and/or up to 10 mol %, up to 20 mol %, or more) of the cross-links. In some embodiments in which the semi-permeable membrane comprises cross-links (e.g., as part of an active layer), the semi-permeable membrane comprises a cross-linked polymeric material derived from monomers. In some such embodiments, fewer than or equal to 99.9 mol % (e.g., fewer than or equal to 99 mol %, fewer than or equal to 98 mol %, fewer than or equal to 95 mol %, and/or as few as 90 mol %, as few as 80 mol %, or fewer) of the monomers participate in at least one cross-link (e.g., due at least in part to disruption such as chemical disruption).

One example of a way in which at least some cross-links may be disrupted is by treating at least a portion of the membrane with a chemical reagent tending to break covalent and/or noncovalent bonds within the cross-links of the membrane. In some embodiments, the chemical reagent comprises an oxidant. One example of a potential oxidant for use with at least some membranes (e.g., polyamide membranes) is hypochlorite (ClO⁻). The hypochlorite may be provided as a solution comprising sodium hypochlorite (NaClO). The cross-links of the membrane may be disrupted by exposing at least a portion of the membrane to the chemical reagent (e.g., an oxidant such as hypochlorite). The duration of the exposure and/or the amount of chemical reagent (e.g., concentration of reagent in a solution contacting the membrane) may be selected based on a desired extent of disruption of the cross-links of the membrane. The desired extent of disruption of the cross-links of the membrane may in turn be based at least on a desired permeability of the semi-permeable membrane under certain conditions, a desired average pore size, and/or a desired MWCO.

The presence and extent of disrupted cross-links may be determined by examination of the semi-permeable membrane. For example, the loss of cross-links due to chemical disruption may be detected and quantified by observing the presence and/or number of certain atoms or moieties (e.g., terminal functional groups) associated with the chemical dissociation of the cross-links being considered. The presence and/or number of such certain atoms or moieties may be observed using, for example spectroscopic techniques such as infrared (IR) spectroscopy (e.g., Fourier-Transform Infrared (FTIR) spectroscopy) or X-ray photoelectron spectroscopy (XPS). For example, XPS can be used to determine deviations from atomic ratios of certain atoms compared to ratios that would be expected in the absence of disruption of cross-linking. As an illustrative example, a partially oxidized polyamide membrane can be measured by determining the atomic ratio of oxygen to nitrogen using XPS. When polyamide is fully crosslinked, all oxygen atoms and nitrogen atoms in the polyamide polymer form amide groups, resulting in a 1:1 atomic ratio of oxygen to nitrogen. In a fully linear polyamide (thereby lacking cross-links), a free carboxyl group is present for every two amide groups, so the atomic ratio of oxygen to nitrogen is 2:1. Measurements of atomic ratio values between 1:1 and 2:1 can be used to determine extent of disruption of partially-oxidized polyamide accordingly. For example, an atomic ratio of oxygen to nitrogen of 1.5:1 in a polyamide membrane would indicate that 50 mol % of the crosslink are disrupted.

The rejection of each membrane separator may be chosen based on any of a variety of design criteria such as desired purity of permeate, desired hydraulic pressure to be used, and nature of incoming influent (e.g., solute concentration of incoming influent). The rejection, R, of a membrane separator can be calculated from C_{R} (the concentration of solute on the retentate side of the membrane) and C_{P} (the concentration of solute on the permeate side of the membrane) and expressed as a percentage using Equation [6] below:

$$R = [ 1 - ( {C}_{P} / {C}_{R} ) ] * 100 \qquad [ 6 ]$$

In some embodiments, the rejections (R) of the first membrane separator and the second membrane separator (and, if present the third membrane separator) during operation of the method are chosen to afford good, consistent performance across all membrane separators by accounting for differences in concentrations of their respective retentate inlet streams. In some embodiments, the rejection of the first membrane separator for at least one solute (or all solutes) (e.g., the solute during the step of transporting the first membrane separator retentate inlet stream to the retentate side of the first membrane separator) is different than a rejection of the second membrane separator for the for at least one solute (or all solutes) (e.g., the solute during the step of transporting the second membrane separator retentate inlet stream to the retentate side of the second membrane separator). The difference in rejections between the first membrane separator and the second membrane separator may be due, at least in part, to use of different semi-permeable membranes in the first and second membrane separators (e.g., having different pore sizes, MWCOs, and/or surface chemistries). In some embodiments, the rejection of the first membrane separator for at least one solute (or all solute) (e.g., the solute during the step of transporting the first membrane separator retentate inlet stream to the retentate side of the first membrane separator) and the rejection of the second membrane separator for at least one solute (or all solute) (e.g., the solute during the step of transporting the second membrane separator retentate inlet stream to the retentate side of the second membrane separator) are at least 5% different, at least 10% different, at least 20% different, at least 50% different, and/or up to 100% different, or more different from each other. In some embodiments, the rejection of the second membrane separator for at least one solute (or all solutes) (e.g., the solute during the step of transporting the second membrane separator retentate inlet stream to the retentate side of the second membrane separator) is less than that of the first membrane separator for the at least one solute (or all solutes) (e.g., the solute during the step of transporting the first membrane separator retentate inlet stream to the retentate side of the second membrane separator) (e.g., by at least 5%, at least 10%, at least 20%, at least 50%, at least 75%, at least 90%, or more). In some embodiments, the rejection of the second membrane separator for at least one solute (or all solutes) (e.g., the solute during the step of transporting the second membrane separator retentate inlet stream to the retentate side of the second membrane separator) and the rejection of the third membrane separator for at least one solute (or all solute) (e.g., the solute during the step of transporting the third membrane separator retentate inlet stream to the retentate side of the third membrane separator) are at least 5%, at least 10%, at least 20%, at least 50%, and/or up to 100% different, or more different from each other. In some embodiments, the rejection of the third membrane separator for at least one solute (or all solutes) (e.g., the solute during the step of transporting the third membrane separator retentate inlet stream to the retentate side of the third membrane separator) is less than that of the second membrane separator for the at least one solute (or all solutes) (e.g., the solute during the step of transporting the second membrane separator retentate inlet stream to the retentate side of the second membrane separator) (e.g., by at least 5%, at least 10%, at least 20%, at least 50%, at least 75%, at least 90%, or more).

In some embodiments, the rejection for at least one solute (or all solutes) (e.g., the solute during the step of transporting the first membrane separator retentate inlet stream to the retentate side of the first membrane separator, or in some instances specifically lithium cations) of the first membrane separator is greater than or equal to 10%, greater than or equal to 15%, greater than or equal to 20%, greater than or equal to 50%, greater than or equal to 75%, greater than or equal to 80%, greater than or equal to 85%, greater than or equal to 90%, greater than or equal to 95%, greater than or equal to 98%, greater than or equal to 99%, greater than or equal to 99.9%, or greater. In some embodiments, the rejection for at least one solute (or all solutes) (e.g., the solute during the step of transporting the first membrane separator retentate inlet stream to the retentate side of the first membrane separator, or in some instances specifically lithium cations) of the first membrane separator is less than or equal to 100%, less than or equal to 99%, less than or equal to 95%, less than or equal to 90%, less than or equal to 85%, less than or equal to 80%, less than or equal to 50%, or less. Combinations of these ranges (e.g., greater than or equal to 10% and less than or equal to 100%) are possible.

In some embodiments, the rejection for at least one solute (or all solutes) (e.g., the solute during the step of transporting the first membrane separator retentate inlet stream to the retentate side of the first membrane separator, or in some instances specifically lithium cations) of the first membrane separator, second membrane separator, and/or the third membrane separator (if present) are, independently, greater than or equal to 10%, greater than or equal to 15%, greater than or equal to 20%, greater than or equal to 50%, or greater. In some embodiments, the rejection for at least one solute (or all solutes) (e.g., the solute during the step of transporting the first membrane separator retentate inlet stream to the retentate side of the first membrane separator, or in some instances specifically lithium cations) of the second membrane separator and/or the third membrane separator (if present) are, independently, less than or equal to greater than or equal to 95%, less than or equal to 90%, less than or equal to 85%, less than or equal to 80%, less than or equal to 75%, less than or equal to 60%, less than or equal to 50%, or less. Combinations of these ranges (e.g., greater than or equal to 10% and less than or equal to 95%) are possible.

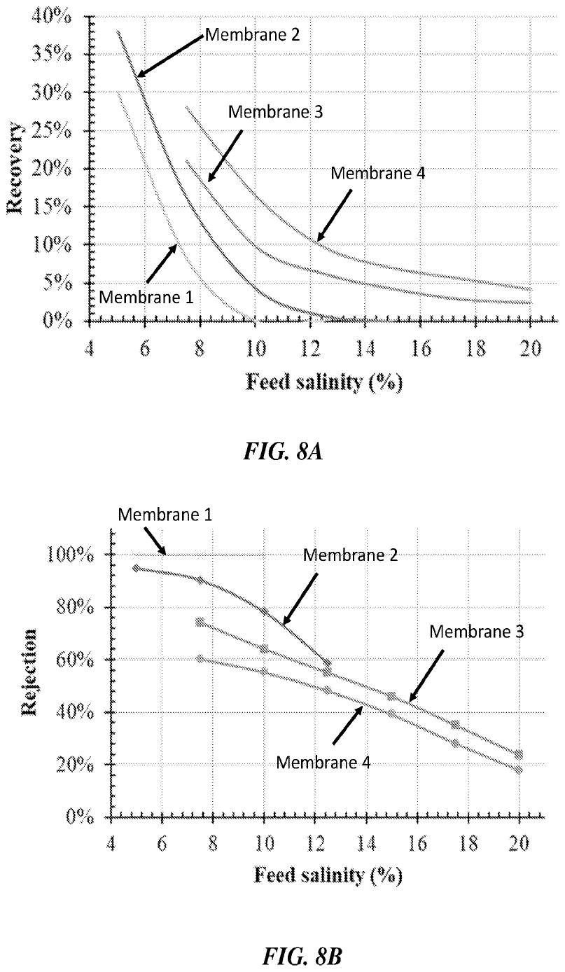

It has been realized in the context of this disclosure that, for a system for performing liquid separations (e.g., for feed stream concentration and/or desalination processes), judicious selection of membranes with varying properties can promote good system performance (e.g., in terms of performing desired separations with fewer components and/or smaller membrane areas). Membrane properties such as permeability, salt passage, pore size, and/or MWCO can affect observed recoveries and rejections. It has also been realized in the context of this disclosure that the recovery and the rejection accomplished by a membrane separator is affected by the solute concentration (e.g., salinity) of the retentate inlet streams. For example, FIGS. 8A-8B show recovery (FIG. 8A) and rejection (FIG. 8B) as a function of feed salinity for four membranes with varying permeability. Membrane 1 has the lowest permeability and highest rejection, while Membrane 4 has the highest permeability and lowest rejection. Such membranes can be obtained from any of a variety of sources, such as by obtaining commercially or by modifying commercially available membranes (e.g., polyamide membranes) to achieve the desired permeability. As can be seen in FIGS. 8A-8B, for each membrane, the recovery and rejection decrease with increasing feed salinity. However, it has been realized in the context of this disclosure that a substantially constant recovery (which can be desirable) for a system having multiple membrane separators can be achieved irrespective of feed salinity by utilizing membranes with varying permeability. As an illustrative example, and referring again to FIG. 8A, to achieve 5% recovery, Membrane 1 can be used for 8% salinity feed, Membrane 2 for 10% salinity feed, Membrane 3 for 14% salinity feed and Membrane 4 for a 19% salinity feed.

As used herein, the salinity of a liquid stream refers to the weight percent (wt %) of all dissolved salts in the liquid stream. Salinity may be measured according to any method known in the art. For example, a non-limiting example of a suitable method for measuring salinity is the SM 2540C method. According to the SM 2540C method, a sample comprising an amount of liquid comprising one or more dissolved solids is filtered (e.g., through a glass fiber filter), and the filtrate is evaporated to dryness in a weighed dish at 180° C. The increase in dish weight represents the mass of the total dissolved solids in the sample. The salinity of the sample may be obtained by dividing the mass of the total dissolved solids by the mass of the original sample and multiplying the resultant number by 100.

According to some embodiments, the humidifier described above is a bubble column humidifier (e.g., a humidifier in which the evaporation process occurs through direct contact between an aqueous stream and bubbles of a carrier gas). As discussed in further detail below, a bubble column humidifier may be associated with certain advantages. In some embodiments, the humidifier is a packed bed humidifier (e.g., a humidifier comprising packing material). The packing material may, in some cases, facilitate turbulent gas flow and/or enhance contact between an aqueous stream flowing in a first direction through the packing material and a carrier gas flowing in a second, substantially opposite direction. A non-limiting example of suitable packing material is polyvinyl chloride (PVC) packing material. In certain cases, the humidifier is a spray tower (e.g., a humidifier configured to spray droplets of an aqueous stream). For example, a nozzle or other spraying device may be positioned at the top of the humidifier such that the aqueous stream is sprayed downward towards the bottom of the humidifier. The use of a spraying device may advantageously increase the degree of contact between an aqueous stream fed to the humidifier and a carrier gas into which water from the aqueous stream is transported. The humidifier may, in some embodiments, be a packed bed humidifier and a spray tower (e.g., the spray tower may comprise packing material). In some embodiments, the humidifier is a wetted wall tower (e.g., a humidifier in which the evaporation process occurs through direct contact between a fluid film or laminar layer and a carrier gas).

In some embodiments, the humidifier is configured to be a counter-flow device. For example, in certain cases, the humidifier is configured such that a humidifier liquid inlet is positioned at a first end (e.g., a top end) of the humidifier and a humidifier gas inlet is positioned at a second, opposite end (e.g., a bottom end) of the humidifier. Such a configuration may facilitate the flow of a liquid stream in a first direction (e.g., downwards) through the humidifier and the flow of a gas stream in a second, substantially opposite direction (e.g., upwards) through the humidifier, which may advantageously result in high thermal efficiency.

In some embodiments, in which a humidification-dehumidification (HDH) apparatus comprising a humidifier and a dehumidifier as described above is used, the dehumidifier of the HDH apparatus may have any configuration that allows for the transfer of water from a humidified gas stream produced by a humidifier to a substantially pure water stream through a condensation process. In some embodiments, the dehumidifier comprises a gas inlet configured to receive the humidified gas stream from the humidifier and/or a liquid inlet configured to receive a substantially pure water stream (e.g., from a source of substantially pure water). The dehumidifier may further comprise a dehumidifier liquid outlet and/or a dehumidifier gas outlet.

In certain embodiments, the dehumidifier is a bubble column dehumidifier (e.g., a dehumidifier in which the condensation process occurs through direct contact between a substantially pure water stream and bubbles of a humidified gas). In certain cases, the dehumidifier is a surface condenser (e.g., a dehumidifier in which the condensation process occurs through direct contact between a humidified gas and a cooled surface). Non-limiting examples of suitable surface condensers include a cooling tube condenser and a plate condenser.

In some embodiments, the dehumidifier is configured to be a counter-flow device. For example, in certain cases, the dehumidifier is configured such that a dehumidifier liquid inlet is positioned at a first end (e.g., a top end) of the dehumidifier and a dehumidifier gas inlet is positioned at a second, opposite end (e.g., a bottom end) of the dehumidifier. Such a configuration may facilitate the flow of a liquid stream in a first direction (e.g., downwards) through the dehumidifier and the flow of a gas stream in a second, substantially opposite direction (e.g., upwards) through the dehumidifier, which may advantageously result in high thermal efficiency.

According to some embodiments, the humidifier is a bubble column humidifier, and/or the dehumidifier is a bubble column dehumidifier. In some cases, bubble column humidifiers and bubble column dehumidifiers may be associated with certain advantages. For example, bubble column humidifiers and dehumidifiers may exhibit higher thermodynamic effectiveness than certain other types of humidifiers and dehumidifiers. Without wishing to be bound by a particular theory, the increased thermodynamic effectiveness may be at least partially attributed to the use of gas bubbles for heat and mass transfer in bubble column humidifiers and dehumidifiers, since gas bubbles may have more surface area available for heat and mass transfer than many other types of surfaces (e.g., metallic tubes, liquid films, packing material). In addition, bubble column humidifiers and dehumidifiers may have certain features that further increase thermodynamic effectiveness, including, but not limited to, relatively low liquid level height, relatively high aspect ratio liquid flow paths, and multi-staged designs.

Suitable bubble column condensers that may be used as the dehumidifier and/or suitable bubble column humidifiers that may be used as the humidifier in certain systems and methods described herein include those described in U.S. Pat. No. 8,523,985, by Govindan et al., issued Sep. 3, 2013, and entitled “Bubble-Column Vapor Mixture Condenser”; U.S. Pat. No. 8,778,065, by Govindan et al., issued Jul. 15, 2014, and entitled “Humidification-Dehumidification System Including a Bubble-Column Vapor Mixture Condenser”; U.S. Patent Publication No. 2013/0074694, by Govindan et al., filed Sep. 23, 2011, and entitled “Bubble-Column Vapor Mixture Condenser”; U.S. Patent Publication No. 2014/0367871, by Govindan et al., filed Jun. 12, 2013, and entitled “Multi-Stage Bubble Column Humidifier”; U.S. Patent Publication No. 2015/0083577, filed on Sep. 23, 2014, and entitled “Desalination Systems and Associated Methods”; U.S. Patent Publication No. 2015/0129410, filed on Sep. 12, 2014, and entitled “Systems Including a Condensing Apparatus Such as a Bubble Column Condenser”; U.S. patent application Ser. No. 14/718,483, by Govindan et al., filed May 21, 2015, and entitled “Systems Including an Apparatus Comprising both a Humidification Region and a Dehumidification Region”; U.S. patent application Ser. No. 14/718,510, by Govindan et a., filed May 21, 2015, and entitled “Systems Including an Apparatus Comprising both a Humidification Region and a Dehumidification Region with Heat Recovery and/or Intermediate Injection”; U.S. patent application Ser. No. 14/719,239, by Govindan et al., filed May 21, 2015, and entitled “Transiently-Operated Desalination Systems and Associated Methods”; U.S. patent application Ser. No. 14/719,189, by Govindan et al., filed May 21, 2015, and entitled “Transiently-Operated Desalination Systems with Heat Recovery and Associated Methods”; U.S. patent application Ser. No. 14/719,295, by St. John et al., filed May 21, 2015, and entitled “Methods and Systems for Producing Treated Brines”; and U.S. patent application Ser. No. 14/719,299, by St. John et al., and entitled “Methods and Systems for Producing Treated Brines for Desalination,” each of which is incorporated herein by reference in its entirety for all purposes.

In some embodiments in which substantially pure water is formed, the substantially pure water stream has a relatively low total solubilized ion concentration (e.g., concentration of all solubilized ions present in the water stream). In some cases, the total solubilized ion concentration of the substantially pure water stream is about 500 mg/L or less, about 200 mg/L or less, about 100 mg/L or less, about 50 mg/L or less, about 20 mg/L or less, about 10 mg/L or less, about 5 mg/L or less, about 2 mg/L or less, about 1 mg/L or less, about 0.5 mg/L or less, about 0.2 mg/L or less, about 0.1 mg/L or less, about 0.05 mg/L or less, about 0.02 mg/L or less, or about 0.01 mg/L or less. According to some embodiments, the total solubilized ion concentration of the substantially pure water stream is substantially zero (e.g., not detectable). In certain cases, the total solubilized ion concentration of the substantially pure water stream is in the range of about 0 mg/L to about 500 mg/L, about 0 mg/L to about 200 mg/L, about 0 mg/L to about 100 mg/L, about 0 mg/L to about 50 mg/L, about 0 mg/L to about 20 mg/L, about 0 mg/L to about 10 mg/L, about 0 mg/L to about 5 mg/L, about 0 mg/L to about 2 mg/L, about 0 mg/L to about 1 mg/L, about 0 mg/L to about 0.5 mg/L, about 0 mg/L to about 0.1 mg/L, about 0 mg/L to about 0.05 mg/L, about 0 mg/L to about 0.02 mg/L, or about 0 mg/L to about 0.01 mg/L.

As used herein, two elements are in fluidic communication with each other (or, equivalently, in fluid communication with each other) when fluid may be transported from one of the elements to the other of the elements without otherwise altering the configurations of the elements or a configuration of an element between them (such as a valve). Two conduits connected by an open valve (thus allowing for the flow of fluid between the two conduits) are considered to be in fluidic communication with each other. In contrast, two conduits separated by a closed valve (thus preventing the flow of fluid between the conduits) are not considered to be in fluidic communication with each other.

As used herein, two elements are fluidically connected to each other when they are connected such that, under at least one configuration of the elements and any intervening elements, the two elements are in fluidic communication with each other. Two membrane separators connected by a valve and conduits that permit flow between the membrane separators in at least one configuration of the valve would be said to be fluidically connected to each other. To further illustrate, two membrane separators that are connected by a valve and conduits that permit flow between the membrane separators in a first valve configuration but not a second valve configuration are considered to be fluidically connected to each other both when the valve is in the first configuration and when the valve is in the second configuration. In contrast, two membrane separators that are not connected to each other (e.g., by a valve, another conduit, or another component) in a way that would permit fluid to be transported between them under any configuration would not be said to be fluidically connected to each other. Elements that are in fluidic communication with each other are always fluidically connected to each other, but not all elements that are fluidically connected to each other are necessarily in fluidic communication with each other.

Various components are described herein as being fluidically connected. Fluidic connections may be either direct fluidic connections or indirect fluidic connections. Generally, a direct fluidic connection exists between a first region and a second region (and the two regions are said to be directly fluidically connected to each other) when they are fluidically connected to each other and when the composition of the fluid at the second region of the fluidic connection has not substantially changed relative to the composition of the fluid at the first region of the fluidic connection (i.e., no fluid component that was present in the first region of the fluidic connection is present in a weight percentage in the second region of the fluidic connection that is more than 5% different from the weight percentage of that component in the first region of the fluidic connection). As an illustrative example, a stream that connects first and second unit operations, and in which the pressure and temperature of the fluid is adjusted but the composition of the fluid is not altered, would be said to directly fluidically connect the first and second unit operations. If, on the other hand, a separation step is performed and/or a chemical reaction is performed that substantially alters the composition of the stream contents during passage from the first component to the second component, the stream would not be said to directly fluidically connect the first and second unit operations. In some embodiments, a direct fluidic connection between a first region and a second region can be configured such that the fluid does not undergo a phase change from the first region to the second region. In some embodiments, the direct fluidic connection can be configured such that at least 50 wt % (or at least 75 wt %, at least 90 wt %, at least 95 wt %, or at least 98 wt %) of the fluid (e.g., liquid) in the first region is transported to the second region via the direct fluidic connection. Any of the fluidic connections described herein may be, in some embodiments, direct fluidic connections. In other cases, the fluidic connections may be indirect fluidic connections.

In some embodiments, the feed stream transported to the lithium recovery system initially comprises one or more boron-containing species (e.g., as an impurity). In some such embodiments, the feed stream is treated such that at least some (e.g., at least 5 wt %, at least 10 wt % at least 25 wt %, at least 50 wt %, at least 75 wt %, at least 90 wt %, at least 95 wt %, at least 98 wt %, at least 99 wt %, at least 99.9 wt %, or all) of the boron-containing species initially present in the feed stream are removed. This removal of boron-containing species may occur prior to the liquid removal steps described below. In some embodiments, the concentration of dissolved boron-containing species in the feed stream is decreased via boron-containing species removal by at least 5 wt %, at least 10 wt % at least 25 wt %, at least 50 wt %, at least 75 wt %, at least 90 wt %, at least 95 wt %, at least 98 wt %, at least 99 wt %, at least 99.9 wt %, or 100 wt % relative to its initial concentration prior to boron-species removal.

In some embodiments, the concentrated stream describe below comprises one or more boron-containing species (e.g., as an impurity). In some such embodiments, the concentrated stream is treated such that at least some (e.g., at least 5 wt %, at least 10 wt % at least 25 wt %, at least 50 wt %, at least 75 wt %, at least 90 wt %, at least 95 wt %, at least 98 wt %, at least 99 wt %, at least 99.9 wt %, or all) of the boron-containing species initially present in the concentrated stream are removed. This removal of boron-containing species may occur prior to, during, and/or after other impurity removal steps described in this disclosure (e.g., removal of non-lithium cations). In some embodiments, the concentration of dissolved boron-containing species in the concentrated stream is decreased via boron-containing species removal by at least 5 wt %, at least 10 wt % at least 25 wt %, at least 50 wt %, at least 75 wt %, at least 90 wt %, at least 95 wt %, at least 98 wt %, at least 99 wt %, at least 99.9 wt %, or 100 wt % relative to its initial concentration prior to boron-species removal.

Non-limiting examples of boron-containing species that may be present (and may be removed) in the feed stream and/or the concentrated stream include non-ionic species (e.g., boric acid (H₃BO₃)) and/or ionic species (e.g., tetrahydroxyborate (B(OH)₄⁻).

Any of a variety of techniques may be employed to remove the boron-containing species. For example, the feed stream and/or concentrated stream may be exposed to a boron-selective medium. FIG. 13A shows a schematic diagram of lithium recovery system 100 in which boron-selective medium 145 is configured to treat feed stream 104 by being exposed to feed stream portion 104A and removing at least some boron-containing species, thereby producing feed stream portion 104B (at least a portion of which may form some or all of first membrane separator retentate inlet stream 105). Feed stream portion 104B may have a lower concentration of boron-containing species than feed stream portion 104A (e.g., by at least 25%, at least 50%, at least 75%, at least 90%, at least 95%, at least 98%, at least 99%, or more on a mass basis) or may be free of boron-containing species. A portion of the boron-selective medium (e.g., an outlet) may be fluidically connected to the retentate side of the first membrane separator.

FIG. 13B shows a schematic diagram of lithium recovery system 100 in which boron-selective medium 145 is configured to treat concentrated stream 108 by being exposed to feed stream portion 108A and removing at least some boron-containing species, thereby producing concentrated stream portion 104B (at least a portion of which may form some or all of impurity-depleted stream 124). Concentrated stream portion 108B may have a lower concentration of boron-containing species than concentrated stream portion 108A (e.g., by at least 25%, at least 50%, at least 75%, at least 90%, at least 95%, at least 98%, at least 99%, or more on a mass basis) or may be free of boron-containing species. A portion of the boron-selective medium (e.g., an inlet) may be fluidically connected to the retentate side of the first membrane separator (or second membrane separator or third membrane separator or to a portion of a humidifier if present).

The boron-selective medium may be, for example, a boron-selective membrane. As another example, the boron-selective medium may be a boron-selective resin. For example, the boron-selective medium may be a boron-selective ion exchange medium such as a boron-selective ion exchange membrane and/or ion exchange resin. Boron-containing species may bind to at least a portion of the boron-selective medium (e.g., a boron-selective membrane and/or resin). The binding may occur through chelation, adsorption, and/or any other suitable mechanism. The boron-selective medium may, in some cases, comprise N-methylglucamine functional groups and/or benzyl-dimethylethanolamine functional groups.

Non-limiting examples of techniques for removing boron-containing species from liquids (e.g., water) are described in U.S. Patent Application Publication No. 2020/0231473, published on Jul. 23, 2020, and entitled, “Systems and Methods for Removal of Boron from Water, Such as Oilfield Wastewater,” which is incorporated herein in its entirety.

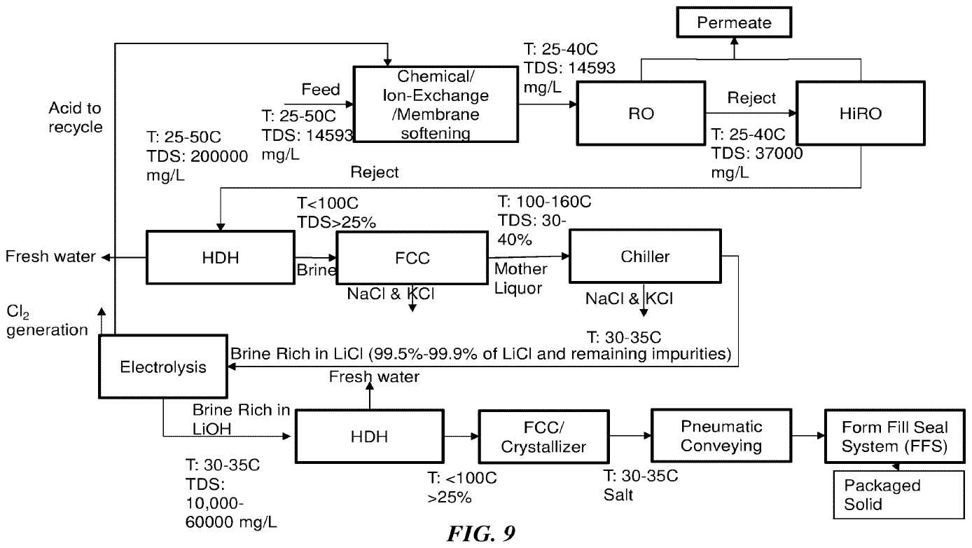

In one example embodiment, lithium hydroxide is obtained from a brine (e.g., a salar brine) rich in solubilized lithium cations and solubilized chloride anions using methods and systems described in this disclosure. FIG. 9 shows a schematic process diagram for the solid lithium hydroxide recovery. A feed stream first undergoes a softening process, in which scale-forming ions (e.g., multivalent cations, silica) are removed using one or more of chemical treatment (e.g., with lime, dolomite, activated alumina, iron chloride, sodium hypochlorite, and/or polymers (e.g., polyelectrolytes) while in some instances maintaining a pH from 8 to 8.5), ion exchange or membrane softening (e.g., nanofiltration or electrodialysis). Prior to the softening, the feed stream may be at a temperature in the range of 25 to 50° C., a pH in the range of 2-14, and have a total dissolved solids concentration of 14593 mg/L (including a lithium cation concentration of from 10 mg/L to 680 mg/L). Following the softening, the feed stream has a temperature in the range of from 25 to 40° C. (e.g., 25 to 36° C.), a pH of approximately 5.5, and a total dissolved solids concentration (TDS) of 14593 mg/L. The feed stream is then fed to the retentate side of a first membrane separator (“RO”) at a flow rate of approximately 2.5 m³/hr and a hydraulic pressure is applied to perform a reverse osmosis process. The reject of the first membrane separator is then fed to the retentate side of a second membrane separator (a high permeability reverse osmosis unit, “HiRO”) at a flow rate of approximately 1.3 m³/hr. The reject fed to HiRO has a temperature in the range of from 25 to 40° C. (e.g., 25 to 36° C.), and a total dissolved solids concentration of 37,000 mg/L. The permeate from both RO (having a total dissolved solids concentration of less than 500 mg/L) and HiRO can be discharged from the system (as shown in FIG. 9), though in some instances the permeate from the HiRO can be recycled back to the retentate inlet stream of the RO or the HiRO. The reject from HiRO has a temperature in the range of from 25 to 50° C. (e.g., 25 to 40° C. or 25 to 36° C.) and a total dissolved solids concentration of 200,000 mg/L. The reject from the HiRO is fed to an HDH apparatus (“HDH”) comprising a packed bed humidifier and a multi-stage bubble column dehumidifier. The HDH produces fresh water (which can be discharged from the system) and a brine having a temperature less than 100° C. and a total dissolved solids concentration of 250,000 mg/L. The brine from the HDH is fed to a forced circulation evaporator (FCC), where non-lithium salts separation takes place. In FCC, the brine is heated under atmospheric pressure until it starts to boil, and continued boiling at temperatures reaching from 100° C. to 160° C. while circulating the brine results in the precipitation of mixtures of potassium and sodium chloride. The resulting mother liquor from FCC, which has a total dissolved solids concentration of 300,000-400,000 mg/L, is fed to a chiller (e.g., part of a crystallizer). In the chiller, the temperature is reduced to 30-35° C. and further precipitation of NaCl and KCl occurs while maintaining a substantially same amount of solubilized lithium ions in the mother liquor. The precipitates are separated from the mother liquor (e.g., by decantation). Additional lithium cations may be recovered by washing the precipitates with a small quantity of feed water and sending that quantity of feed water back to the feed stream. The precipitates may be sent for further processing, such as via a centrifuge/agitated thin film dryer crystallizer to obtain solid NaCl and KCl having low moisture. The lithium-rich mother liquor/supernatant from the FCC/chiller is fed to an electrolysis unit. In the electrolysis unit, Cl₂ and acid is generated. The Cl₂ is discharged from the system, and the acid may be recycled back for use in the softening process for the feed stream. The electrolysis unit produces a brine rich in LiOH, at a temperature in the range of from 30° C. to 35° C. and a total dissolved solids concentration of 10,000-60,000 mg/L. The brine rich in LiOH is transferred from the electrolysis unit to a second HDH unit, where it is further concentrated in a humidifier (while the dehumidifier produces fresh water). The further concentrated brine rich in LiOH, which in some instances may have a total dissolved salts concentration of greater than 250,000 mg/L, is transferred to another FCC/crystallizer, where solid LiOH salt is produced. The solid LiOH salt may then undergo pneumatic conveying and packaging in a form fill seal system.

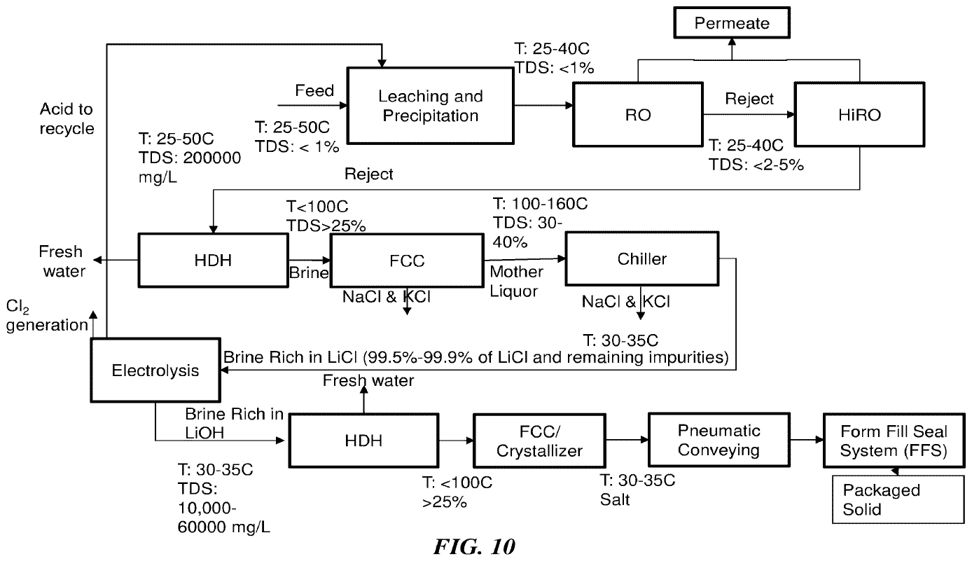

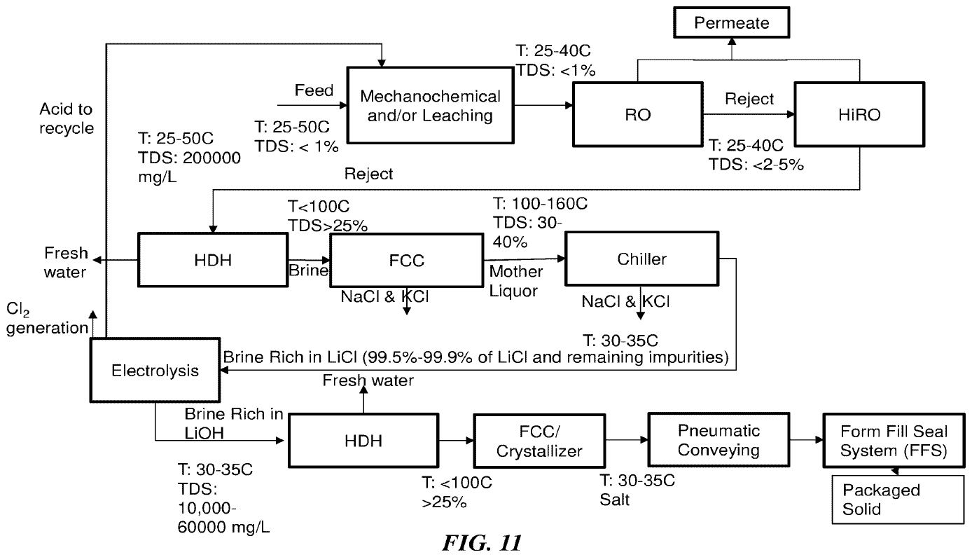

In another example embodiment, solid lithium hydroxide is obtained from a solution rich in solubilized lithium cations and solubilized sulfate and carbonate anions using methods and systems described in this disclosure. FIG. 10 shows a schematic process diagram for the solid lithium hydroxide recovery. A feed stream first undergoes a leaching and precipitation process, during which the sulfate and carbonate anions are replaced via chemically-induced precipitation and/or leaching, and chloride anions remain and/or are added. Prior to the leaching and precipitation, the feed stream may be at a temperature in the range of 25 to 50° C., a pH in the range of 2-14, and have a total dissolved solids concentration of <1%. Following the leaching and precipitation, the feed stream has a temperature in the range of from 25 to 40° C. (e.g., 25 to 36° C.), a pH of approximately 5.5, and a total dissolved solids concentration of <1%. The feed stream is then fed to the retentate side of a first membrane separator (“RO”) at a flow rate of approximately 2.5 m³/hr and a hydraulic pressure is applied to perform a reverse osmosis process. The reject of the first membrane separator is then fed to the retentate side of a second membrane separator (a high permeability reverse osmosis unit, “HiRO”) at a flow rate of approximately 1.3 m³/hr. The reject fed to HiRO has a temperature in the range of from 25 to 40° C. (e.g., 25 to 36° C.), and a total dissolved solids concentration of <2-5%. The permeate from both RO (having a total dissolved solids concentration of less than 500 mg/L) and HiRO can discharged from the system (as shown in FIG. 10), though in some instances the permeate from the HiRO can be recycled back to the retentate inlet stream of the RO or the HiRO. The reject from HiRO has a temperature in the range of from 25 to 50° C. (e.g., 25 to 40° C. or 25 to 36° C.) and a total dissolved solids concentration of 200,000 mg/L. The remainder of the process shown in this example, as shown in FIG. 10, is the same as that shown in FIG. 9 and described above.

In another example embodiment, solid lithium hydroxide is obtained from a solution derived from lithium ion batteries (e.g., discarded/spent lithium ion batteries) using methods and systems described in this disclosure. FIG. 11 shows a schematic process diagram for the solid lithium hydroxide recovery. A feed stream supplied directly or indirectly from one or more lithium ion batteries first undergoes a mechanochemical and/or leaching process (e.g., via addition of hydrochloric acid, sulfuric acid, nitric acid, acetic acid, and/or citric acid), and chloride anions remain and/or are added. Prior to the mechanochemical and/or leaching processes, the feed stream may be at a temperature in the range of 25 to 50° C. (e.g., 25 to 40° C. or 25 to 36° C.), a pH in the range of 2-14, and have a total dissolved solids concentration of <1%. Following the mechanochemical and/or leaching processes, the feed stream has a temperature in the range of from 25 to 40° C. (e.g., 25 to 36° C.), a pH of approximately 5.5, and a total dissolved solids concentration of <1%. The feed stream is then fed to the retentate side of a first membrane separator (“RO”) at a flow rate of approximately 2.5 m³/hr and a hydraulic pressure is applied to perform a reverse osmosis process. The reject of the first membrane separator is then fed to the retentate side of a second membrane separator (a high permeability reverse osmosis unit, “HiRO”) at a flow rate of approximately 1.3 m³/hr. The reject fed to HiRO has a temperature in the range of from 25 to 40° C. (e.g., 25 to 36° C.), and a total dissolved solids concentration of <2-5%. The permeate from both RO (having a total dissolved solids concentration of less than 500 mg/L) and HiRO can discharged from the system (as shown in FIG. 11), though in some instances the permeate from the HiRO can be recycled back to the retentate inlet stream of the RO or the HiRO. The reject from HiRO has a temperature in the range of from 25 to 50° C. (e.g., 25 to 40° C. or 25 to 36° C.) and a total dissolved solids concentration of 200,000 mg/L. The remainder of the process shown in this example, as shown in FIG. 11, is the same as that shown in FIG. 9 and described above.

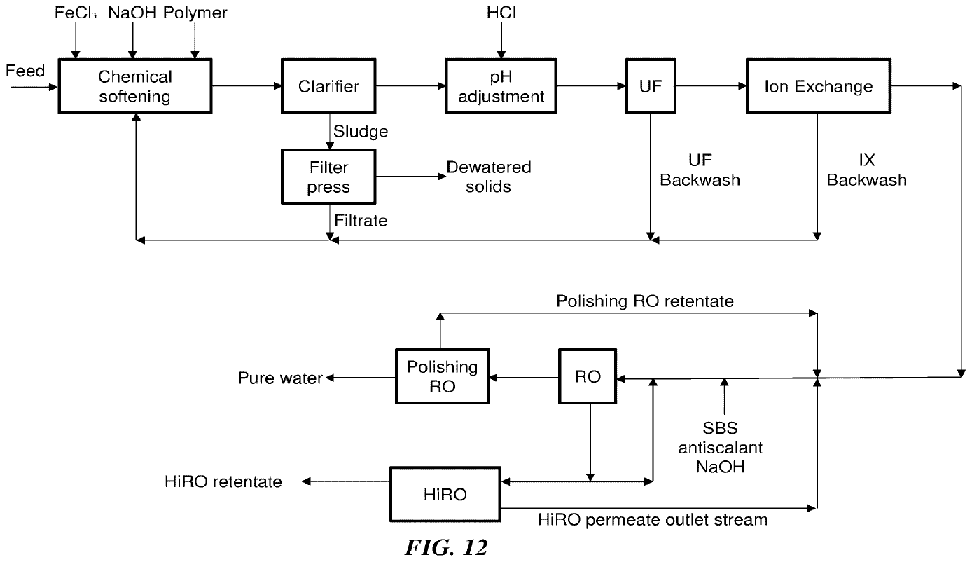

In another example embodiment, a lithium-containing stream (e.g., comprising solubilized lithium cations in an amount of at least 10 mg/L) is concentrated using methods described in this disclosure. FIG. 12 shows a schematic process diagram for such a lithium ion concentration process. A feed stream first undergoes a softening process in which scale-forming ions (e.g., multivalent cations, silica) are removed using chemical treatment, clarification, multi-media filtration, and ion exchange. Ferric chloride (FeCl₃), sodium hydroxide (NaOH) and a polymer flocculant are added to the feed stream in a series of continuously stirred-tank reactors (“Chemical Softening” in FIG. 12) to cause precipitation of hardness and facilitate flocculation. Flocculated precipitate (“sludge” in FIG. 12) is settled from the feed stream in a clarifier, and a clarified supernatant stream is removed. The clarified supernatant is pH adjusted with the addition of hydrochloric acid (HCl), ultrafiltered (“UF” in FIG. 12), and introduced to an ion exchange column containing a strong acid cation resin for additional hardness removal to produce a softened feed stream. Flocculated precipitate settled from the supernatant in the clarifier (“sludge”) is dewatered in a filter press, and the resulting dewatered solids are discharged from the system. Backwash waste from the ultrafilters (“UF Backwash” in FIG. 12) and ion exchange regeneration (“IX” Backwash” in FIG. 12) are combined with filter press filtrate and recycled back to the chemical softening process where they are combined with the feed stream. The softened feed stream is treated with sodium bisulfate (“SBS”), antiscalant, and sodium hydroxide, pumped through a cartridge filter, combined with a portion of an RO reject stream to form an RO inlet stream, pressurized to 7.5 MPa, and introduced to a the retentate side of a first membrane separator (“RO” in FIG. 12). The hydraulic pressure on the retentate side of the RO membrane overcomes the osmotic pressure of the RO inlet stream, causing an RO permeate stream to diffuse through the RO membrane leaving behind the RO retentate stream. The RO permeate stream is pressurized again and introduced to the retentate side of a second membrane separator (“polishing RO” in FIG. 12). The hydraulic pressure on the retentate side of the polishing RO overcomes the osmotic pressure of the RO permeate stream, causing a polishing RO permeate stream, comprised of substantially pure water, to diffuse through the polishing RO membrane, leaving behind a polishing RO retentate stream. The polishing RO permeate stream is delivered to a customer as a final product, and the polishing RO retentate stream is combined with the softened feed stream. A portion of the RO retentate stream is combined with the softened feed stream to form the RO inlet stream, and the remainder is introduced to the retentate side of a third membrane separator that is a high permeability reverse osmosis unit (“HiRO” in FIG. 12) as an HiRO retentate inlet stream. The HiRO system contains multiple (e.g., at least 2, at least 5, at least 10, or more) membranes arranged with their retentate and permeate sides connected in series. The hydraulic pressure difference across each of the HiRO membranes overcomes the osmotic pressure difference, and water and at least some solute diffuse across the membranes from the HiRO retentate stream to form an HiRO permeate outlet stream, leaving behind an HiRO retentate outlet stream. The HiRO retentate outlet stream is depressurized, and a first portion of the stream is discharged from the system.

International Patent Application Publication No. WO2022/203706, published on Sep. 29, 2022, filed as International Patent Application No. PCT/US2021/47614 on Aug. 25, 2021, and entitled “Lithium Recovery from Liquid Streams,” is incorporated herein by reference in its entirety for all purposes. U.S. Patent Application Publication No. 2023-0001355, published on Jan. 5, 2023, filed as U.S. patent application Ser. No. 17/305,289, on Jul. 2, 2021, and entitled “Membranes with Controlled Porosity for Serial Filtration,” is incorporated herein by reference in its entirety for all purposes. U.S. Provisional Patent Application No. 63/411,079, filed on Sep. 28, 2022, under Attorney Docket No. G0859.70055US01, and entitled “Liquid Separation Using Solute-Permeable Membranes and Related Systems,” is incorporated herein by reference in its entirety for all purposes. U.S. patent application Ser. No. 18/315,130, filed on May 10, 2023, and entitled “Liquid Separation Using Solute-Permeable Membranes and Related Systems,” is incorporated herein by reference in its entirety for all purposes.

U.S. Provisional Patent Application No. 63/411,075, filed Sep. 28, 2022, and entitled “Lithium Recovery from Liquid Streams Using Solute-Permeable Membranes,” is incorporated herein by reference in its entirety for all purposes.

The following examples are intended to illustrate certain embodiments of the present invention, but do not exemplify the full scope of the invention.

### Example 1

This Example describes the concentration of lithium-containing streams having various salinities and solubilized lithium cation concentrations using a membrane separator comprising a semi-permeable membrane having a relatively high solute and water permeability (referred to as a “HiRO” unit in this example).

A synthetic brine rich with lithium cations having the concentrations listed in Table 1 having a salinity of approximately 7.5% was prepared to mimic a feed stream's properties following an initial concentration using a conventional high-rejection reverse osmosis (RO) unit. The concentrations were determined using mass spectrometry.

TABLE 1
Properties of initial feed brine fed to HiRO unit.

| | Feed Water | |
|---|---|---|
| Parameter | Quality | Units |
| Cl | 61500 | ppm |
| Li | 10400 | ppm |
| K | 147 | ppm |
| Na | 4210 | ppm |
| SO₄ | 559 | ppm |
| TDS | 76816 | ppm |

The brine was pressurized to 1000 psi (6,895 kPa) and fed to a HiRO unit prepared according to the methods described in U.S. patent application Ser. No. 17/305,289, producing a concentrate stream exiting the retentate side of the HiRO and a permeate stream exiting the permeate side of the HiRO. The concentrate stream and permeate streams had the following properties as determined via mass balance shown in Table 2 and Table 3, respectively.

TABLE 2
Properties of concentrate stream formed via treatment
of the initial 7.5% feed brine via the HiRO unit.

| | Concentrate Water | |
|---|---|---|
| Parameter | Quality | Units |
| Cl | 64951 | ppm |
| Li | 10944 | ppm |
| K | 147 | ppm |
| Na | 4462 | ppm |
| SO₄ | 634 | ppm |
| TDS | 81138 | ppm |

TABLE 3
Properties of permeate stream formed via treatment
of the initial 7.5% feed brine via the HiRO unit.

| | Permeate Water | |
|---|---|---|
| Parameter | Quality | Unit |
| Cl | 37000 | ppm |
| Li | 6540 | ppm |
| K | 148 | ppm |
| Na | 2420 | ppm |
| SO₄ | 27.7 | ppm |
| TDS | 46135.7 | ppm |

Identical experiments were performed at salinities of 10%, 12.5%, 15%, 17% and 20%, with each trial performed with the same ratio of constituent ions, to approximate the gradual concentration across the retentate sides of a multi-stage HiRO system. The results of the final concentrate properties following treatment of the 20% brine by the HiRO unit are shown in Table 4.

TABLE 4
Properties of concentrate stream formed via treatment
of the initial 20% feed brine via the HiRO unit.

| | Concentrate Water | |
|---|---|---|
| Parameter | Quality | Units |
| Cl | 175536 | ppm |
| Li | 30352 | ppm |
| K | 613 | ppm |
| Na | 11975 | ppm |
| SO₄ | 1824 | ppm |
| TDS | 220299 | ppm |

The experiments in this Example demonstrate that membrane separators with relatively high permeabilities that allow a portion of solubilized lithium cations to pass through their semi-permeable membrane(s) can be used to effectively concentrate lithium in lithium-rich feed streams having relatively high total salinities while using relatively modest applied hydraulic pressures.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

As used herein in the specification and in the claims, the phrase “at least a portion” means some or all. “At least a portion” may mean, in accordance with certain embodiments, at least 1 wt %, at least 2 wt %, at least 5 wt %, at least 10 wt %, at least 25 wt %, at least 50 wt %, at least 75 wt %, at least 90 wt %, at least 95 wt %, or at least 99 wt %, and/or, in certain embodiments, up to 100 wt %.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A method, comprising:
removing at least a portion of liquid from a feed stream comprising the liquid, solubilized lithium cations, and solubilized non-lithium cations, to form a concentrated stream having a higher concentration of solubilized lithium cations compared to the feed stream, wherein the removing comprises:
(a) transporting a first membrane separator retentate inlet stream comprising at least a portion of the feed stream to a retentate side of a first membrane separator such that:
a first membrane separator retentate outlet stream exits the retentate side of the first membrane separator, the first membrane separator retentate outlet stream having a concentration of solubilized lithium cations that is greater than a concentration of solubilized lithium cations in the first membrane separator retentate inlet stream, and
at least a portion of liquid from the first membrane separator retentate inlet stream is transported from the retentate side of the first membrane separator, through a semi-permeable membrane of the first membrane separator, to a permeate side of the first membrane separator;
(b) transporting a second membrane separator retentate inlet stream comprising at least a portion of the first membrane separator retentate outlet stream to a retentate side of a second membrane separator such that:
a second membrane separator retentate outlet stream exits the retentate side of the second membrane separator, the second membrane separator retentate outlet stream having a concentration of solubilized lithium cations that is greater than a concentration of solubilized lithium cations in the second membrane separator retentate inlet stream, and
at least a portion of liquid, at least a portion of solubilized lithium cations, and at least a portion of solubilized non-lithium cations from the second membrane separator retentate inlet stream are transported from the retentate side of the second membrane separator, through a semi-permeable membrane of the second membrane separator, to a permeate side of the second membrane separator; and
(c) transporting a humidifier liquid inlet stream comprising at least a portion of the second membrane separator retentate outlet stream to a humidifier and allowing at least a portion of liquid of the humidifier liquid inlet stream to evaporate within the humidifier to produce a humidified gas stream and a humidifier liquid outlet stream having a higher concentration of solubilized lithium cations compared to the humidifier liquid inlet stream, such that at least a portion of the humidifier liquid outlet stream is part of the concentrated stream; and
removing at least some of the solubilized non-lithium cations from the concentrated stream to form an impurity-depleted concentrated steam having an atomic ratio of solubilized lithium cations to solubilized non-lithium cations that is larger than an atomic ratio of solubilized lithium cations to solubilized non-lithium cations in the concentrated stream.

2. A method, comprising:
removing at least a portion of liquid from a feed stream comprising the liquid, solubilized lithium cations, and solubilized non-lithium cations, to form a concentrated stream having a higher concentration of solubilized lithium cations compared to the feed stream, wherein the removing comprises:
(a) transporting a first membrane separator retentate inlet stream to a retentate side of a first membrane separator such that:
a first membrane separator retentate outlet stream exits the retentate side of the first membrane separator, the first membrane separator retentate outlet stream having a concentration of solubilized lithium cations that is greater than a concentration of solubilized lithium cations in the first membrane separator retentate inlet stream, and
at least a portion of liquid from the first membrane separator retentate inlet stream is transported from the retentate side of the first membrane separator, through a semi-permeable membrane of the first membrane separator, to a permeate side of the first membrane separator;
(b) transporting a second membrane separator retentate inlet stream comprising at least a portion of the first membrane separator retentate outlet stream to a retentate side of a second membrane separator such that:
a second membrane separator retentate outlet stream exits the retentate side of the second membrane separator, the second membrane separator retentate outlet stream having a concentration of solubilized lithium cations that is greater than a concentration of solubilized lithium cations in the second membrane separator retentate inlet stream, and
at least a portion of liquid, at least a portion of solubilized lithium cations, and at least a portion of solubilized non-lithium cations from the second membrane separator retentate inlet stream are transported from the retentate side of the second membrane separator, through a semi-permeable membrane of the second membrane separator, to a permeate side of the second membrane separator where the portion of the liquid, portion of solubilized lithium cations, and portion of solubilized non-lithium cations form some or all of a second membrane separator permeate outlet stream that is transported out of the permeate side of the second membrane separator;
(c) transporting a third membrane separator retentate inlet stream comprising at least a portion of the second membrane separator retentate outlet stream to a retentate side of a third membrane separator such that:
a third membrane separator retentate outlet stream exits the retentate side of the third membrane separator, the third membrane separator retentate outlet stream having a concentration of solubilized lithium cations that is greater than a concentration of solubilized lithium cations of the third membrane separator retentate inlet stream, and
at least a portion of liquid, at least a portion of solubilized lithium, and at least a portion of solubilized non-lithium cations from the third membrane separator retentate inlet stream are transported from the retentate side of the third membrane separator, through a semi-permeable membrane of the third membrane separator, to a permeate side of the third membrane separator where the portion of the liquid, portion of solubilized lithium cations, and portion of solubilized non-lithium cations form some or all of a third membrane separator permeate outlet stream that is transported out of the permeate side of the third membrane separator; and
(d) transporting a humidifier liquid inlet stream comprising at least a portion of the third membrane separator retentate outlet stream to a humidifier and allowing at least a portion of liquid of the humidifier liquid inlet stream to evaporate within the humidifier to produce a humidified gas stream and a humidifier liquid outlet stream having a higher concentration of solubilized lithium cations compared to the humidifier liquid inlet stream, such that at least a portion of the humidifier liquid outlet stream is part of the concentrated stream; and
removing at least some of the solubilized non-lithium cations from the concentrated stream to form an impurity-depleted concentrated steam having an atomic ratio of solubilized lithium cations to solubilized non-lithium cations that is larger than an atomic ratio of solubilized lithium cations to solubilized non-lithium cations in the concentrated stream;
wherein:
the first membrane separator retentate inlet stream comprises at least a portion of the second membrane separator permeate outlet stream and/or at least a portion of the third membrane separator permeate outlet stream; and
the second membrane separator retentate inlet stream and/or the third membrane separator retentate inlet stream comprises at least a portion of the feed stream.

3. A method, comprising:
removing at least a portion of liquid from a feed stream comprising a liquid and solubilized lithium cations to form a concentrated stream having a higher concentration of solubilized lithium cations compared to the feed stream, wherein the removing comprises:
transporting a first membrane separator retentate inlet stream comprising at least a portion of the feed stream to a retentate side of a first membrane separator such that:
a first membrane separator retentate outlet stream exits the retentate side of the first membrane separator, the first membrane separator retentate outlet stream having a concentration of solubilized lithium cations that is greater than a concentration of solubilized lithium cations in the first membrane separator retentate inlet stream, and
at least a portion of liquid from the first membrane separator retentate inlet stream is transported from the retentate side of the first membrane separator, through a semi-permeable membrane of the first membrane separator, to a permeate side of the first membrane separator; and
transporting a second membrane separator retentate inlet stream comprising at least a portion of the first membrane separator retentate outlet stream to a retentate side of a second membrane separator such that:
a second membrane separator retentate outlet stream exits the retentate side of the second membrane separator, the second membrane separator retentate outlet stream having a higher concentration of solubilized lithium cations than a concentration of solubilized lithium cations of the second membrane separator retentate inlet stream, such that at least a portion of the second membrane separator retentate outlet stream is part of the concentrated stream, and
at least a portion of liquid and at least a portion of solubilized lithium cations from the second membrane separator retentate inlet stream are transported from the retentate side of the second membrane separator, through a semi-permeable membrane of the second membrane separator, to a permeate side of the second membrane separator;
wherein:
a concentration of solubilized lithium cations in the feed stream is greater than or equal to 10 mg/L, and
a ratio of a concentration of solubilized lithium cations in the concentrated stream to the concentration of solubilized lithium cations in the feed stream is greater than or equal to 4.

4. A method, comprising:
removing at least a portion of liquid from a feed stream comprising a liquid and solubilized lithium cations to form a concentrated stream having a higher concentration of solubilized lithium cation compared to the feed stream, wherein the removing comprises:
transporting a first membrane separator retentate inlet stream to a retentate side of a first membrane separator such that:
a first membrane separator retentate outlet stream exits the retentate side of the first membrane separator, the first membrane separator retentate outlet stream having a concentration of solubilized lithium cations that is greater than a concentration of solubilized lithium cations in the first membrane separator retentate inlet stream, and
at least a portion of liquid from the first membrane separator retentate inlet stream is transported from the retentate side of the first membrane separator, through a semi-permeable membrane of the first membrane separator, to a permeate side of the first membrane separator;
transporting a second membrane separator retentate inlet stream comprising at least a portion of the first membrane separator retentate outlet stream to a retentate side of a second membrane separator such that:
a second membrane separator retentate outlet stream exits the retentate side of the second membrane separator, the second membrane separator retentate outlet stream having a higher concentration of solubilized lithium cations than a concentration of solubilized lithium cations of the second membrane separator retentate inlet stream, and
at least a portion of liquid and at least a portion of solubilized lithium cations from the second membrane separator retentate inlet stream are transported from the retentate side of the second membrane separator, through a semi-permeable membrane of the second membrane separator, to a permeate side of the second membrane separator where the portion of the liquid and the portion of solubilized lithium cations form some or all of a second membrane separator permeate outlet stream that is transported out of the permeate side of the second membrane separator; and
transporting a third membrane separator retentate inlet stream comprising at least a portion of the second membrane separator retentate outlet stream to a retentate side of a third membrane separator such that:
a third membrane separator retentate outlet stream exits the retentate side of the third membrane separator, the third membrane separator retentate outlet stream having a concentration of solubilized lithium cations that is greater than a concentration of solubilized lithium cations of the third membrane separator retentate inlet stream, such that at least a portion of the third membrane separator retentate outlet stream is part of the concentrated stream, and
at least a portion of liquid and at least a portion of solubilized lithium cations from the third membrane separator retentate inlet stream are transported from the retentate side of the third membrane separator, through a semi-permeable membrane of the third membrane separator, to a permeate side of the third membrane separator where the portion of the liquid and the portion of solubilized lithium cations form some or all of a third membrane separator permeate outlet stream that is transported out of the permeate side of the third membrane separator;
wherein:
the first membrane separator retentate inlet stream comprises at least a portion of the second membrane separator permeate outlet stream and/or at least a portion of the third membrane separator permeate outlet stream;
the second membrane separator retentate inlet stream and/or the third membrane separator retentate inlet stream comprises at least a portion of the feed stream;
a concentration of solubilized lithium cations in the feed stream is greater than or equal to 10 mg/L, and
a ratio of a concentration of solubilized lithium cations in the concentrated stream to the concentration of solubilized lithium cations in the feed stream is greater than or equal to 4.

5. The method of claim 3, wherein the first membrane separator retentate inlet stream comprises a portion of the first membrane separator retentate outlet stream.

6. The method of claim 3, wherein the portion of the liquid and the portion of solubilized lithium cations transported from the retentate side of the second membrane separator, through the semi-permeable membrane of the second membrane separator, to the permeate side of the second membrane separator form some or all of a second membrane separator permeate outlet stream.

7. (canceled)

8. The method of claim 3, wherein at least a portion of solubilized lithium cations from the first membrane separator retentate inlet stream are transported from the retentate side of the first membrane separator, through the semi-permeable membrane of the first membrane separator, to the permeate side of the first membrane separator.

9. The method of claim 3, wherein a solute permeability of the first membrane separator during the step of transporting the first membrane separator retentate inlet stream to the retentate side of the first membrane separator is different than a solute permeability of the second membrane separator during the step of transporting the second membrane separator retentate inlet stream to the retentate side of the second membrane separator.

10. (canceled)

11. The method of claim 3, wherein a salt passage percentage at standard conditions of the first membrane separator is different than a salt passage percentage at standard conditions of the second membrane separator, wherein the salt passage percentage at standard conditions is determined using ASTM D4516-19a.

12. (canceled)

13. The method of claim 3, wherein the second membrane separator has a salt passage percentage at standard conditions that is greater than that of the first membrane separator.

14. (canceled)

15. The method of claim 3, wherein the second membrane separator has a rejection for at least one solute on the retentate side that is less than that of the first membrane separator.

16. (canceled)

17. The method of claim 3, wherein the semi-permeable membrane of the second membrane separator has an average molecular weight cutoff (MWCO) that is greater than that of the semi-permeable membrane of the first membrane separator.

18-20. (canceled)

21. The method of claim 3, wherein the first membrane separator and/or the second membrane separator has a rejection for the solubilized lithium cations of less than or equal to 95%.

22. The method of claim 3, wherein the first membrane separator and/or the second membrane separator has a rejection for the solubilized lithium cations of greater than or equal to 10%.

23-25. (canceled)

26. The method of claim 3, wherein the method further comprises transporting a third membrane separator retentate inlet stream to a retentate side of a third membrane separator such that:
a third membrane separator retentate outlet stream exits the retentate side of the third membrane separator, the third membrane separator retentate outlet stream having a concentration of solubilized lithium cations that is greater than a concentration of solubilized lithium cations of the third membrane separator retentate inlet stream, and
at least a portion of liquid and at least a portion of solubilized lithium cations from the third membrane separator retentate inlet stream are transported from the retentate side of the third membrane separator, through a semi-permeable membrane of the third membrane separator, to a permeate side of the third membrane separator where the portion of the liquid and the portion of solubilized lithium cations form some or all of a third membrane separator permeate outlet stream that is transported out of the permeate side of the third membrane separator;
wherein:
the third membrane separator retentate inlet stream comprises at least a portion of the second membrane separator retentate outlet stream.

27-32. (canceled)

33. The method of claim 3, wherein the feed stream comprises solubilized non-lithium cations.

34. The method of claim 33, wherein the method further comprises removing at least some of the solubilized non-lithium cations from the concentrated stream to form an impurity-depleted concentrated steam having an atomic ratio of solubilized lithium cations to solubilized non-lithium cations that is larger than an atomic ratio of solubilized lithium cations to solubilized non-lithium cations in the concentrated stream.

35-36. (canceled)

37. The method of claim 34, wherein the removing at least some of the solubilized non-lithium cations from the concentrated stream results in a ratio of a concentration of solubilized lithium cations to a total concentration of all solubilized non-lithium cations in the impurity-depleted concentrated stream that is greater than a ratio of a concentration of solubilized lithium cations to a total concentration of all solubilized non-lithium cations in the concentrated stream by a factor of at least 1.1.

38-39. (canceled)

40. The method of claim 34, wherein the removing at least some of the solubilized non-lithium cations from the concentrated stream comprises elevating a temperature of the concentrated stream to form a heated concentrated stream such that an amount of a solid non-lithium-containing salt comprising at least a portion of the non-lithium cations is formed.

41-42. (canceled)

43. The method of claim 34, wherein the impurity-depleted concentrated stream comprises solubilized first anions, and the method further comprises applying a voltage to an electrochemical cell comprising at least a portion of the impurity-depleted concentrated stream such that at least a portion of the first anions are replaced by second, different anions, thereby forming an electrochemically-treated solution comprising the liquid, solubilized lithium cations, and solubilized second anions at a concentration greater than a concentration of the solubilized second anions in the impurity-depleted concentrated stream.

44-45. (canceled)

46. The method of claim 43, further comprising allowing at least a portion of liquid from the electrochemically-treated solution to evaporate within a humidifier to produce a humidified gas stream and a humidifier liquid outlet stream having a higher concentration of solubilized lithium cations and solubilized second anions compared a concentration of solubilized lithium cations and solubilized second anions in the electrochemically-treated solution.

47. The method of claim 46, further comprising obtaining a solid lithium salt comprising at least a portion of the lithium cations and at least a portion of the second anions from the humidifier liquid outlet stream.

48. The method of claim 3, wherein the feed stream initially comprises one or more boron-containing species, and the method comprises removing at least some of the one or more boron-containing species from the feed stream.

49. The method of claim 3, wherein the concentrated stream initially comprises one or more boron-containing species, and the method comprises removing at least some of the one or more boron-containing species from the concentrated stream.
